(19) United States
(12) Patent Application Publication
(10) Pub. No.: US 2026/0370352 A1
(43) Pub. Date: Nov. 19, 2026

(54) SYSTEMS FOR CONTROLLING ONE OR MORE DEVICES USING A SIGNAL CONTROL UNIT

(71) Applicant: SYNCHRON AUSTRALIA PTY LIMITED, Fitzroy (AU)

(72) Inventors: Evan SCHNELL, North Oaks, MN (US); Marthe Esmee DOHLE, New York, NY (US); Nicholas F. HARDY, Brooklyn, NY (US); Katerina PRASTAKOU, Brooklyn, NY (US)

(21) Appl. No.: 19/680,768

(22) Filed: May 18, 2026

Related U.S. Application Data
(60) Provisional application No. 63/808,306, filed on May 19, 2025.

(51) Int. Cl. H04B 13/00; H04W 4/38; H04W 68/00; H04W 88/16

(52) U.S. Cl. CPC H04B 13/005; H04W 4/38; H04W 68/00; H04W 88/16

(57) ABSTRACT

Interface systems for directing communication between an individual and a plurality of external devices using an external processing system, where the individual has a neural interface device having an electrode component electrically coupled with a receiver and transmitter unit (RTU). The RTU is configured to locally decode a user intent from a bounded fallback vocabulary and perform a fallback action when the external processing system is unavailable. The RTU is further operable in an active mode and an idle mode having different communication intervals, while maintaining the ability to detect events and transmit notifications from the idle mode. Routing logic selects a caregiver-output route from among multiple routes ordered by priority based on an availability state of at least the external processing system, including at least one fallback route that does not use the external processing system.

### RELATED APPLICATIONS

This application claims the benefit of U.S. Provisional Application No. 63/808,306, filed on May 19, 2025, entitled “SYSTEMS FOR CONTROLLING ONE OR MORE DEVICES USING A SIGNAL CONTROL UNIT,” the entire contents of which are incorporated herein by reference.

### BACKGROUND

The development of brain-computer-interface (“BCI”) technologies presently focuses both on safety and enabling people living with full or partial paralysis or with limited/decreasing motor ability to use a BCI system to control electronic devices, including prosthetic arms and computers and to complete a variety of daily tasks. There is a need to restore continuous and independent motor outputs that allow for BCI control of devices by the BCI user. BCI systems hold promise for restoring lost neurologic function, including motor neuroprostheses (MNPs), to restore motor capability to the individual. An implantable MNP can directly infer motor intent by detecting local brain signals and transmitting the motor control signal out of the brain to generate a motor output, referred to as a digital motor output (DMO), and subsequently control computer actions or control other electronic devices. In one variation, this physiological function can be performed by the motor neurons in the individual.

However, while traditional BCI systems provide a paralyzed patient with some level of autonomy through control of the device, the BCI systems that exist today afford only very limited overall autonomy to patients with paralysis. For example, a paralyzed individual using a BCI system typically requires assistance with setting up or turning on the BCI system (including charging/recharging), calibrating the system for an individual's use, including learning how an individual must think so to enable useful electronic commands to be generated; and setting up the individual (adjusting the screens, antennas and/or posture etc. of the patient) to allow the individual to use the system (as opposed to setting up the system itself).

Conventional BCI systems function by connecting with a computing device, such as a computer or tablet. These conventional systems do not enable an individual with limited peripheral mobility to autonomously switch between using a variety of devices. There is a need for individuals with limited peripheral mobility to autonomously control a variety of independent devices at will, both concurrently and to be able to select which devices are controlled at any given time.

There is also a need for a BCI system that provides BCI users with more meaningful autonomy and independence. Such meaningful autonomy and independence can be provided by a BCI system used by an individual that requires less assistance from or even in the absence of a caregiver. Moreover, there remains a need for a BCI system that can communicate with one or more external devices through a central processing system that can serve various functions to increase the ability of the patient to interact with a host device as well as to allow caregivers to monitor and/or service the BCI as needed.

### SUMMARY

The systems and methods described herein allow for a BCI system that can always be available, enabling the BCI user to access digital devices. This system improves the quality of life of the BCI user by providing independence in daily living activities by autonomously accessing digital devices or sending a remote call-for-help when they are alone. This critical architecture decision defines a fully implanted recording component and a portable SCU while also setting some critical constraints that further elaborate the system design.

While variations of the systems and methods include BCI users who are fully or partially paralyzed or have limited/decreased motor ability, additional variations include any user that could benefit from the systems and methods. For example, such a user could include an individual having motor capabilities but is expected to lose those capabilities due to a chronic condition. Moreover, variations of the systems and methods described herein are used with one or more neuroprostheses with fully implanted recording components. However, additional methods and systems described herein can include partially implanted recording components or external recording components. The present disclosure includes an implantable neural interface architecture that preserves limited, clinically meaningful autonomy when an external processing system is unavailable by maintaining implant-side low-fidelity intent/event handling, (reduced-duty) always-ready communication, and state-aware caregiver notification routes that can bypass the external processing system. For example, some aspects include a combination of neural-intent/event source, implant-side reduced fallback responsibility, an external-processing-system-unavailable trigger, idle-mode event detection, and a direct RTU-to-personal-device or local-alert fallback path.

Variations of the present disclosure include an implantable neural interface system that includes a neural interface implanted in a user and configured to detect brain signals from the user and generate electronic neural signals representative of the brain signals. The system further includes a receiver and transmitter unit (RTU) coupled to the neural interface and configured to receive the electronic neural signals, and an external processing system configured to receive the electronic neural signals from the RTU and decode at least one user intent therefrom during a first operating mode. In such variations, the RTU is further configured to decode a user intent from the electronic neural signals without using the external processing system when an unavailability condition associated with the external processing system is present, and to perform a fallback action based on the user intent decoded by the RTU.

In some variations, the RTU-side decoding is a reduced-complexity classification or event-detection process relative to the decoding performed by the external processing system. For example, the RTU may detect a one-bit notification event, a caregiver-contact event, a wake event, a lock or unlock event, or another reduced set of neural event classes using threshold detection, template matching, temporal pattern detection, state detection, or classification against a bounded fallback vocabulary. In some implementations, the bounded fallback vocabulary includes only a notification or caregiver-contact event, while in other implementations the bounded fallback vocabulary includes notification, lock, unlock, wake, recovery, or other easily decoded neural events.

The present disclosure also includes methods performed by an implantable neural interface system. Such methods include detecting, by a neural interface implanted in a user, brain signals from the user; generating, by the neural interface, electronic neural signals representative of the brain signals; receiving, by a receiver and transmitter unit (RTU) coupled to the neural interface, the electronic neural signals; communicating, by the RTU, the electronic neural signals to an external processing system, where the external processing system decodes at least one user intent therefrom during a first operating mode; decoding, by the RTU, a user intent from the electronic neural signals without using the external processing system when an unavailability condition associated with the external processing system is present; and performing, by the RTU, a fallback action based on the user intent decoded by the RTU.

In some implementations, decoding by the RTU includes detecting a reduced-complexity neural event associated with a notification, wake, lock, unlock, recovery, or other fallback command. The reduced-complexity neural event may be distinguishable from a full vocabulary user intent decoded by the external processing system during normal operation. For example, the RTU may detect a notification-only event sufficient to cause a caregiver notification, while the external processing system remains responsible for cursor control, text entry, multi-degree-of-freedom device control, or other higher-complexity outputs during normal operation.

Variations of the present disclosure include an implantable neural interface system that includes a neural interface implanted in a user and configured to detect brain signals from the user and generate electronic neural signals representative of the brain signals, and a receiver and transmitter unit (RTU) coupled to the neural interface and configured to communicate the electronic neural signals with an external processing system. The RTU is operable in an active mode in which the RTU communicates the electronic neural signals with the external processing system according to a first communication interval, and an idle mode in which the RTU communicates the electronic neural signals with the external processing system according to a second communication interval. In the idle mode, the RTU is configured to detect at least one event and, responsive to detection of the at least one event, transition to the active mode or transmit a notification via a wireless link maintained by the RTU independently of the external processing system.

The present disclosure also includes methods performed by an implantable neural interface system that include detecting, by a neural interface implanted in a user, brain signals from the user; generating, by the neural interface, electronic neural signals representative of the brain signals; communicating, by a receiver and transmitter unit (RTU) coupled to the neural interface, the electronic neural signals with an external processing system; operating the RTU in an active mode in which the RTU communicates the electronic neural signals with the external processing system according to a first communication interval; transitioning the RTU to an idle mode in which the RTU communicates the electronic neural signals with the external processing system according to a second communication interval; detecting, by the RTU while in the idle mode, at least one event; and responsive to detection of the at least one event, transitioning the RTU to the active mode or transmitting, by the RTU, a notification via a wireless link maintained by the RTU independently of the external processing system.

In some examples, the second communication interval is longer than the first communication interval. Additionally, or alternatively, the RTU and/or the external processing system use a first vocabulary (e.g., a bounded vocabulary) during the idle mode and a second vocabulary (e.g., a full vocabulary) during the active mode. In some examples, the idle mode is not limited to reducing communication power. In some examples, the idle mode preserves a pre-authorized event-detection pathway in which the RTU remains capable of detecting at least a caregiver-contact event, wake event, unlock event, or recovery event without requiring a fresh pairing, full reconnection, or immediate restoration of continuous full-rate streaming. Thus, the idle mode preserves clinically meaningful availability for a user who may be unable to retrieve, reposition, power, or troubleshoot the external processing system.

Variations of the present disclosure include an implantable neural interface system that includes a neural interface implanted in a user and configured to detect brain signals from the user and generate electronic neural signals representative of the brain signals; a receiver and transmitter unit (RTU) coupled to the neural interface and configured to receive the electronic neural signals from the neural interface; an external processing system configured to receive the electronic neural signals from the RTU and decode user intents therefrom during a first operating mode; and routing logic configured to determine, based on an availability state of at least the external processing system, which of a plurality of caregiver-output routes is available, and to initiate a transmission of a caregiver notification, generated in response to a user intent decoded from the electronic neural signals, via a highest-priority available caregiver-output route from among the plurality of caregiver-output routes. The plurality of caregiver-output routes are ordered by priority and include at least a primary route associated with internet connectivity and at least one fallback route that does not use the external processing system.

The present disclosure also includes methods performed by an implantable neural interface system that include detecting, by a neural interface implanted in a user, brain signals from the user; generating, by the neural interface, electronic neural signals representative of the brain signals; receiving, by a receiver and transmitter unit (RTU) coupled to the neural interface, the electronic neural signals from the neural interface; decoding, by an external processing system during a first operating mode, user intents from the electronic neural signals received from the RTU; determining, based on an availability state of at least the external processing system, which of a plurality of caregiver-output routes is available; and initiating a transmission of a caregiver notification, generated in response to a user intent decoded from the electronic neural signals, via a highest-priority available caregiver-output route from among the plurality of caregiver-output routes. The plurality of caregiver-output routes are ordered by priority and include at least a primary route associated with internet connectivity and at least one fallback route that does not use the external processing system.

In some examples, the availability state of the external processing system is treated as a primary (such as a leading or largest weighted) routing variable. When the external processing system is unavailable, routes that require the external processing system to decode, format, relay, or transmit the caregiver notification may be excluded from the available route set. The routing logic may then select an RTU-originated fallback route, such as a direct RTU-to-personal-electronic-device route or a direct RTU-to-local-alert-device route, from a reduced set of routes that do not require the external processing system.

Variations of the present disclosure include an interface system for use by an individual, the interface system including: a neural interface device having an electrode component electrically coupled with a transmitter/receiver component, where the electrode component is configured to detect a brain signal from a brain of the individual and the transmitter/receiver component is configured to transmit an electronic signal representative of the brain signal; a signal control unit including a housing structure that is physically separate from the neural interface device and is configured to be portable; a power supply, an electronic communications circuitry and a processor each housed with the housing structure; wherein the processor is configured to apply one or more algorithms to decode the electronic signal from the transmitter/receiver component and is also configured to produce an output signal upon determining that the electronic signal is representative of an intentional neural brain signal generated by the individual; and wherein the electronic communications circuitry is configured to provide a plurality of wireless electronic communication modalities for electronic transfer communication of the output signal to a plurality of external devices, wherein at least two wireless electronic communication modalities are different and wherein the electronic communications circuitry is also configured for electronic exchange of a device data with one or more of the plurality of external devices, where the device data is generated by at least one of the plurality of external devices.

Additional variations of the system include a signal control unit including a housing structure that is physically separate from the neural interface device and is configured to be portable; a power supply, an electronic communications circuitry and a processor each housed with the housing structure; wherein the processor is configured to apply one or more algorithms to decode the electronic signal from the transmitter/receiver component and is also configured to produce an output signal upon determining that the electronic signal is representative of an intentional neural brain signal generated by the individual; and wherein the electronic communications circuitry is configured to provide a plurality of wireless electronic communication modalities for electronic transfer communication of the output signal to a plurality of external devices, wherein at least two wireless electronic communication modalities are different and wherein the electronic communications circuitry is also configured for electronic exchange of a device data with one or more of the plurality of external devices, where the device data is generated by at least one of the plurality of external devices.

Electrically coupling can include the ability of any device to transmit and/or receive a signal in an electronic form using any means of data transfer. Such transfer includes wireless electronic connections or receipts. Such transfer can also include wired connections. The communication modalities can include, but are not limited to, short-range wireless (e.g., blue tooth or blue tooth low energy), ultra-high frequency (such as low power device 433 MHz), as well as the ability to communicate via an HTTP/HTTPS using a Wi-Fi or other network connection. Such electrical coupling can include two-way coupling, where data/signal is sent and received, or one-way coupling, where data/signal is sent by one device with no receipt of data/signal returned back to the device. Moreover, for purposes of this disclosure, in the variations discussed below, the term can be interchangeably used with signal when discussion electronic communication between or from any device.

Variations of the present disclosure include an interface system, wherein at least one of the plurality of wireless electronic communication modalities includes a security communication modality and where only a subset of the plurality of external devices includes the security communication modality. In one example, such a security communication modality can include a wireless communication modality that uses a proprietary connection, encryption, or other specialization that prevents the signal/data from being received by non-authorized external devices. In one variation, the security communication modality can comprise a proprietary and/or encrypted BLE.

In some variations of the interface system, the transmitter/receiver component of the neural interface device and the signal control unit are configured to use the security communication modality to communicate the electronic signal representative of the brain signal. For example, such a configuration allows a user to limit/prevent the dissemination of data/signals to unauthorized devices. In an example of the present system, such a subset of external devices includes a host device (primarily used by the BCI user) and/or an administrator device (primarily used by a caregiver or system technician) to monitor operations of and/or maintain the system.

In some variations, the signal control unit is configured for wirelessly coupling to a host device having one or more applications that control at least one of the plurality of external devices. The signal control unit can be configured to directly wirelessly exchange data with the host device. Alternatively, or in combination, the signal control unit can in-directly wirelessly exchange data with the host device.

In some variations, the signal control unit is configured to communicate the output signal with one of the plurality of external devices at a time. Alternative variations of the system can allow the signal control unit to communicate simultaneously with any number of devices.

Variations of the present disclosure include an interface system, wherein the neural interface device is coupled to the transmitter/receiver component through one or more lead members. In some examples, the neural interface device, the one or more lead members, and the transmitter/receiver component are configured for full implantation within the individual. Alternatively, the neural interface can be partially implanted (e.g., portions of the system extend outside of the body), can be fully external (e.g., external electrodes), or a combination thereof.

Variations of the interface system include a transmitter/receiver component that is configured for wireless charging of a power supply in the transmitter/receiver component and independently of the signal control unit using a remote charging device. Optionally, the transmitter/receiver component and the remote charging device can maintain a wireless communication connection therebetween during charging or simply when connected.

Variations of the present disclosure include an interface system, wherein the signal control unit is configured to electronically connect with one or more of the plurality of external devices and retain the information needed to re-connect if any external device is disconnected.

Variations of the present disclosure include a signal control unit that is further configured to detect whether the one or more of the plurality of external devices and to alter the output signal based on whether the one or more of the plurality of external devices is electrically connected to the signal control unit.

The signal control unit can be configured to transmit the output signal as a wireless signal to an alert device when the plurality of external devices are unconnected to the signal control unit.

The signal control unit can include a user interface accessible on a surface of the housing structure, where the user interface includes a plurality of visible indicators.

Variations of the present disclosure include an interface system, wherein the signal control unit is configured to indirectly exchange data with the host device using a network connection.

Variations of the present disclosure include an interface system, wherein the signal control unit is configured to transmit a system-generated output signal automatically without prompting by the individual.

Variations of the present disclosure include an interface system, wherein the plurality of external devices includes a first external device and a second external device, and wherein the signal control unit is configured to wirelessly transmit the device data from the first external device to the second external device.

Variations of the present disclosure include an interface system, wherein the signal control unit is configured to establish a wireless network connection with a cloud-based network.

Variations of the present disclosure include an interface system, wherein the signal control unit is configured to determine whether at least one of the plurality of external devices uses a gesture control and wherein the signal control unit adjusts the output signal to trigger the gesture control.

The present disclosure also includes methods of operatively interfacing an individual with a plurality of external devices. For example, such a method can include detecting a brain signal from the individual using a neural interface device having an electrode component electrically coupled with a transmitter/receiver component; transmitting an electronic signal representative of the brain signal using the transmitter/receiver component to a signal control unit including a housing structure that is physically separate from the neural interface device and is configured to be portable; processing the electronic signal representative of the brain signal using a processor within the signal control unit that is configured to apply one or more algorithms to decode the electronic signal from the transmitter/receiver component; producing an output signal upon determining that the electronic signal is representative of an intentional neural brain signal generated by the individual; transmitting the output signal to one or more external devices using the signal control unit; and electronically exchanging a device data with one or more of the plurality of external devices using the signal control unit, where the device data is generated by at least one of the plurality of external devices, where the signal control unit is configured to select a plurality of separate communication modalities based on which of the plurality of external devices is connected to the signal control unit.

Variations of method can include electronically exchanging the device data with one or more of the plurality of external devices using the signal control unit, where the device data is generated by at least one of the plurality of external devices.

In additional variations, the present disclosure includes systems for transmitting an electronic signal to an external device from an individual having an electrode device configured to receive brain signals from a brain of the individual and a receiver and transmitter unit, electrically coupled to the electrode device, the receiver and transmitter unit configured to receive an electronic neural signal from the electrode device corresponding to brain signals from the brain of the individual, the system including: a signal control unit configured to receive transmissions from the receiver and transmitter unit, the signal control unit configured to perform signal processing on the electronic neural signal to produce at least one output signal; and a first external host device configured to electronically communicate with the signal control unit.

Variations of systems can further include a second external device, where the signal control unit is configured to electronically communicate with both the first external host device and the second external device. Optionally, the first external host device is a patient host device and the second external device is a monitoring device. Either the first external host device or the second external device can initiate communication with the signal control unit.

### BRIEF DESCRIPTION OF THE DRAWINGS

FIG. 1A illustrates a conventional approach to accessing regions of the brain with a brain stimulation device containing electrodes that are implanted within the brain of an individual.

FIG. 1B shows a remote power supply that can be used to wirelessly charge and/or communicate with an implantable receiver and transmitter unit.

FIG. 1C illustrates a variation of a signal control unit that houses a power supply, processor, and circuitry to enable wireless and/or wired electronic communication.

FIG. 1D illustrates an example of a portable signal control unit having a housing with a user interface on the housing.

FIG. 1E shows a representation of an example of bonds or bonding between the various components of the BCI system.

FIG. 2A provides a basic illustration of a signal control unit as being a central hub for communication with various external devices.

FIG. 2B illustrates an additional variation of an interface system, where the multiple and distinct communication channels of the signal control unit allow an individual BCI user to operatively engage one or more external devices to improve autonomy for the individual.

FIGS. 3A and 3B illustrate examples where the BCI system is mapped to standard communication protocols of various consumer electronics.

FIGS. 4A and 4B illustrate a variation of a system where the receiver and transmitter unit are configured to inherently implement basic or low-level functionality without use of a signal control unit or any external processor.

FIG. 5 shows a flowchart for a configuration where transmission to the processor or signal control unit is maintained at a minimal level to maintain connection with the processor/signal control unit that requires significantly less power than when operating in a normal configuration.

FIG. 6 shows a system architecture diagram illustrating the components of an implantable neural interface system and the communication paths therebetween.

FIG. 7 shows a block diagram of the internal architecture of a receiver and transmitter unit (RTU).

FIG. 8 shows a flowchart illustrating a process for fallback decoding by the RTU when an external controller is unavailable.

FIG. 9 shows a state diagram illustrating transitions between an active mode, an idle mode, and an optional third state.

FIG. 10 shows a timing diagram comparing continuous active mode streaming with an active/idle mode alternating between two communication intervals.

FIG. 11 shows a flowchart illustrating a caregiver-notification routing process.

FIG. 12 shows a diagram illustrating a physical path topology for caregiver-output routes across different system availability states.

FIGS. 13-19 show example methods that support availability enhancements for implantable neural interface systems.

FIG. 20 shows an example of a diagram of a receiver and transmitter unit (RTU) that supports availability enhancements for implantable neural interface systems.

### DETAILED DESCRIPTION

Brain-computer interfaces (BCIs) establish a communication pathway between a brain and one or more external devices by recording and interpreting neural signals. BCIs may be implemented using intracranial electrode arrays implanted within the brain that communicate with neural tissue, or extracranial means such as electroencephalography (EEG) or other sensing modalities. In some BCI architectures, an implanted neural interface device detects brain signals and generates electronic neural signals representative of those brain signals, and a receiver and transmitter unit (RTU) coupled to (via a communication interface) the neural interface device receives the electronic neural signals and communicates them to an external processing system, such as a signal control unit (SCU) or a host device executing a neural interface application, that decodes user intents from the electronic neural signals. The decoded user intents may be used to drive a variety of outputs, including on-screen cursors, text-based communication, control of consumer electronics, and/or interaction with home automation systems, among other examples. Such BCI systems hold promise for restoring lost neurologic function and providing individuals with motor impairments, including those with full or partial paralysis, a degree of autonomy in controlling electronic devices and completing daily tasks.

However, some BCI systems that rely on an external processing system as a sole or primary decoder of neural signals present several challenges relating to system availability, power management, and reliable caregiver communication. First, because the external processing system might serve as a single point of failure for intent decoding, if the external processing system becomes unavailable (for example, because it is out of wireless range, powered off, physically damaged, misplaced, or in a software-failure state) the user may lose both device control capability and the ability to contact a caregiver, leaving the user without any means of requesting assistance. This is particularly concerning for individuals with paralysis who cannot independently retrieve or reposition the external processing system. Second, continuous full-rate communication between the implanted RTU and the external processing system consumes significant power, which reduces the operational longevity of the implanted components and increases the frequency of recharging, yet a complete disconnection during periods of inactivity risks unacceptable wake-up latency and loss of responsiveness when the user tries to resume interaction or request assistance, such as during nighttime use. Third, some BCI systems that provide caregiver notification capability typically rely on a single communication pathway, such that if that pathway becomes unavailable due to loss of the external processing system, loss of network connectivity, or both, the user's ability to request caregiver assistance also may be lost. Further, some smart-home alert systems and personal emergency response devices do not account for the unique architectural characteristics of BCI systems, including the availability state of the external processing system as a routing variable and privacy considerations associated with neural signals or information derived from neural signals, and do not provide fallback notification pathways that originate from the implanted RTU independently of the external processing system. Thus, individuals using BCI systems may benefit from techniques that improve system availability, reduce power consumption while maintaining responsiveness, and provide reliable multi-path caregiver notification across varying system availability states.

Various aspects of the present disclosure relate generally to availability enhancements for implantable neural interface systems, and more specifically to techniques by which an RTU supports an ability to locally decode user intents and perform fallback actions when an external processing system is unavailable. In some examples, the implantable neural interface system includes a neural interface implanted in a user that detects brain signals and generates electronic neural signals representative of those brain signals, an RTU coupled to the neural interface that receives the electronic neural signals via a communication interface, and an external processing system that receives the electronic neural signals from the RTU and decodes at least one user intent therefrom during a first operating mode (e.g., a normal operating mode). The RTU is further configured to decode a user intent from the electronic neural signals without using the external processing system when an unavailability condition associated with the external processing system is present, and to perform a fallback action based on the user intent decoded by the RTU. The unavailability condition may include the external processing system being out of wireless range, powered off, physically damaged, misplaced, or in a software-failure state. The user intent decoded by the RTU may be from a bounded fallback vocabulary that includes, for example, a caregiver-contact or notification intent, a lock intent, an unlock intent, a wake intent, or a physiological-state detection intent. A physiological-state detection intent may correspond to the RTU detecting a neural signal pattern associated with a physiological or neurological state, such as a seizure-related pattern or an abnormal brain-state signature, and using the fallback path to trigger a caregiver notification or initiate a recovery workflow. The fallback action performed by the RTU may include transmitting a caregiver notification to a personal electronic device via a wireless link maintained by the RTU independently of the external processing system, changing the system between an active state and an idle or locked state, issuing a wake or recovery command directed to the external processing system, or transmitting an alert signal to a local notification device. The external processing system may be implemented by a signal control unit that is physically separate from the RTU, a host device that executes a neural interface application without a separate signal control unit, or a signal control unit operating in conjunction with a host device.

Particular aspects of the implant-side fallback decoding techniques described in this disclosure can be implemented to realize one or more of the following potential advantages. By retaining a bounded fallback vocabulary and local decode logic at the RTU, the described techniques avoid a complete loss of function when the external processing system becomes unavailable, providing graceful degradation rather than system failure. By enabling the RTU to locally decode at least a caregiver-contact or notification intent and to transmit a caregiver notification via a wireless link maintained independently of the external processing system, the described techniques preserve the user's ability to request assistance from a caregiver even when the external processing system is out of range, unpowered, damaged, misplaced, or in a software-failure state. This capability may be particularly important for individuals with paralysis who cannot independently retrieve or re-position the external processing system. By keeping the fallback vocabulary bounded to a small number of intents, the described techniques limit the processing and power burden imposed on the implanted RTU while still preserving the most clinically meaningful functions, including caregiver notification and system state control. By supporting multiple fallback action types (including caregiver notification, state transitions, wake or recovery commands, and local alert signals) the described techniques provide the RTU with a range of autonomous responses that can address different failure scenarios without any intervention by the user beyond generating the relevant neural intent.

Additional aspects of the present disclosure relate to power-efficient state management techniques for implantable neural interface systems, and more specifically to techniques by which an RTU transitions between an active mode and an idle mode while maintaining the ability to detect events and respond to user intents without a full disconnection and reconnection cycle. In some examples, the RTU is coupled to (via a communication interface) a neural interface implanted in a user and is configured to communicate electronic neural signals representative of brain signals with an external processing system. The RTU is operable in an active mode in which the RTU communicates the electronic neural signals with the external processing system according to a first communication interval, and an idle mode in which the RTU communicates with the external processing system according to a second communication interval. The first communication interval may be on the order of milliseconds (for example, approximately 7.5 milliseconds), and the second communication interval may be on the order of seconds (for example, approximately 4 seconds), such that the second communication interval is greater than the first communication interval by at least one order of magnitude. In the idle mode, the RTU is configured to detect at least one event from a predefined event set and, responsive to detection of the at least one event, transition to the active mode or transmit a notification via a wireless link maintained by the RTU independently of the external processing system. The predefined event set may include, for example, a wake intent or an unlock intent that triggers a transition from the idle mode to the active mode, or a caregiver-contact intent that triggers transmission of a notification without first resuming the active mode. The RTU may enter the idle mode responsive to a user-generated lock intent decoded from the electronic neural signals, an inactivity timeout triggered by absence of detected neural activity for a configurable period, an environment-monitoring signal indicating a sleep or rest condition, or a command received from the external processing system or a caregiver device. In some examples, the RTU is further operable in a third mode intermediate between the active mode and the idle mode. In some examples, the RTU is further configured to receive a caregiver-override signal while in the idle mode and, responsive to receipt of the caregiver-override signal, transition to the active mode regardless of whether an unlock intent has been detected from the user.

Particular aspects of the low-duty idle-interval state management techniques described in this disclosure can be implemented to realize one or more of the following potential advantages. By maintaining a wireless relationship between the RTU and the external processing system at a reduced-duty second communication interval during the idle mode rather than fully disconnecting, the described techniques reduce power consumption of the implanted RTU while preserving the ability to resume full-rate communication without a fresh pairing or reconnection event, thereby reducing wake-up latency when the user needs to resume interaction. By enabling the RTU to detect at least one event from a predefined event set while in the idle mode (including both wake or unlock intents and caregiver-contact intents) the described techniques ensure that the system remains always ready to respond to user needs even during periods of inactivity, such as during nighttime use, without continuous full-rate streaming that may unnecessarily deplete the power supply of the implanted components. By allowing the RTU to transmit a caregiver notification via a wireless link maintained independently of the external processing system without first transitioning to the active mode, the described techniques preserve the user's ability to request caregiver assistance from the idle mode with minimal latency, avoiding the delay that would otherwise be introduced by first restoring full-rate communication with the external processing system. By supporting a caregiver-override signal that can transition the RTU from the idle mode to the active mode regardless of whether an unlock intent has been detected from the user, the described techniques enable caregivers to restore full system functionality when the user is unable to generate an unlock intent, such as during a medical event. By separating the communication interval between the active mode and the idle mode by at least one order of magnitude, the described techniques achieve a substantial reduction in power draw during periods of inactivity while still maintaining a connection that supports event detection and rapid state transitions.

Further aspects of the present disclosure relate to multi-path caregiver-notification routing techniques for implantable neural interface systems, and more specifically to techniques by which routing logic selects a caregiver-output route from among a plurality of available routes based on an availability state of at least the external processing system. In some examples, the implantable neural interface system includes a neural interface implanted in a user that detects brain signals and generates electronic neural signals representative of those brain signals, an RTU coupled to the neural interface that receives the electronic neural signals via a communication interface, and an external processing system that receives the electronic neural signals from the RTU and decodes user intents therefrom during a first operating mode. The implantable neural interface system may further include routing logic configured to determine, based on an availability state of at least the external processing system, which of a plurality of caregiver-output routes is available, and to initiate a transmission of a caregiver notification, generated in response to a user intent decoded from the electronic neural signals, via a highest-priority available caregiver-output route from among the plurality of caregiver-output routes. The plurality of caregiver-output routes are ordered by priority and include at least a primary route associated with internet connectivity and at least one fallback route that does not use the external processing system. In some examples, the priority ordering of the plurality of caregiver-output routes is patient-configurable or caregiver-configurable. In some examples, when both the external processing system and internet connectivity are available, the routing logic selects a caregiver-output route that delivers a generated or custom text message via an internet-connected channel. In some examples, when the external processing system is available, but internet connectivity is unavailable, the routing logic selects a caregiver-output route that delivers a pre-recorded, synthesized, or canned message via a local communication channel. In some examples, when the external processing system is unavailable, the routing logic, executing at least in part on the RTU, selects a fallback caregiver-output route associated with a personal electronic device or a local notification device independently of the external processing system. In some examples, the routing logic is further configured to monitor for a delivery acknowledgement on the highest-priority available caregiver-output route and, upon expiration of a configurable timeout without acknowledgement, initiate the transmission of the caregiver notification via a next-priority available caregiver-output route. In some examples, the plurality of caregiver-output routes includes at least three route types: an external-processing-system-mediated route, a personal-electronic-device-mediated route, and a local-alert-device-mediated route. In some examples, each caregiver-output route is configured to deliver at least one of a generated text message, a canned text message, a pre-recorded audio message, a synthesized audio message, a tone, or a sub-GHz radio frequency alert signal.

Particular aspects of the state-aware caregiver-notification routing techniques described in this disclosure can be implemented to realize one or more of the following potential advantages. By maintaining a plurality of caregiver-output routes ordered by priority and selecting among them based on an availability state of at least the external processing system, the described techniques avoid reliance on a single communication pathway for caregiver notification, such that the user's ability to request assistance is preserved across varying system availability states rather than being lost when any single component or connection fails. By including at least one fallback route that does not use the external processing system, the described techniques ensure that caregiver notification remains available even when the external processing system is out of range, unpowered, damaged, misplaced, or in a software-failure state. This capability may be particularly important for individuals with paralysis who cannot independently restore the external processing system. By supporting a patient-configurable or caregiver-configurable priority ordering, the described techniques allow the notification routing hierarchy to be tailored to the user's specific living environment and caregiver arrangement, such that a home-care user with a spousal caregiver may prefer phone-mediated messaging as a primary route while an institutional-care user may prefer a nurse-station or bedside alert as a primary route. By monitoring for a delivery acknowledgement and escalating to a next-priority route upon timeout, the described techniques provide automatic retry and escalation behavior that increases the likelihood that the caregiver notification is successfully delivered without requiring any additional action by the user beyond generating the initial notification intent. By supporting multiple output modalities across the plurality of routes (including generated text, canned text, pre-recorded audio, synthesized audio, tones, and sub-GHz radio frequency alert signals) the described techniques enable each route to deliver a notification in a format that is appropriate for the endpoint device and the communication channel available at the time of transmission, balancing notification richness against availability constraints.

As used herein, the term “external processing system” refers to any processing system that is external to the RTU and that, during normal operation, receives electronic neural signals from the RTU and decodes user intents therefrom. The external processing system may be implemented by a signal control unit (SCU) that is physically separate from the RTU, one or more host devices (such as a tablet, smartphone, and/or computer) that execute a neural interface application without a separate signal control unit, a signal control unit operating in conjunction with one or more host devices, or any combination thereof. The external processing system may also be implemented by a local wearable compute unit, an edge computing device, or a cloud-based decoder or remote compute path, among other examples. References herein to the external processing system being “unavailable” or to an “unavailability condition associated with the external processing system” encompass any condition in which the external processing system is unable to receive electronic neural signals from the RTU and decode user intents therefrom, including but not limited to the external processing system being out of wireless range, powered off, physically damaged, misplaced, in a software-failure state, or otherwise unable to perform its normal decoding function. In some implementations, the external processing system is the primary decoder for normal user control, while the RTU is not required to replicate the full decoding capability of the external processing system. Instead, the RTU may provide a reduced fallback capability that is sufficient to detect or classify one or more fallback events, such as a notification event, and to initiate one or more fallback actions when the external processing system is unavailable, in idle mode, or otherwise not participating in full decoding.

As used herein, the term “receiver and transmitter unit” or “RTU” refers to a device coupled to a neural interface that is configured to receive electronic neural signals from the neural interface and to communicate those electronic neural signals with an external processing system. The RTU may be implanted in the user or may be external to the user. In some examples, the RTU is fully implanted within the body of the user and includes a wireless communication interface for communicating with external devices. The RTU may include processing circuitry configured to perform local signal processing, local intent decoding (such as decoding from a bounded fallback vocabulary), power management, and state management functions as described herein. The RTU may also be referred to as a “transmitter/receiver component,” an “implantable receiver and transmitter unit,” or an “IRTU,” and references to any of these terms should be understood as encompassing the RTU as described herein. The RTU may include a low-power microcontroller, digital signal processor, fixed-function detection circuit, configurable logic, application-specific integrated circuit, memory, radio controller, or combinations thereof. In some examples, the RTU performs only preprocessing and telemetry during the first (normal) operating mode and activates or relies on local fallback logic when a monitored unavailability condition, idle-state event, notification-authorized condition, or other trigger is present. In other examples, the local fallback logic runs continuously in a background or supervisory mode and suppresses fallback action unless one or more state conditions are satisfied.

As used herein, the term “caregiver notification” refers to any electronic notification, message, signal, or alert that is generated in response to a user intent or a system-detected condition and that is directed toward a caregiver or other individual responsible for providing assistance to the user. A caregiver notification may take any of a variety of forms, including a generated text message, a canned or pre-configured text message, a pre-recorded audio message, a synthesized audio message, a tone or series of tones, a push notification, a sub-GHz radio frequency alert signal (such as a 433 MHz signal), or any combination thereof. A caregiver notification may be transmitted via any of a plurality of caregiver-output routes, including routes mediated by the external processing system, routes mediated by a personal electronic device, and routes mediated by a local alert device, as described herein. The term “caregiver” as used herein includes any individual who provides care, assistance, or monitoring to the user, including but not limited to a family member, a spouse, a professional caregiver, a nurse, a medical practitioner, or a remote monitoring service. A caregiver notification may be associated with a message class, urgency level, privacy level, route class, acknowledgement requirement, or escalation rule. A low-bandwidth fallback route may transmit only a tone, code, canned message identifier, notification token, or predefined command that causes a receiving personal electronic device, local alert device, or gateway to generate the caregiver-facing notification. A higher-bandwidth route may transmit a richer generated, custom, template-populated, synthesized, or context-specific message when sufficient processing and communication resources are available.

As used herein, the term “bounded fallback vocabulary” refers to a predefined and limited set of user intents that the RTU is configured to locally decode from the electronic neural signals without using the external processing system. The bounded fallback vocabulary is bounded in the sense that it includes fewer intents than the full vocabulary that the external processing system is capable of decoding during normal operation. In some examples, the bounded fallback vocabulary includes no more than five intents. The bounded fallback vocabulary may include, for example, a caregiver-contact or notification intent, a lock intent, an unlock intent, a wake intent, a physiological-state detection intent, or any subset or combination thereof. The bounded fallback vocabulary may be implemented in firmware executing on a microcontroller, a dedicated fixed-function circuit, configurable hardware, or a hybrid thereof, and may be stored locally on the RTU. In some examples, the bounded fallback vocabulary is implemented as a reduced-complexity event vocabulary rather than a full motor-output vocabulary. The bounded fallback vocabulary may include only one intent or event class, such as a notification event or caregiver-contact event. In some examples, the bounded fallback vocabulary includes two, three, four, five, or fewer than ten event classes. The bounded vocabulary may be a subset of the full vocabulary, which may additionally include cursor control, text entry, multi-degree-of-freedom control, or continuous DMO control. Example vocabularies are illustrated in Table 1, shown below, where a bounded vocabulary may be used in RTU standalone operation and the full vocabulary may be used when the external processing system is connected (e.g., available).

TABLE 1
Intent Vocabulary - RTU Standalone vs. External
Processing System Connected

| | | External Processing |
|---|---|---|
| | RTU Standalone | System Connected |
| | (external processing | (external processing |
| Intent Class | system unavailable) | system available) |
| Caregiver | Supported - | Supported - |
| Notification | single-bit | rich context |
| | notify | |
| Lock/Unlock | Supported - | Supported - full |
| State | binary | |
| Wake External | Supported - | Supported - full |
| Processing System | threshold | |
| Command | detect | |
| Motor/Device | Not in bounded | Supported - full |
| Control | vocabulary | |
| High-dim Intent | Not in bounded | Supported - full |
| Set | vocabulary | |

The RTU may locally detect or classify a fallback event using amplitude thresholding, temporal pattern detection, matched filtering, template correlation, bandpower detection, threshold-crossing counts, linear classification, logistic classification, decision-tree logic, compressed neural-network inference, state-machine logic, voting across multiple detection windows, or combinations thereof. The RTU may classify the fallback event based on one or more reduced signal features, such as channel subset activity, bandpower features, event timing, feature-vector projections, threshold-crossing counts, or signal-quality metrics. The RTU may use (e.g., require, rely on, or expect) confidence thresholds, repeated detections, refractory periods, hysteresis, confirmation windows, caregiver authorization states, idle-mode authorization states, or other false-positive suppression criteria before initiating a fallback action.

As used herein, the term “caregiver-output route” refers to a communication pathway through which a caregiver notification can be transmitted from the implantable neural interface system to a caregiver or to a device associated with a caregiver. A plurality of caregiver-output routes may be ordered by priority, and routing logic may select among the plurality of caregiver-output routes based on an availability state of at least the external processing system. The plurality of caregiver-output routes may include routes that require the external processing system (such as routes that use the external processing system to access internet connectivity or to generate a message) and routes that do not require the external processing system (such as routes in which the RTU communicates directly with a personal electronic device or a local alert device independently of the external processing system). In some examples, the plurality of caregiver-output routes includes at least three route types: an external-processing-system-mediated route, a personal-electronic-device-mediated route, and a local-alert-device-mediated route. The priority ordering of the plurality of caregiver-output routes may be patient-configurable or caregiver-configurable.

In some examples, the routing logic uses a route table stored at least in part on the RTU, the external processing system, a personal electronic device, a cloud service, or combinations thereof. Each route-table entry may identify one or more required components, required communication links, endpoint types, route priority, permitted message formats, privacy rules, urgency rules, acknowledgement rules, timeout values, retry counts, fallback successor routes, and conditions under which the route is enabled or disabled. Route availability may be determined based on heartbeat messages, bond status, handshake status, link-layer acknowledgements, application-layer acknowledgements, battery state, radio state, network reachability, endpoint proximity, endpoint configuration, caregiver-configured availability, or combinations thereof.

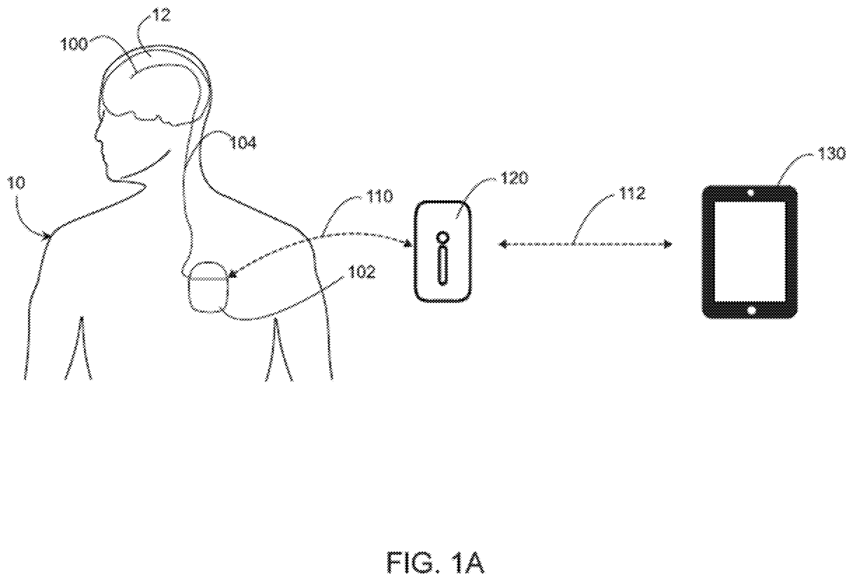

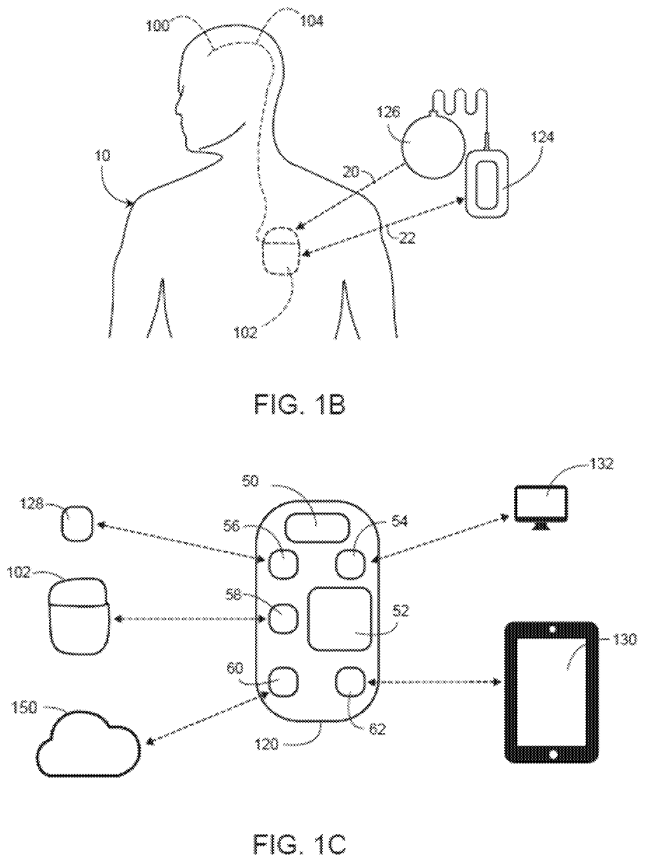

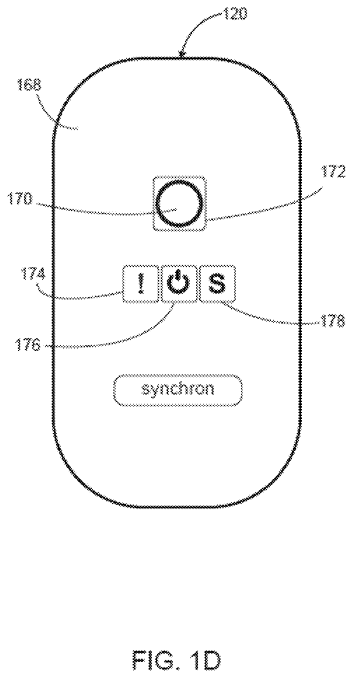

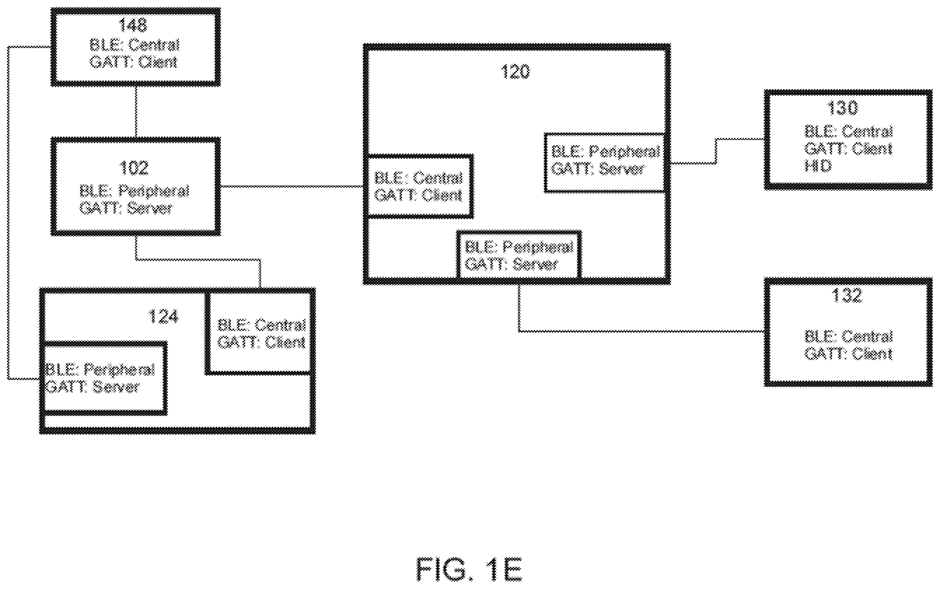

FIG. 1A is a representative illustration of a brain controller interface comprising an implant 100 positioned within a brain 12 of an individual. The implant 100 can be coupled to a receiver and transmitter unit 102, where the receiver and transmitter unit produce an electronic neural signal from the electrode device corresponding to brain signals from the brain of the individual. Typically, the implant 100 is coupled to the receiver and transmitter unit 102 via one or more leads 104 (which may be an example of a communication interface between the implant and the receiver and transmitter unit 102). However, this communication can occur wirelessly. Moreover, the systems described herein can be used with various other implantable and non-implantable external devices. In addition, the receiver and transmitter unit 102 can comprise an implantable housing where charging is performed through a capacitive or similar configuration from an external charging unit. Alternate variations include a receiver and transmitter unit 102 that is external to the individual 10.

FIG. 1A also shows the receiver and transmitter unit 102 having an ability to communicate with a signal control unit 120 that receives transmissions from the receiver and transmitter unit 102 and is configured to perform signal processing on the electronic neural signal to perform any number of functions for interaction with a host device 130 or a number of host devices. A host device can comprise any electronic device such as a computer or tablet, including dedicated and may also include non-dedicated (proprietary and/or non-proprietary) applications. The host device can support secure and proprietary communication with the signal control unit 120 and can provide a user interface for the individual BCI user. In some variations, individuals use the host device 130 to control a wide variety of applications, including.

This signal processing can include filtering, classifying, decoding, and transmitting the data received from the receiver and transmitter unit. In one variation, the inventive system simply comprises a signal control unit 120 and one or more external host devices 130, in which case the signal control unit 120 operates with a variety of systems. One benefit of using a dedicated signal control unit 120 is to provide a signal control unit 120 that allows for a power efficient low latency device for interaction with one or more electronic devices. In addition, the majority of the signal processing and data storage can occur in the signal control unit 120. The signal control unit 120 can be dedicated to signal processing and decision-making with custom applications to guide user interactions. In additional variations, the signal control unit 120 is configured to access a cloud network 150 for computing and storage resources or for analytics. Offsetting such requirements from the implantable components allows for minimization of the weight and size of the receiver and transmitter unit 102 and reduces the heat generated by the receiver and transmitter unit 102 during operation.

In addition, moving all or most of the computing power to the signal control unit 120 allows any software updates to take place outside of the BCI user's body. In addition, this configuration allows the receiver and transmitter unit 102 to operate with lower power requirements to reduce the frequency of recharging. In alternate variations, the processing, storage, and communication functions can be divided between the receiver and transmitter unit 102, the signal control unit 120, and/or any external host devices 130.

Generally, BCI system (the implant 100 and receiver and transmitter unit 102) captures motor intention from the brain (e.g., the motor cortex) and produces one or more electrical signals corresponding to the motor intention. Electrical signals can be captured from brain activity in regions other than the motor cortex. The signal control unit 120 decodes the electrical signals for utilization with a host device 130 for control of software applications (typically on the host device 130). In some cases, the host device 130 can be used to control additional digital devices (such as a computer, wheelchair, home automation systems, or other devices) that aid the individual 10 using the BCI.

Variations of the systems and methods described herein include a benefit of increasing longevity of the implanted components (e.g., the implant 100, the one or more leads 104, the receiver and transmitter unit 102) of the system to avoid repeated surgeries to replace implanted components. Accordingly, variations of the system and methods allow for a receiver and transmitter unit 102 that can be remotely and/or wirelessly recharged (e.g., capacitively) using an external power supply as represented in FIG. 1B. Alternative variations can include a receiver and transmitter unit 102 that allows for a physical connection to an external power supply.

In order to extend the longevity of the system as well as to increase mobility and autonomy of the BCI user 10, the systems and methods described herein can employ an architecture that distributes processing and data storage capabilities across non-implanted components of the system, with the implanted receiver and transmitter unit 102 responsible for obtaining and transmitting a signal indicative of the intent of the user. For example, the receiver and transmitter unit 102 can communicate with the implant 100 (e.g., an electrode) such that when the electrode detects a brain signal from a brain of the BCI user 10, the receiver and transmitter unit is configured to transmit an electronic signal representative of the brain signal.

FIG. 1C illustrates a variation of a signal control unit 120 that houses a power supply 50, processor 52, and circuitry 54-62 to enable wireless and/or wired electronic communication. The power supply 50 can comprise batteries or an external power source. The processor 52 is configured to apply one or more algorithms to decode the electronic signal from the transmission component. The signal control unit 120 can also be configured to produce an output signal upon determining that the electronic signal is representative of an intentional neural brain signal generated by the individual. Accordingly, the signal control unit 120 can house any number of communications circuitry or modules 54, 56, 58, 60, and 62 that can be used to electronically communicate with one or more external devices as discussed below. The modules can provide the signal control unit 120 with wireless or wired communication capabilities. Examples of wireless communication includes, but are not limited to, short-range wireless (e.g., Bluetooth or Bluetooth low energy (BLE)), ultra-high frequency (such as low power device 433 MHz), as well as the ability to communicate via an HTTP/HTTPS using a Wi-Fi or other network connection. In the variation illustrated in FIG. 1C, the signal control unit 120 can include one or more (BLE modules to simultaneously or sequentially communicate with the receiver and transmitter unit 102 as well as any number of external devices (e.g., the host device 130, external devices 132). The signal control unit 120 can also include different modules to simultaneously communicate with an alert device 128. Although not shown, the signal control unit 120 can include one or more speakers or alarms to play a tone, series of tones, pre-recorded message, or other audible message/sound. For example, the communications circuitry may include separate modules dedicated to different roles (such as a low-power link to implanted components, a standard link for controlling consumer devices, and a distinct link for local alerting) so that the system can continue providing at least limited functionality under different connectivity conditions.

In one variation of the system, the system is configured such that the signal control unit 120 is configured to interact with the receiver and transmitter unit 102 using a specific communication mode to limit distribution of data from the receiver and transmitter unit 102. Such a specific communication mode can be encrypted, secured, and/or otherwise proprietary. This prevents transmission of data from the receiver and transmitter unit 102 to unauthorized devices. In some variations of the system, a host device is configured to receive data using this specific communication mode from the signal control unit 120. Therefore, one distinction between a host device 130 and other external devices 132 is that the external devices receive data using standard communication modes. In one variation of the system, the specific communication mode can comprise a proprietary and/or encrypted BLE, while communication with other external devices relies on other communication modes. This allows the signal control unit 120 to isolate/control various other communication modes to prevent inadvertent output of data (e.g., to prevent data transmitted unintentionally over the internet or to an external device).

In an additional variation of the system, the signal control unit 120 receives an electronic signal from the receiver and transmitter unit 102 and produces a decoded output signal. The signal control unit 120 is aware of which external devices are connected and active. Based on this information, the signal control unit 120 can produce an output signal for an HID. This HID output signal can be sent to the currently active end device. In one variation of the system, the signal control unit 120 more than external device can be connected to the signal control unit 120 but the signal control unit 120 is configured to only send the output signal to one device at a time. While the end devices can be paired in the host device 130 (e.g., by a caregiver), the user can control which device is active using neural signals. Additionally, during the active HID session with the end device, another active session with the host device can be ongoing using a distinct wireless protocol, which allows for secure input/output to/from the signal control unit 120 to the host device that informs the configuration and control of the signal control unit 120. Additionally, or alternatively, a third “proto-profile” or distinct wireless signal based on a third wireless protocol may utilize input and output signals communicating with the operating system of the host device (e.g., iOS Switch Control or Assistive Touch) to allow the patient to control the desktop and any apps on the host device or an “end” device instead of the host device based on context data from the host device. By utilizing a plurality of distinct wireless profiles (protocols or modes), the signal control unit 120 can communicate adaptively with a plurality of connected devices based on the decoded signal and the connected devices with which the signal control unit 120 is communicating.

FIG. 1D illustrates an example of a portable signal control unit 120 having a housing 168 with a minimal user interface on the housing to enable a lower power design as described herein. The housing 168 is selected to be portable (e.g., it can fit within the pocket of a garment or can be worn by the individual). The user interface shown in FIG. 1D uses auditory, vibratory, and/or light feedback to provide user information. The housing 168 includes a power button 170 that can also toggle the signal control unit 120 between a locked and unlocked configuration as well as a sleep/low power mode. The power button 170 can be elastomeric or capacitive. The region 172 around the power button can provide general information. In the illustrated example, the information region 172 shows a ring-shaped light indicator to convey certain functions of the signal control unit 120. This light can vary in size and color and can pulsate to use varying frequencies of appearance to convey information. The housing 168 can also include a notification indicator 174 that can be used to call attention to system information such as errors or other notifications. The housing 168 can also include a power indicator 176 to show the power level/state of charge. Additionally, the housing 168 can include a connectivity indicator to convey the status of the signal control unit 120 connection with the receiver and transmitter unit or other component of the system. Variations of the signal control unit 120 can include any combination of the indicators described above. Moreover, in additional variations, the signal control unit 120 can include a detailed user interface rather than a limited user interface. Although not illustrated, the signal control unit 120 can include any additional ports, recovery buttons, speakers, etc.

The limited user-interface with portable/small volume pocketable hardware provides a prosthetic hardware and functions to replace at least some lost mobility and function of the peripheral nervous system for the BCI user. To reduce power usage between user interactions host and end devices, the signal control unit 120 can be configured to disconnect any external device (e.g., host and/or external device) to save power when the receiver and transmitter unit 102 are in an idle mode. The signal control unit 120 can further leverage automation, or shortcuts, upon connection, to open the host device upon request of the signal control unit 120. The ability to monitor connected devices and selectively engage various communication modes can allow a signal control unit 120 to provide a BCI function for the user over a duration of at least 4, 8, 12, 24 hours on single battery charge, during which time the signal control unit 120 can receive, decode, and transmit distinct output signals to a plurality of external devices without external power.

FIG. 1E shows a representation of an example of bonds between the various components of the BCI system. As shown, the receiver and transmitter unit 102 stores bonds for one signal control unit 120, one setup administrator device 148, and a charging device 124. As shown, the administrator device 148 can communicate with the receiver and transmitter unit 102 and/or the charging device 124 independently of the signal control unit. The system can be configured such that if a different instance of one of these elements connects, the prior instance's bond is cleared. In this variation, the receiver and transmitter unit 102 cannot connect to an administrator device 148 and a signal control unit 120 at the same time. The administrator device, like the host device, can be configured to communicate with the receiver and transmitter unit and/or signal control unit 120 using a specific communication mode discussed above.

The signal control unit 120 can act as a hub within the system such that it is optionally bonded with 0 to any number of external devices 132 such as end devices (such as an eye tracking device) as a GATT Server and BLE Peripheral; the signal control unit 120 can be bonded with one host device 130 at a time as a GATT Server and BLE Peripheral; and the signal control unit 120 can be bonded with one receiver and transmitter unit 102 as a GATT Client and BLE Central.

Because the host device role cannot be established until after both BLE bonding and a BLE handshake, the signal control unit 120 will not remove the previous host device 130 bond until after a new host device 130 is fully bonded, and the BLE handshake has been completed.

Since the signal control unit 120 is aware of its bonded devices, the signal control unit 120 includes roles as a central and a peripheral. In the peripheral role (as a BLE peripheral to end devices), the signal control unit 120 functions as an input/output device and allows the user to select between multiple end devices. The signal control unit 120 not only processes the decoded signal but also provides an adaptive output signal to the host device 130 or end device 132. In one implementation, the signal control unit 120 acts as the central to the receiver and transmitter unit 102 and a peripheral for all other connections, including host device 130 and end devices 132. When the signal control unit 120 is not connected to the receiver and transmitter unit 102, the signal control unit 120 can scan for the receiver and transmitter unit 102 and attempt to connect and maintain the connection whenever possible. For the other connections, the signal control unit 120 can communicate as being available and connectible, so to enable the peripheral devices to initiate a connection.

Actively maintaining a connection between the signal control unit 120 and a host device 130 allows for the quick transfer of data when needed. The connection between the host device (patient host software (host device) and the signal control unit 120 leverages a first secure wireless protocol/profile that provides Application Level (BLE) security. The host device 130 can connect to multiple services on the signal control unit 120, as described below. These allow bidirectional interaction with the host device for training, configuration, and utilization, as well as more generic HID or HID-like interactions with other apps on the host device and the host device itself. Due to the importance of patient privacy and the unique needs of implanted medical devices, the system consistently uses the first secure wireless protocol/profile to authenticate and encrypt BLE communications within the medical device software system.

Additionally, in a variation of the system, when an intentional neural signal is detected, the signal is converted into a Human Interface Device (standard HID profile) signal. This HID signal is sent to the currently active end device since the signal control unit 120 maintains a list of paired devices. As such, there may be more than one connected device, but only one is actively receiving HID from the signal control unit 120 at a time. The end devices can be paired in the host device (e.g., by a caregiver), but the patient may control which end device is active with neural signals.

Additionally, or alternatively, a third “proto-profile” or distinct wireless signal based on a third wireless protocol can use input and output signals communicating with the operating system of the host device (e.g., iOS Switch Control or Assistive Touch) to allow the patient to control the desktop and any apps on the host device or an “end” device instead of the host device based on context data from the host device of the a first secure wireless protocol/profile which provides additional HID-like features and operates as standard BLE in communication between medical and non-medical applications using standard BLE security.

The use of distinct BLE protocols solves the challenge of the different types of security needed for the different types of external host device connections. By utilizing a plurality of distinct wireless profiles (or protocols), the signal control unit 120 is able to communicate adaptively with a plurality of connected devices based on the decoded signal and the connected devices with which the signal control unit 120 is communicating.

In a variation of the system, the signal control unit 120 will not necessarily maintain a concurrent BLE connection with every bonded device and will have one connection to a receiver and transmitter unit 102, one connection for purpose of providing user interface control via any external device/HID. This connection could be to an any external device, such as an end device or to the host device. The signal control unit 120 does not need to maintain connections to external devices where the signal control unit 120 is not providing UI control.

In additional variations, the signal control unit 120 maintains one connection for proprietary GATT communication when HID control is to an end device rather than a host device. Proprietary host device application communication with administrator services can always enabled whenever the host device is able to connect, even when end device control is in use.

While the signal control unit 120 is providing UI control to the host device, both the HID and proprietary host application communication can optionally take place via the same BLE connection between the SCU and the host device. When the signal control unit 120 is configured for UI control of an End Device, HID application communication can take place over the active end device connection, and no HID communication is conveyed to the host device. A caregiver may still use the host app to send GATT commands to the SCU, as this connection remains intact during end device control. In additional variations, the system signal control unit can operate even though there are no connections established, such as when no applicable devices are bonded or in range of the SCU.

The devices, methods, and systems described herein can benefit or be combined with endovascular carriers and electrode arrays and systems/methods of using neural signals disclosed in U.S. Pat. No. 10,575,783 issued on Mar. 3, 2020; U.S. Pat. No. 10,485,968 issued on Nov. 26, 2019; U.S. Pat. No. 10,729,530 issued on Aug. 4, 2020; and U.S. Pat. No. 10,512,555 issued on Dec. 24, 2019. U.S. Publication Nos.: US20190358445 published on Nov. 28, 2019; US20180303595 published on Oct. 25, 2018; US20200352697 published on Nov. 12, 2020; US20190038438 published on Feb. 7, 2019; US20200078195 published on Mar. 12, 2020; US20190336748 published on Nov. 7, 2019; US20200016396 published on Jan. 16, 2020; US20200363869 published on Nov. 19, 2020. U.S. application Ser. No. 17/093,196 filed on Nov. 9, 2020; and U.S. application Ser. No. 18/792,965 filed on Aug. 2, 2024. PCT Application Nos.: PCT/US2020/060780, PCT/US2020/059509, both filed on Nov. 6, 2020. U.S. Provisional application No. 63/003,480 filed on Apr. 1, 2020; 63/057,379 filed on Jul. 28, 2020; and 63/062,633 filed on Aug. 7, 2020. The contents of each of which are incorporated herein by reference in their entirety.

The implanted components (e.g., the implant 100 and/or the receiver and transmitter unit 102) can include amplifiers, filters, controllers, data storage, a power supply, and wireless communication equipment (e.g., RF, Bluetooth, etc.). Moreover, the communication 110 between the receiver and transmitter unit 102 and signal control unit 120 can occur wirelessly via any of the wireless communication modalities discussed herein, including but not limited to Bluetooth, BLE, UHF, RF, Wi-Fi, and/or ultra-wideband (UWB). In some variations, communication can occur through a wired connection. Likewise, the connection 112 (e.g., the communication) between the signal control unit 120 and host device 130 can occur through wired or wireless connections. Moreover, as discussed below, any of these communications modes can occur via a local network or a cloud-based network.

It should be noted that while the signal control unit 120 and host device 130 are illustrated as separate components, variations of the system can include a signal control unit 120 that is integrated into a host device 130 either by hardware components or through software integration.

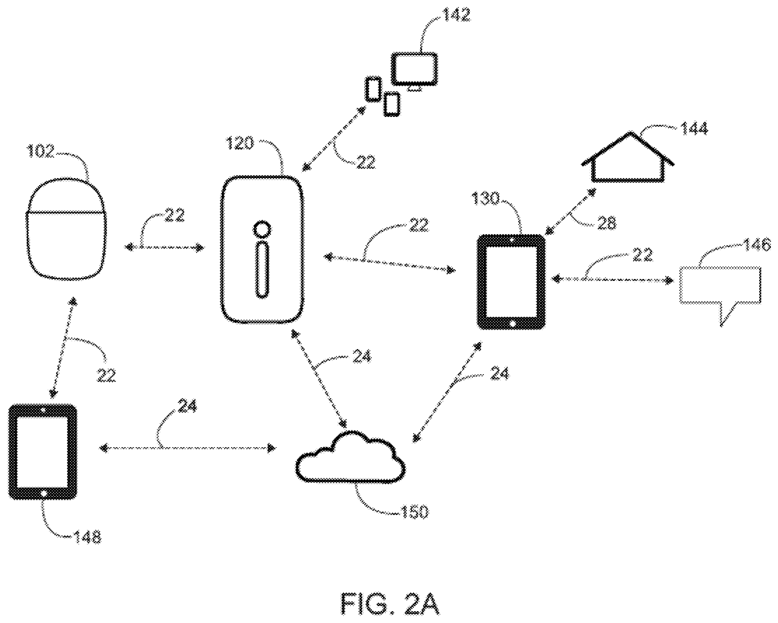

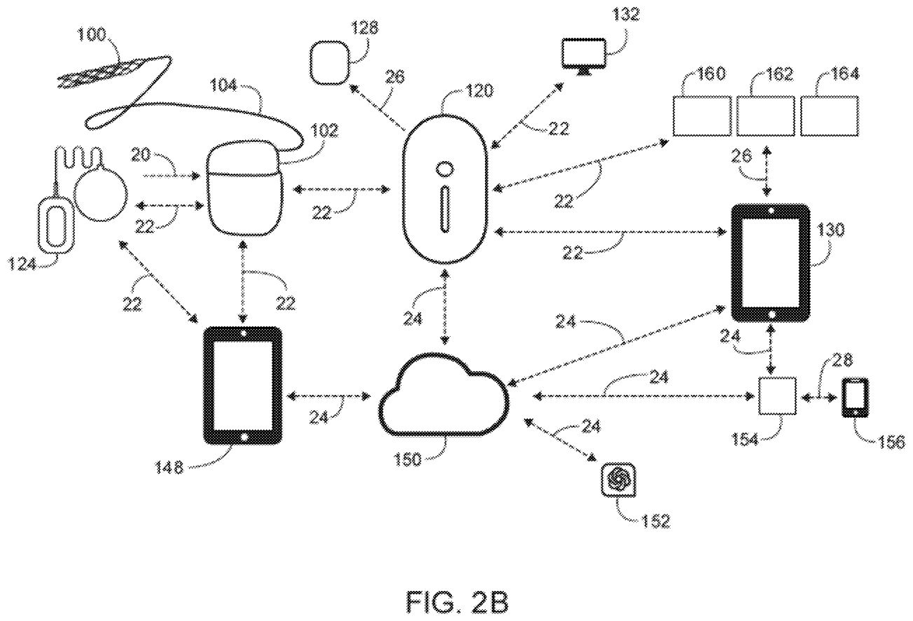

FIG. 2A provides a simplified illustration of an interface system using a signal control unit 120 as a central hub for communication with various external devices using different wireless communication modalities 22, 24. As noted above, signal control unit 120 processes one or more decoding algorithms when receiving information from the receiver and transmitter unit 102. This information flow (e.g., the communication 110) can occur via any wireless communication modality, e.g., BLE. However, other transmission protocols, as well as a wired connection, are within the scope of this disclosure. Alternatively, or in combination, an administrator device 148 can communicate directly with the receiver and transmitter unit 102. In such a case, the administrator device 148 can house an integrated signal control unit either through hardware or software. In either case, the signal control unit 120 can access a cloud network 150 or infrastructure through Wi-Fi, cellular, or any other network connection means. The ability to access a cloud environment allows for analysis, meta-analysis, generative client/predictive text, the ability to assist patients remotely, and to provide software downloads remotely. A cloud computing and storage component can also allow for aggregation of data and provide managing physicians and data.

In addition, any number of host applications/devices (a monitoring service 142, a network 144, and/or messaging 146) can communicate with the signal control unit 120 either through direct connections 112 (e.g., BLE) or via a network 144 to access a cloud network 150. For example, the host applications can include personal digital devices and/or a monitoring service 142, and the host application can include the network 144 (such as home automation), messaging 146 via text or similar communication modes.

Again, the host device 130 and/or the administrator device 148 applications can provide a graphical user interface for the users to calibrate and utilize decoding algorithms to control the host device and to provide Bluetooth HID (Human Interface Device) inputs to BT-enabled devices. In addition, remote monitoring (using the monitoring service 142) can be used to ensure that the patient and BCI are operating as desired. Furthermore, in case of malfunction, the signal control unit 120 can initiate communications with any external device upon the indication that the BCI or receiver and transmitter unit 102 is not functioning properly.

FIG. 2B illustrates an additional variation of an interface system, where the multiple and distinct communication channels of the signal control unit 120 allow an individual BCI user to operatively engage one or more external devices to improve autonomy for the individual. As noted above, a neural interface device detects a brain signal or neural activity from the individual. The neural interface device includes one or more electrode components that are electrically coupled with a receiver and transmitter unit 102 (which may be another component). Upon receiving a signal from the electrode component (e.g., the implant 100), the receiver and transmitter component transmits an electronic signal representative of the brain signal to the signal control unit 120. In one variation, the receiver and transmitter unit 102 transmits the electronic signal representative of the brain signal to the signal control unit 120 using a BLE transmission 22. As noted herein, the use of BLE allows for reduced power demands from the receiver and transmitter unit 102. However, additional variations of the systems and methods disclosed herein can use any wireless transmission modality as discussed herein.

It is noted that FIG. 2B illustrates various specific wireless transmission modalities between the various components. For example, BLE 22, network/internet/HTTPS 24, UHF 26, short messaging service “SMS” 28. These specific wireless transmission modalities demonstrate one variation of an improved BCI device (e.g., the implant 100, the one or more leads 104, the receiver and transmitter unit 102, the signal control unit 120, and/or the host device 130) operating in a much larger system. However, additional configurations of the system contemplate any wireless transmission modality being used between any components of the system.

As discussed above, FIG. 2B illustrates a fully implantable neural interface device that comprises an electrode carrier (e.g., an implant 100) coupled to a receiver and transmitter unit 102 via one or more wires/leads (e.g., the one or more leads 104). However, additional variations can include external neural interface devices or partially implanted neural interface devices (i.e., where a portion of the neural interface device extends externally from the body). FIG. 2B also shows an administrator device 148 that can be used for the initial setup of the system or system monitoring. The administrator device can interact with any of the system components using the communication channels independently of the user or in assisting the user.

The variation of the system shown in FIG. 2B includes a signal control unit 120 having a housing structure that is physically separate from the neural interface device (e.g., the implant 100, the receiver and transmitter unit 102, the one or more leads 104) and is configured to be portable such that signal control unit 120 can remain with the individual while remaining in operative engagement the system. The signal control unit 120 processes the electronic signal representative of the brain signal using one or more processors that apply one or more algorithms to decode the electronic signal from the transmission component. As noted above, variations of the system include performing all or the majority processing of the electronic signal within the signal control unit 120. However, additional variations can include performing processing of the signal within one or more processors of the receiver and transmitter unit 102. Alternatively, or in combination, some processing can occur through external processing from a host device 130 or via one or more cloud networks 150 (e.g., cloud-based networks).

Once the system that the electronic signal is representative of an intentional neural brain signal generated by the individual, the signal control unit 120 can transmit an output signal to one or more external devices using the signal control unit. In the illustrated variation, the signal control unit 120 exchanges data via a BLE transmission 22 with a personal host device 130 (such as a tablet computer, a computer, or other electronic device). However, additional variations of the system can include the signal control unit 120 directly communicating with other external electronic devices 160, 162, 164.

In some variations, the signal control unit 120 is configured to work with one or more external devices 132 such as end devices, where an end device is any digital device that supports HID profiles for a keyboard, mouse, or other peripheral devices. Interconnectivity with end devices in the patient's home can leverage traditional pass-key pairing to a BLE HID device with the help of the host device 130. In one example, an end-device can include an eye-tracker or other applications that assist the individual in using the BCI interface.

Variations of the system include a host device 130 that supports secure and proprietary communication with the signal control unit 120 and provides the necessary user interface to support patient training and use of the entire BCI system. Individuals can use their host device to control a wide variety of applications, including but not limited to texting, writing documents, using social media, internet communications, shopping, interaction with home appliances and home automation, health applications, banking applications, etc.

The system shown in FIG. 2B also contemplates that one or more of the external electronic devices (e.g., the host device 130, external electronic devices 160, external electronic devices 162, and external electronic devices 164) generates or passes data (“device data”). This device data is transmitted to the signal control unit 120, which can then transmit the device data back to any of the external electronic devices (e.g., the host device 130, external electronic devices 160, external electronic devices 162, and external electronic devices 164).

FIG. 2B illustrates that the interface system can interact with cloud-based software and data through various communication pathways. In one variation, various host devices 130 can be synchronized with the cloud network 150 data for a variety of purposes. The cloud network 150 can also store proprietary software relating to system components as well as authentication and certificate services, which are used both during product use and for production, manufacture, and installation of the system. The internet connection 24 (between the signal control unit 120 and cloud network 150) can also be used to generate online notifications to a caregiver. In the example shown, the signal control unit 120 can send data to the cloud network 150 that ultimately goes to a caregiver's cell phone 156 via SMS 28 messaging. Likewise, the caregiver can communicate with the user's host device 130 via SMS 154 or directly to the signal control unit 120 via the internet connection.

The system network and communication channels allow cloud connectivity for various individuals to monitor and review the performance of the BCI user to provide assistance or to improve the performance of the system. In some variations, the cloud network 150 stores neural data from the individual (or various other individuals) and can convey requests to third-party services, including support for notification use cases described in more detail elsewhere herein.

The cloud network 150 also allows the system to access artificial intelligence (AI) that can be transmitted to any component of the system. In the example shown, the AI involves a large language model 152 that assists the BCI user to communicate with others by providing generative content as described in U.S. application Ser. No. 18/734,476 filed on Jun. 5, 2024, the entirety of which is incorporated by reference.

One additional benefit of the interface systems and methods described herein is that the low power, portability, and a number of distinct wireless communication modalities offer an “always-on” functionality. For example, given that the receiver and transmitter unit 102 is charged and the signal control unit 120 and host device 130 are powered, then the individual can use the complete system independently and on-demand for an extended period (e.g., 24 hours or more). This always-on feature allows the individual the ability to engage in digital daily living activities like telehealth, social media, communication, or adjusting interacting with various home interface systems that are based automation or control of appliances (e.g., the external electronic devices 160, 162, 164). More importantly, the always-on feature can assist by providing potentially lifesaving messages to caregivers. By having the ability to run the system on battery power for an extended period allows this notification capability to work outside, away from home, and generally without the internet. Without an internet connection the system can still communicate to other devices, either in the individual's home (e.g., the external electronic devices 160, 162, 164) or to devices outside of the home (e.g., 156). The signal control unit 120 can also communicate with devices if the host device 130 is offline. For example, the signal control unit 120 can send signals to one or more alert devices 128 using low power device 433 MHz. The always-on feature also allows the user to transition from an idle state and immediately request caregiver assistance (e.g., if the individual awakes at night and can instantly message a caregiver). For example, a caregiver-contact output may be deliverable through an internet-mediated path when available, and through a local radio alert path when internet connectivity or a host device is not available.

Another benefit of the system described includes selective control between a host device 130 and any number of the external electronic devices 160, 162, 164, where the control is adaptive based on detected bonding and/or active connections between the signal control unit 120 device and external electronic devices 160, 162, 164 and based on differentiated intent information (confirmation of the intentional neural brain signal generated by the individual and decoded into an electronic signal transmitted to the SCU). An active connection means that the external device is bonded to the host device 130 and active such that the external device is ready to exchange data with the host.

Adaptive control can occur with the host device as well as any number of external devices selected by the user through the use of the signal control unit. The signal control unit 120, through bonding as discussed above, knows which devices are connected, and the signal control unit 120 translates the decoded intent signals generated by the individual adaptively based thereon. The term “bonding” is intended to refer to a relationship established between two devices, allowing for secure reconnection without re-pairing. This can be accomplished by the host device or any device in the system. In some cases, term pairing includes any process where devices exchange the information necessary to establish a connection or an encrypted connection.

As the signal control unit 120 translates the decoded signal into one or more output signals, the signal control unit 120 can use information on the number of bonded devices to take into account how to relay the output signal. This allows the BCI user an individual autonomous control of interactions with a variety of different external devices without dependence on a caregiver. As one example, as noted above, if the individual generates an intent to contact a caregiver, once this intent is sent to the signal control unit for decoding and confirmation, the signal control unit 120 can generate an output command based on the bonded devices available. If the BCI user is in a situation where there are no bonded devices or if there is no network connectivity, then the signal control unit 120 can transmit the output through a fallback communication protocol (e.g., 433 MHz to an alert device 128). This capability can also be applied to system warnings. For example, the system may select among different output mechanisms based on which devices are currently connected and what communication links are available.

In one variation, the BCI system can be configured to monitor the ability of the system to detect a brain signal from the user and determine that the electronic signal associated is representative of an intentional neural brain signal generated by the individual. In some cases, an individual might suffer from deteriorating health such that the signals generated by the brain change or deteriorate, causing a BCI system that once was properly functioning no longer function due to the deteriorating condition of the individual. In such a case, the signal control unit 120 can be configured to provide notice to a caregiver or other medical practitioner.

In an additional variation of the system shown in FIG. 2B the signal control unit 120 receives an electronic signal from the receiver and transmitter unit 102 and produces a decoded output signal. The signal control unit 120 is aware of which external devices are connected and active. Based on this information, the signal control unit 120 can produce an output signal for an HID. This HID output signal can be sent to the currently active end device. In one variation of the system, the signal control unit 120 more than external device can be connected to the signal control unit 120 but the signal control unit 120 is configured to only send the output signal to one device at a time. While the end devices can be paired in the host device 130 (e.g., by a caregiver), the user can control which device is active using neural signals. Additionally, during the active HID session with the end device, another active session with the host device can be ongoing using a distinct wireless protocol, which allows for secure input/output to/from the signal control unit 120 to the host device that informs the configuration and control of the signal control unit 120. Additionally, or alternatively, a third “proto-profile” or distinct wireless signal based on a third wireless protocol may utilize input and output signals communicating with the operating system of the host device (e.g., iOS Switch Control or Assistive Touch) to allow the patient to control the desktop and any apps on the host device or an “end” device instead of the host device based on context data from the host device. By utilizing a plurality of distinct wireless profiles (protocols or modes), the signal control unit 120 can communicate adaptively with a plurality of connected devices based on the decoded signal and the connected devices with which the signal control unit 120 is communicating.

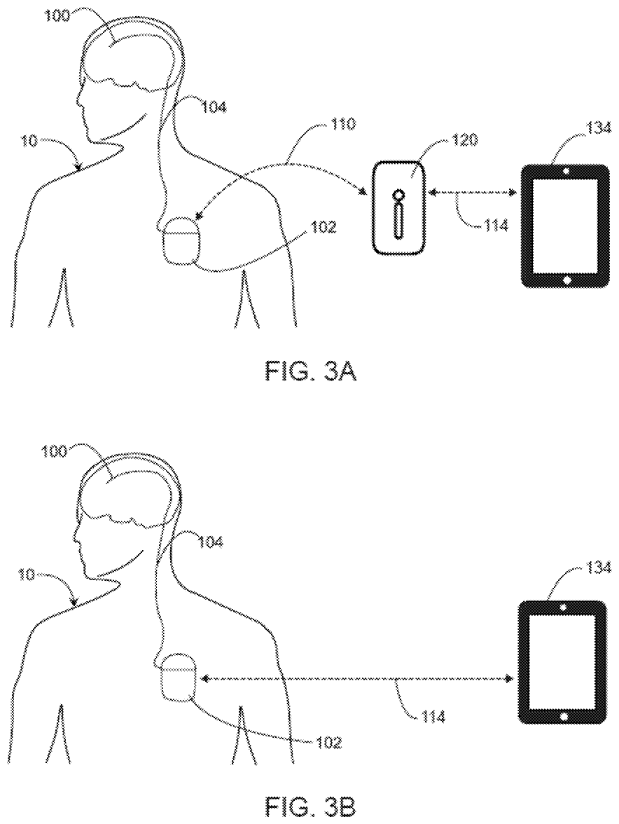

In some variations of the system, a connection between a signal control unit 120 and a host device 130 is immediately disconnected after data transfer and when data is not being transferred between the signal control unit 120 and host device 130 to preserve power. However, this can increase the latency of the system. In order to improve the user experience for the systems described in this disclosure, e.g., as shown in FIGS. 3A and 3B, the components of the system can be configured to minimize system latency for the user to use brain activity to engage with host/external devices. For example, both the host and end devices can keep their connections active when the signal control unit 120 is in use. This can allow a low system latency (e.g., less than 100 ms) from detection of implanted neural signal, transmission and wireless receipt of the signal by the signal control unit 120, decoding and translation of neural signal to an output signal using the signal control unit 120, and transmission of a second wireless transmission from the signal control unit 120 to one or more external devices. The selective control between host and end devices can be adaptive based on detected bonds (between the signal control unit 120 and external devices) and differentiated intent information (decoded signals from the neural signals received from the electrode device and decoded by the signal control unit 120 device).

FIGS. 3A and 3B illustrate another variation of a BCI interface that allows for frictionless interaction between the BCI units (e.g., the implant 100, the receiver and transmitter unit 102, and/or the one or more leads 104) and consumer electronics having standard and customized user interfaces that can be controlled via standardized communication protocols. In this variation, consumer electronics can include an end device and/or any human interface device (HID) 134 such as a smartphone, tablet, computer, etc. The purpose of the improved BCI system is to increase the usability of the BCI system for a wider group of users with varying levels of BCI control. FIG. 3B shows a variation where end device/HID functions as the receiver and transmitter unit described above through an application on the device 134.

The degree to which a person can control a BCI to generate a control signal varies among individuals. For example, some individuals can generate complex control signals that can be used to perform complex tasks, such as high degrees-of-freedom (DoF) control of a robotic arm in 3-dimensional (3D) space and direct brain-to-speech generation, while other individuals can only generate a simple control signal, such as a binary output.

The variability is also found in non-BCI control signals. For example, some individuals can use traditional methods to interact with human interface devices normally, but other individuals having significant motor impairments can only generate low levels of control signals using their bodies to interact with the digital devices. Many consumer electronics, such as laptops, mobile phones, televisions, have built-in control systems that provide a wide range of users with varying levels of control of the device. For example, Switch Control or Assistive Touch is built-in interaction method implementation from Apple for iOS and iPad OS to cater for users with limited mobility to gain full control of the devices. Importantly, these interaction methods can be controlled using a standardized protocol, such as universal serial bus (USB) HID. Typically, the interaction occurs using a keyboard and a mouse- or devices that mimic the outputs of a keyboard and mouse.

Ordinarily, in the case of a BCI user, the system requires custom software to cater for the wide range of users to create interaction methods that can be used to perform useful tasks, meaning that the tasks that can be performed are limited to what that custom software can do. Often, custom software function is limited compared to what the originating company can do (i.e., a 3rd party app has less function on an Apple device compared to an app that Apple themselves makes). The systems described herein overcome conventional challenges by providing a BCI system that translates any control signal from BCI to standardized communication protocols already used to control existing consumer products or HID. Such a system increases the breadth of users and devices that can interface with the BCI system.

FIGS. 3A and 3B are representative illustrations of improved BCI systems that allow an individual 10 to communicate with common consumer devices 134. For purposes of illustration, the consumer device 134 is shown as a tablet. However, any consumer device is within the scope of this disclosure. In FIG. 3A, the BCI can include an internal unit (e.g., a receiver and transmitter unit 102) that is coupled to one or more units that detect neural signals from the individual. The unit can correspond with a signal control unit 120 that can be coupled or paired with the consumer device 134. The signal control unit 120 can generate commands 114 that are specific to the device 134. For example, the command 114 can allow the signal control unit 120 to control a cursor or prompt on the device 134 such that the individual 10 can control the device 134 using the controls inherent to the device. Coupling to the signal control unit 120 and the device 134 can occur via a wired connection or wireless connection using any number of communication protocols.

FIG. 3B illustrates another variation of the BCI system where the implanted unit (e.g., the receiver and transmitter unit 102) is configured to couple directly to the consumer device 134.

The systems and methods described herein allow for multiple configurations to enable a BCI user to have increased autonomy and interaction with his/her environment. As one example, in the case where the BCI user has limited motor ability and requires a caregiver, the systems described herein can allow the BCI to sleep at night and also allows the caregiver to go to bed. While the BCI user is sleeping, a signal control unit can enter an “idle” or “locked” mode by monitoring the BCI user, monitoring the environment, or by a control button on the signal control unit. This idle/locked mode can be a low energy consumption state. If at some point during the night the BCI user awakes, user has the ability to trigger the signal control unit to wake up any host device (e.g., via the proprietary/secure/encrypted BLE output signal) to engage applications on the host device. The host device BCI app can display an option to notify a caregiver or use the system (perform instrumental activities of daily living “IADLS”). The individual can choose to use the system to launch a website (via DMO based on decoded signal of neural data recorded from patient intent), allowing the patient to scroll through a feed (using HID) or other internet-based content. If there is loss of an internet connection or other loss of connectivity to the signal control unit, the system can notify the caregiver or other individual by either generating an audible tone/series of tones using the signal control unit's internal speaker and/or generate an alert signal using 433 MHz to any configured receiver, to a chime or doorbell type device. This alert signal can be initiated through the system and/or could also be initiated by the individual's neural signal. This can alert a caregiver or other individual that the user requires assistance. If there are no conditions where the BCI user requires assistance, the system allows the user to fall back asleep, causing the signal control unit to transition back to idle mode. Later, the BCI user could awaken again and then decide to watch a TV that is configured as another external device (either directly or through the host device). The BCI user is able, via HID control, to turn on and select media content to watch without waking the caregiver. Finally, the patient can decide to send a message to the caregiver via the host device, to thank them for their assistance and let them know they are going to sleep.

The systems described herein can also be used to notify a caregiver, or other individual, when one or more components of the BCI system, including but not limited to the receiver and transmitter unit 102, the signal control unit 120, and/or the connection to any of the cloud based environments (e.g., the cloud network 150) without the need for the individual to generate the notice. In such a case, the system can be configured to provide an outage warning if any of the components of the system are operating at an unacceptable level. In one variation, the system monitors the connection between the processor (e.g., the signal control unit 120) and its connection to the internet (e.g., the cloud or other network). If the caregiver (or other individuals) is not made aware of any outage, then the caregiver cannot trust that the system is working for the BCI user. By including an outage monitoring function, the system can monitor activity over the cloud or internet to ensure that a notification is sent if any components of the system appear to be offline. In additional variations, the BCI engages a cloud service (e.g., Amazon Web Services) for receipt and transmission of informational packets about the health of the components of the system (including but not limited to the receiver and transmitter unit 102, signal control unit 120, host device 130, etc.) Monitoring these packets can be used to provide notification to any caregiver (or other individual) if analysis of the packets show a problem within the system or if the packets are not received by AWS for a period of time. The monitoring capability of the system can also override any “lock”, “idle”, or similar mode of the receiver and transmitter unit and/or signal control unit in the event that a caregiver must contact the BCI user.

Additional variations of the BCI systems can be configured to allow BCI users to directly trigger common gesture commands associated with various electronic devices such as an Apple Vision Pro, Meta Quest, Ray-Ban Meta smart glasses, or other similar devices.

For example, spatial computing devices using gesture control using a camera or other wearable hand control, as well as voice and button controls have limitations with accuracy and precision in interpreting user gestures, leading to unintentional actions. The present systems can suffer latency delays between gesture input and system response. The gestures may not be recognized properly in various lighting conditions or if the background is too cluttered. Extended use of gesture controls in current systems can lead to physical fatigue, especially with complex or repetitive gestures. There is also a learning curve associated with such devices where users may find it challenging to learn and remember the various gestures required for different commands. There is also a limited range of gestures available as well as the need to prevent hands or objects blocking the sensors can prevent proper gesture recognition and the need for consistency in producing the gestures, which can vary across different users or even for the same user over time. Other problems include accessibility challenges for users with physical disabilities, privacy issues with continuous monitoring of gestures, maintenance and calibration of the system. In variations of the methods and systems described herein, the signal control unit is configured to detect whether an external device having gesture control is connected thereto, and alter an output signal to trigger one or more of the gesture controls of the external device.

The BCIs of the present system can address these issues by offering a significant number of one-dimensional (1D) continuous DMO signals. Each DMO signal can be matched to a gesture command of the systems described above. Configuring DMOs of an individual to directly produce the gesture command can allow the BCI user to have superior control of a spatial computing device without many of the drawbacks currently associated with gesture control on special computing devices.

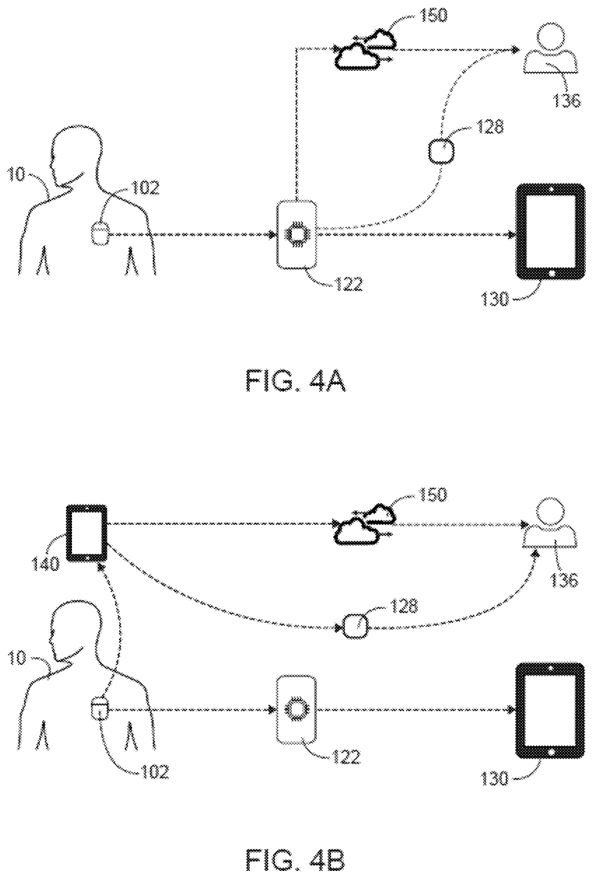

FIGS. 4A and 4B illustrate a variation of a system similar to that described above where the receiver and transmitter unit 102 are configured to inherently implement basic or low-level functionality without the need of using a signal control unit or any external processor 122. FIG. 4A represents a variation of the systems described above where an individual 10 using a BCI employs a receiver and transmitter unit 102 (as described above) that transmits signals to a processor 122 (such as the signal control units described above). This allows the individual 10 to interact with external devices (including but not limited to host devices 130) as well to provide notification to a caregiver 136 using a cloud-based gateway (e.g., the cloud network 150) and/or an alert device 128 (e.g., a notification device).

FIG. 4B illustrates a configuration where the receiver and transmitter unit 102 is configured to decode brain activity from the individual 10 and electronically communicate with the processor 122 and/or a personal electronic device 140 that is configured to interact with the caregiver 136 using an alert device 128 (e.g., through an audible signal delivered to the caregiver). In some variations, the personal electronic device 140 will be configured with a communication modality (e.g., a wireless or wired connection) to send a signal to the cloud-based gateway (e.g., the cloud network 150) for communicating with the caregiver 136. For example, the personal electronic device 140 can comprise a smartphone with a dedicated medical application for receiving and transmitting signals from the receiver and transmitter unit 102. Use of a commercially available smartphone or similar device allows the associated data transmitting capabilities of the device 140 to convey notifications that ultimately go to a caregiver 136 or other individual. Such commercially available devices 140 can be stored on the user 10 (e.g., in a pocket, bag, etc.) without the risk of heating concerns. The use of a mobile application can allow for always-on connectivity and portability while allowing down- (or de-) classification of the processor 122.

Variations of the system where a receiver and transmitter unit include the ability to communicate directly with a personal electronic device 140 allows the individual 10 to notify or receive assistance from another, such as a caregiver 136, without the use of a processor 122. While FIG. 4B shows the receiver and transmitter unit 102 in communication with the processor 122, the receiver and transmitter unit can still communicate with the personal electronic device 140 in the event that communication with the processor 122 is stopped. For example, the processor 122 can be damaged, misplaced, out of range, or lack power, but the connectivity of the receiver and transmitter unit and the personal electronic device having data capabilities allows for the individual 10 to remain in communication with others using the system.

The basic or low-level functionality of the receiver and transmitter unit 102 can comprise any basic notification or command using firmware or other custom hardware. For example, such functionality can include support for changing the processor between an active and idle mode for external digital device control (e.g., a lock/unlock state); decoding of patient intent to send a notification as noted above. For example, such basic functionality can include detecting a simple user intent sufficient to trigger a caregiver notification or to control a lock/unlock state for external-device interaction. By way of further example, such basic functionality may be associated with a bounded vocabulary of the receiver and transmitter unit 102.

In some variations, the personal electronic device 140 only uses software or minimal hardware modifications to relay signals from the receiver and transmitter unit 102. In additional variations, the personal electronic device 140 can operate without a visual user interface but only acts as a gateway to internet notification of caregivers (e.g., to deliver an audible signal or pre-configured message). As noted below, when operating in this reduced state, the receiver and transmitter unit 102 can be configured to operate in a condition that requires relatively lower power requirements.

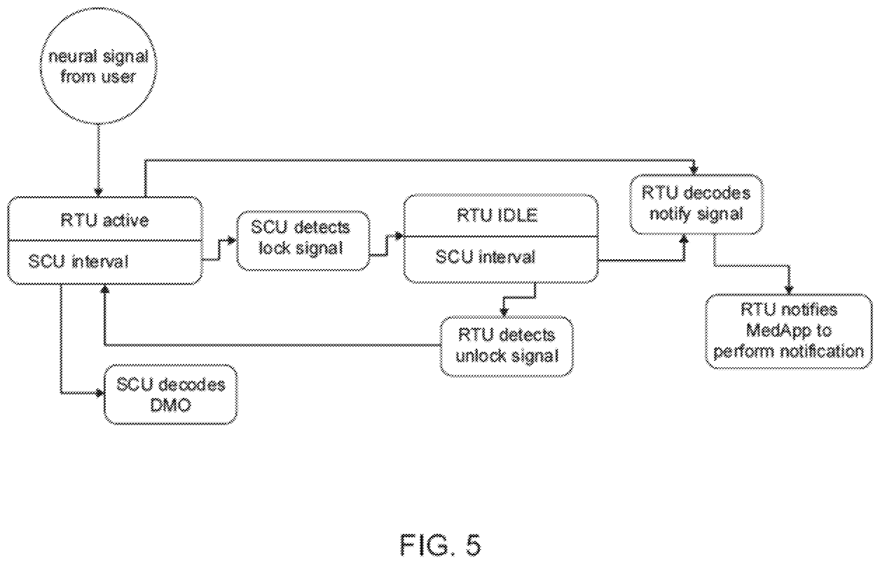

In one example, as shown in FIG. 5, the receiver and transmitter unit can be configured to operate in a configuration where transmission to the processor or signal control unit is maintained at a minimal level to maintain connection with the processor/signal control unit but in a mode that requires much less power than when operating in a normal configuration.

Returning to FIG. 5, the receiver and transmitter unit is configured to receive a neural signal from the user. In an active mode, the receiver and transmitter unit communicates or streams to the signal control unit at a standard interval (e.g., 7.5 ms). However, once the receiver and transmitter unit or signal control unit detects that the system should enter a lock mode (e.g., by receipt of a “lock” signal or command), the receiver and transmitter unit enters an idle state where the communication interval with the signal control unit is reduced (e.g., 4s). Such a reduced communication interval will maintain a connection between the receiver and transmitter unit and the signal control unit but at a much reduce power consumption by the receiver and transmitter unit. Upon detecting the unlock signal or command, the system can return to the active mode and operate in a normal configuration. FIG. 5 also shows that in either the idle or active mode, the receiver and transmitter unit will be capable of decoding a signal (as discussed above) to exit the idle mode or to use an application (e.g., a MedApp or medical application) running on a personal electronic device to send a notification or other message to one or more individuals (e.g., a caregiver). For example, even while operating with a reduced communication interval to conserve power, the implanted unit may still detect an event (e.g., an unlock-related event or a notification-related event) and cause a transition back to a higher-activity state and/or cause a notification to be issued via a personal electronic device.

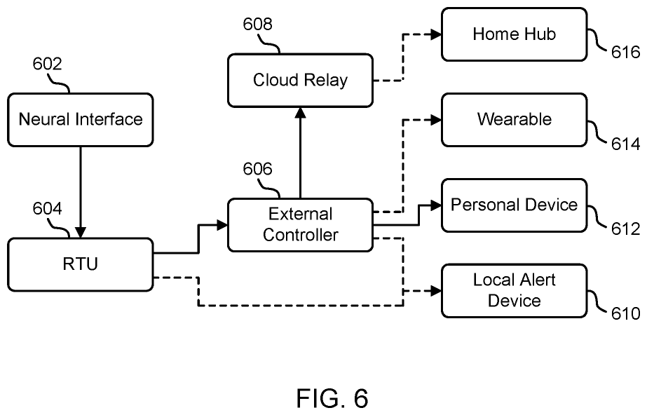

FIG. 6 shows a system architecture diagram 600 illustrating the components of an implantable neural interface system and the communication paths therebetween. As shown in FIG. 6, the implantable neural interface system includes a neural interface 602, a receiver and transmitter unit (RTU) 604, an external controller 606, and a cloud relay 608. The system further includes a plurality of endpoint devices, including a local alert device 610, a personal device 612, a wearable 614, and a home hub 616.

The neural interface 602 may be implanted in a user and configured to detect brain signals from the user and generate electronic neural signals representative of the brain signals. The neural interface 602 may include one or more electrode components positioned within or adjacent to neural tissue, such as within the motor cortex or other regions of the brain. The neural interface 602 is coupled to the RTU 604, which receives the electronic neural signals from the neural interface 602. In some examples, the neural interface 602 is coupled to the RTU 604 via one or more lead members. In some examples, the neural interface 602 and the RTU 604 communicate wirelessly.

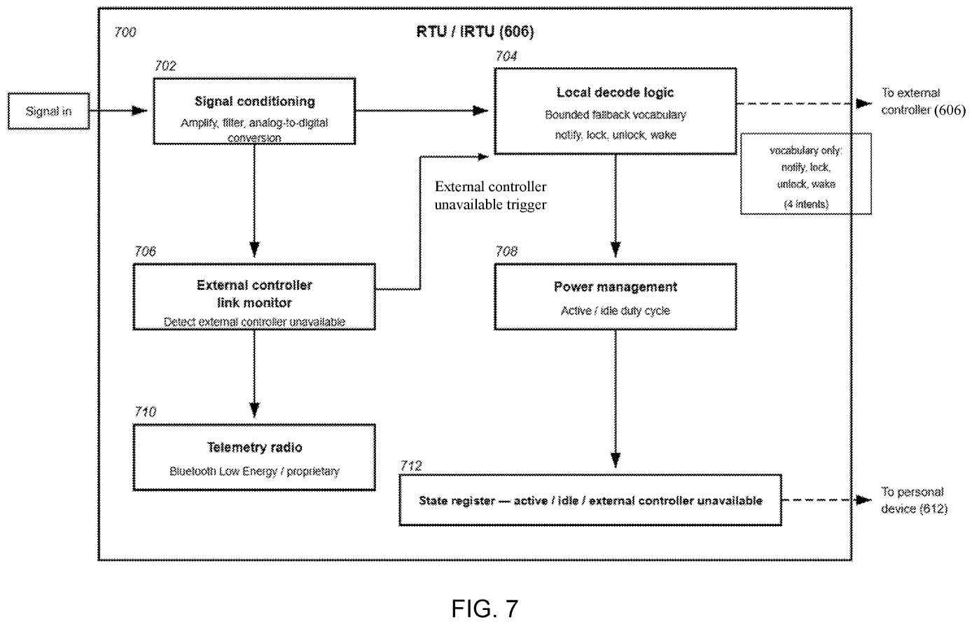

The RTU 604 may be implanted in the user and configured to receive the electronic neural signals from the neural interface 602 and communicate those electronic neural signals with the external controller 606. The RTU 604 may include processing circuitry configured to perform local signal processing, local intent decoding from a bounded fallback vocabulary, power management including active and idle duty cycle control, and state management functions. The RTU 604 may also include a wireless communication interface, such as a telemetry radio supporting Bluetooth Low Energy (BLE) or a proprietary wireless protocol, for communicating with the external controller 606 and with other devices such as the personal device 612. The internal architecture of the RTU 604 is described in further detail with reference to FIG. 7.

The external controller 606 may be physically separate from the RTU 604 and configured to be portable. The external controller 606 may receive the electronic neural signals from the RTU 604 and decode user intents therefrom during a first operating mode. In some examples, the external controller 606 corresponds to a signal control unit (SCU) as described elsewhere herein. In some examples, the external controller 606 is implemented by a host device that executes a neural interface application without a separate signal control unit. In some examples, the external controller 606 is implemented by a signal control unit operating in conjunction with a host device. The external controller 606 may serve as the external processing system referenced in the claims and elsewhere in this disclosure.

As shown in FIG. 6, the RTU 604 communicates with the external controller 606 via a primary communication path (shown as a solid line), which may carry the electronic neural signals for full decoding by the external controller 606 during normal operation. The external controller 606 may in turn communicate with the cloud relay 608 via a network connection, such as a Wi-Fi or cellular connection, to access remote services including cloud-based analytics, generative language models, notification relay services, and software updates. The cloud relay 608 may also communicate with one or more of the endpoint devices, such as the home hub 616, the wearable 614, or the personal device 612, to relay caregiver notifications or other data.

The external controller 606 may also communicate directly with one or more of the endpoint devices. For example, the external controller 606 may communicate with the personal device 612 via BLE or another wireless protocol, with the wearable 614 via BLE, with the local alert device 610 via a sub-GHz radio frequency signal (such as a 433 MHz signal) or via BLE, and with the home hub 616 via a network connection or BLE. These communication paths from the external controller 606 to the endpoint devices are shown as dashed lines in FIG. 6, indicating that they represent available paths that may or may not be active depending on the system state and the availability of the external controller 606 and network connectivity.

The RTU 604 may also maintain a direct communication path to the personal device 612 (shown as a dashed line in FIG. 6) independently of the external controller 606. This direct path allows the RTU 604 to transmit a caregiver notification or other signal to the personal device 612 even when the external controller 606 is unavailable (for example, because the external controller 606 is out of wireless range, powered off, physically damaged, misplaced, or in a software-failure state). The personal device 612 may include a smartphone executing a medical application configured to receive signals from the RTU 604 and route caregiver notifications to a caregiver via an internet-connected channel or a local wireless channel. In some examples, the personal device 612 operates as a gateway device that relays the caregiver notification to a caregiver without presenting a visual user interface to the user.

The local alert device 610 may include a bedside chime, a doorbell-type device, a speaker, a sub-GHz radio frequency receiver (such as a 433 MHz receiver), or any other device configured to produce an audible, visual, or tactile alert in response to receiving a signal from the external controller 606 or from the RTU 604. The wearable 614 may include a smartwatch or other wrist-worn companion device configured to receive notifications and present them to a caregiver. The home hub 616 may include a bedside station, a caregiver monitoring station, or a home automation hub configured to receive and display notifications or relay them to a caregiver.

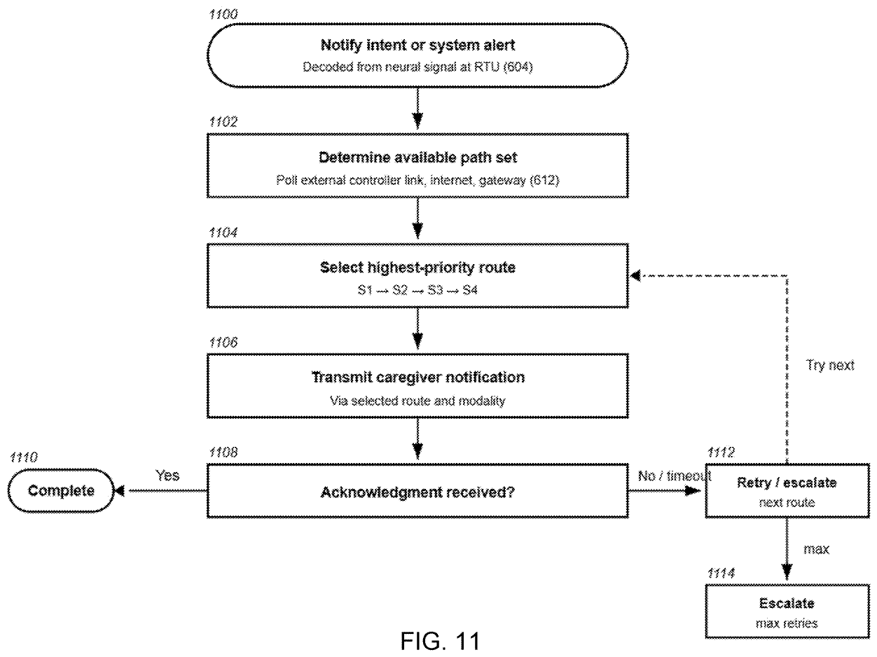

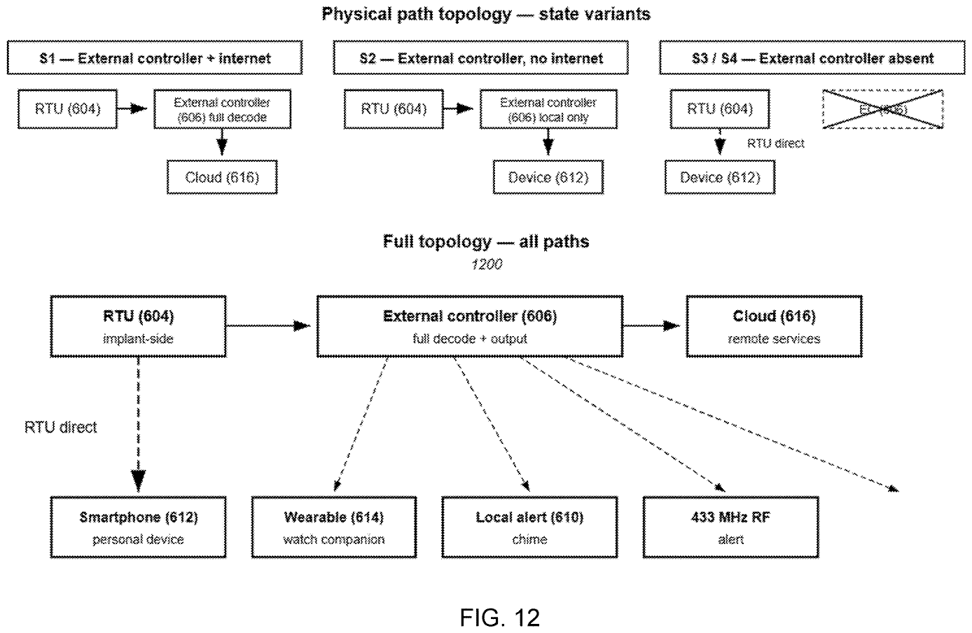

The architecture shown in FIG. 6 supports multiple caregiver-output routes that may be ordered by priority and selected based on an availability state of at least the external controller 606. When the external controller 606 and internet connectivity are both available, the system may route a caregiver notification via the external controller 606 through the cloud relay 608 to deliver a generated or custom text message to a caregiver. When the external controller 606 is available but internet connectivity is unavailable, the system may route a caregiver notification via the external controller 606 to the personal device 612 or the local alert device 610 using a local communication channel. When the external controller 606 is unavailable, the RTU 604 may route a caregiver notification directly to the personal device 612 via the direct communication path maintained independently of the external controller 606, or to the local alert device 610 via a sub-GHz radio frequency signal. The routing logic that selects among these caregiver-output routes is described in further detail with reference to FIGS. 11 and 12.

In some examples, the system may be understood as having at least three responsibility partitions. A normal-operation partition may use the external controller or other external processing system for full decoding and output orchestration. A reduced implant-side fallback partition may use the RTU to detect or decode a limited event vocabulary and initiate one or more fallback actions when the external processing system is unavailable or when the system is operating in a reduced-duty state. A caregiver-output routing partition may select among available output routes based on availability state, priority, urgency, privacy, acknowledgement, or endpoint reachability. In some implementations, these partitions are distributed across the RTU, external controller, personal electronic device, local alert device, and cloud relay, and the distribution of responsibility changes depending on whether the external controller is available, unavailable, idle, recovering, or bypassed.

In some embodiments, the RTU maintains or establishes a direct wireless link with a personal electronic device, such as a smartphone executing a medical application, so that the RTU can transmit a notification packet, alert code, or other fallback signal to the personal electronic device when the external controller is unavailable. The personal electronic device may then relay, generate, display, speak, or otherwise initiate a caregiver notification without requiring the external controller to participate in decoding or routing the notification.

FIG. 7 shows a block diagram 700 of the internal architecture of the RTU 604 (also referred to as an IRTU). As shown in FIG. 7, the RTU 604 receives a signal from the neural interface 602. The signal may include raw analog or digital neural signals representative of brain activity detected by the neural interface 602.

The RTU 604 includes a signal conditioning block 702 configured to amplify, filter, and perform analog-to-digital conversion on the signal in from the neural interface 602. The signal conditioning block 702 may prepare the electronic neural signals for downstream processing by removing noise, applying bandpass filtering, and digitizing the signals for use by other components within the RTU 604.

The RTU 604 further includes a local decode logic block 704 configured to decode user intents from the conditioned electronic neural signals. The local decode logic block 704 implements a bounded fallback vocabulary that includes, in the illustrated example, four intents: notify, lock, unlock, and wake. The bounded fallback vocabulary may include fewer or more intents in other examples, such as no more than five intents. The local decode logic block 704 may be implemented in firmware executing on a microcontroller, a dedicated fixed-function circuit, configurable hardware, or a hybrid thereof. During normal operation when the external controller 606 is available, the conditioned electronic neural signals may be routed to the external controller 606 (shown as the output path “To external controller (606)” in FIG. 7) for full decoding by the external controller 606. When the external controller 606 is unavailable, the local decode logic block 704 classifies the electronic neural signals against the bounded fallback vocabulary to identify a user intent locally.

The local decode logic may be configured to consume fewer computing resources than the decoder executed by the external controller. For example, the local decode logic may operate on a subset of neural channels, a compressed feature vector, a lower sampling rate, a smaller number of intent classes, or a lower-dimensional classifier than the external controller. In some examples, the local decode logic is limited to detecting a caregiver-contact or notification event and does not support cursor control, text entry, multi-degree-of-freedom control, continuous DMO control, or full vocabulary decoding.

The RTU 604 further includes an external controller link monitor 706 configured to detect whether the external controller 606 is unavailable. The external controller link monitor 706 may monitor for an absence of an expected communication from the external controller 606, such as a heartbeat message or bond status indicator, within a configurable monitoring interval. When the external controller link monitor 706 determines that the external controller 606 is unavailable (for example, because the external controller 606 is out of range, damaged, unpowered, or in a software-failure state, such as crashed) the external controller link monitor 706 generates an external controller unavailable trigger that activates the local decode logic block 704 to perform local fallback decoding. The external controller unavailable trigger is shown in FIG. 7 as a signal path from the external controller link monitor 706 to the local decode logic block 704.

The RTU 604 further includes a power management block 708 configured to manage the active and idle duty cycle of the RTU 604. The power management block 708 may control transitions between the active mode and the idle mode based on signals received from the local decode logic block 704. For example, when the local decode logic block 704 decodes a lock intent, the power management block 708 may transition the RTU 604 from the active mode to the idle mode, reducing the communication interval with the external controller 606 from a first communication interval (such as approximately 7.5 milliseconds) to a second communication interval (such as approximately 4 seconds). When the local decode logic block 704 decodes an unlock or wake intent, the power management block 708 may transition the RTU 604 back to the active mode.

The RTU 604 further includes a telemetry radio 710 configured to support wireless communication using Bluetooth Low Energy (BLE) or a proprietary wireless protocol. The telemetry radio 710 provides the physical communication interface through which the RTU 604 communicates with the external controller 606 during normal operation and with the personal device 612 during fallback operation or notification-from-idle operation. As shown in FIG. 7, the telemetry radio 710 supports an output path “To personal device (612)” that may be used to transmit a caregiver notification independently of the external controller 606.

The RTU 604 further includes a state register 712 that maintains the current operating state of the RTU 604. The state register 712 may track whether the RTU 604 is in an active state, an idle state, or an external controller unavailable state. The state register 712 may be read by the power management block 708, the local decode logic block 704, and the telemetry radio 710 to coordinate behavior across the RTU 604. For example, when the state register 712 indicates that the RTU 604 is in the idle mode and the external controller link monitor 706 has detected an unavailability condition, the local decode logic block 704 may decode a caregiver-contact intent and cause the telemetry radio 710 to transmit a caregiver notification to the personal device 612 via the direct communication path without first transitioning the RTU 604 to the active mode. The state register 712 may be supplemented by a fallback-event history, route-attempt history, acknowledgement state, endpoint-availability state, confidence state, timeout state, and false-positive suppression state. These states may be used to avoid repeated false alerts, repeated route attempts, state oscillation, repeated wake transitions, or repeated notification transmissions when the same neural event or system condition persists.

The architecture shown in FIG. 7 illustrates how the RTU 604 partitions functionality between normal-operation streaming to the external controller 606 and fallback-mode local decoding. During normal operation, the signal conditioning block 702 prepares the electronic neural signals and the telemetry radio 710 streams them to the external controller 606 at the first communication interval. During fallback operation, the external controller link monitor 706 detects the unavailability condition, the local decode logic block 704 classifies the user intent from the bounded fallback vocabulary, and the RTU 604 performs a fallback action (such as transmitting a caregiver notification via the telemetry radio 710 to the personal device 612, changing the system state via the power management block 708, or issuing a wake or recovery command to the external controller 606 via the telemetry radio 710).

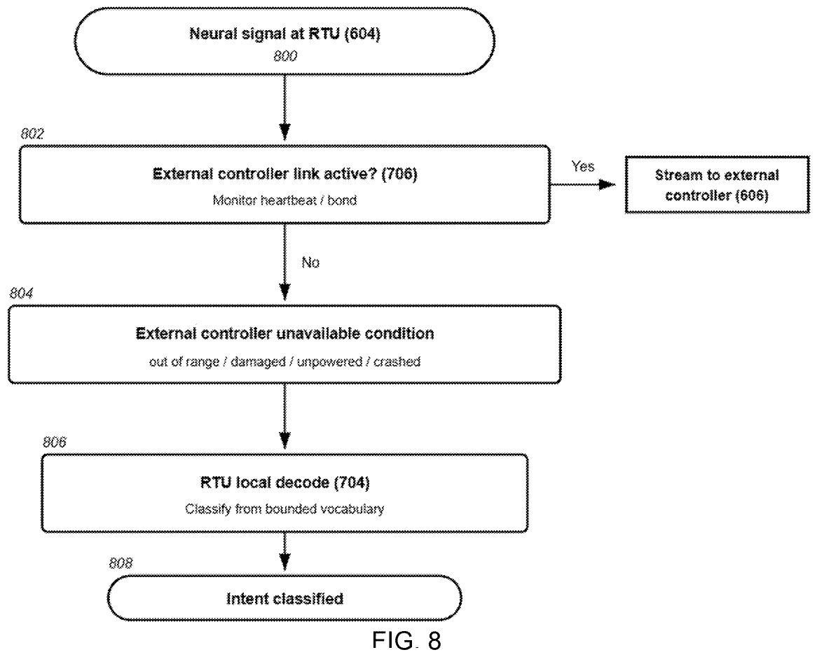

FIG. 8 shows a flowchart illustrating a process for fallback decoding by the RTU 604 when the external controller 606 is unavailable. The flowchart illustrates the decision logic that the RTU 604 may execute upon receiving a neural signal from the neural interface 602.

At block 800, a neural signal is received at the RTU 604. The neural signal may correspond to electronic neural signals generated by the neural interface 602 and conditioned by the signal conditioning block 702 as described with reference to FIG. 7.

At decision block 802, the RTU 604 determines whether the external controller link is active. This determination may be performed by the external controller link monitor 706, which monitors for a heartbeat message or bond status indicator from the external controller 606. If the external controller link is active (Yes), the process proceeds to stream the electronic neural signals to the external controller 606 for full decoding. In this normal-operation path, the external controller 606 receives the electronic neural signals and applies one or more decoding algorithms to decode user intents therefrom, as described elsewhere herein.

If the external controller link is not active (No), the process proceeds to block 804, at which an external controller unavailable condition is identified. The external controller unavailable condition may arise because the external controller 606 is out of range, damaged, unpowered, or crashed (i.e., in a software-failure state). The external controller unavailable condition corresponds to the unavailability condition associated with the external processing system as referenced in the claims and elsewhere in this disclosure.

At block 806, the RTU 604 performs a local decode using the local decode logic block 704. The local decode logic block 704 classifies the electronic neural signals against the bounded fallback vocabulary to identify a user intent. As described with reference to FIG. 7, the bounded fallback vocabulary may include intents such as notify, lock, unlock, and wake.

At block 808, the intent is classified. Once the local decode logic block 704 has classified the user intent, the RTU 604 may perform a corresponding fallback action based on the classified intent. For example, if the classified intent is a notify intent, the RTU 604 may transmit a caregiver notification to the personal device 612 via the telemetry radio 710. If the classified intent is a lock intent, the RTU 604 may transition the system to the idle mode via the power management block 708. If the classified intent is an unlock intent, the RTU 604 may transition the system to the active mode. If the classified intent is a wake intent, the RTU 604 may issue a wake or recovery command directed to the external controller 606 via the telemetry radio 710. In some examples, the RTU 604 may also transmit an alert signal to the local alert device 610, such as a tone or a sub-GHz radio frequency alert signal (for example, a 433 MHz signal), as a fallback action.

The process illustrated in FIG. 8 may be performed by the RTU 604 regardless of whether the RTU 604 is in the active mode or the idle mode. That is, the RTU 604 may detect the external controller unavailable condition and perform local fallback decoding in both the active mode and the idle mode. In some examples, when the RTU 604 is in the idle mode and detects the external controller unavailable condition, the RTU 604 may perform the fallback action (such as transmitting a caregiver notification to the personal device 612) without first transitioning to the active mode, thereby minimizing latency and power consumption. In some examples, upon restoration of communication with the external controller 606 (for example, when the external controller 606 returns to wireless range, is powered on, or recovers from a software failure), the RTU 604 may transition back to the first operating mode in which the external controller 606 resumes decoding user intents from the electronic neural signals.

In some examples, the RTU performs local fallback decoding only after detecting both an unavailability condition and a candidate fallback event. In some examples, the RTU continuously evaluates candidate fallback events but suppresses the fallback action unless an unavailability condition, idle state, locked-monitoring state, notification-authorized state, caregiver-configured state, or other enabling condition exists. The RTU may monitor for repeated classification of the same fallback event over multiple time windows, a minimum confidence value, or satisfaction of a confirmation rule before initiating the fallback action.

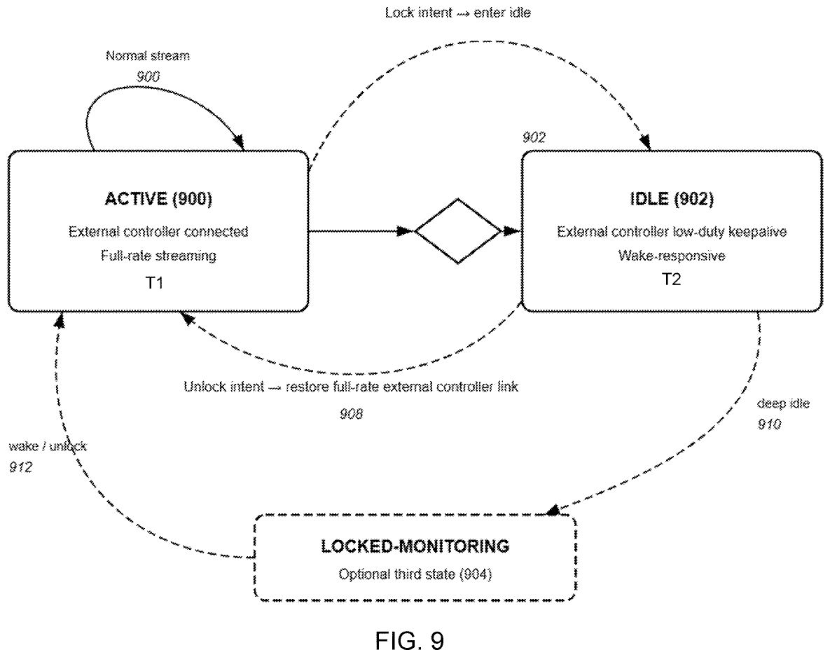

FIG. 9 shows a state diagram illustrating transitions between an active mode, an idle mode, and an optional third state for the RTU 604. The state diagram depicts the operating states of the RTU 604 and the events that trigger transitions between those states.

As shown in FIG. 9, the RTU 604 may operate in an active state 900 (labeled “ACTIVE (900)”) in which the external controller 606 is connected and the RTU 604 performs full-rate streaming at a first communication interval T1 of approximately 7.5 milliseconds. In the active state 900, the RTU 604 communicates the electronic neural signals with the external controller 606 according to the first communication interval T1, and the external controller 606 decodes user intents from the electronic neural signals. The active state 900 corresponds to normal operation of the implantable neural interface system, in which the user has full access to the decoding capabilities of the external controller 606 for device control, communication, and other functions. A “Normal stream” loop (shown as a self-referencing arrow on the active state 900) indicates that the RTU 604 continues streaming at the first communication interval T1 as long as the system remains in the active state 900.

The RTU 604 may transition from the active state 900 to an idle state 902 (labeled “IDLE (902)”) responsive to a lock intent. As shown in FIG. 9, the transition from the active state 900 to the idle state 902 is labeled “Lock intent→enter idle (T1→T2 keepalive),” indicating that upon detection of a lock intent, the RTU 604 reduces the communication interval from the first communication interval T1 to a second communication interval T2. The lock intent may be decoded from the electronic neural signals by the external controller 606 during the active state 900 or by the local decode logic block 704 of the RTU 604. In some examples, the transition to the idle state 902 may also be triggered by an inactivity timeout, an environment-monitoring signal indicating a sleep or rest condition, or a command received from the external controller 606 or a caregiver device.

In the idle state 902, the RTU 604 maintains a low-duty keepalive relationship with the external controller 606 at the second communication interval T2 of approximately 4 seconds. The idle state 902 is described in FIG. 9 as “External controller low-duty keepalive” and “Wake-responsive,” indicating that the RTU 604 maintains the wireless connection with the external controller 606 at the reduced-duty second communication interval while remaining responsive to events from a predefined event set. The second communication interval T2 is greater than the first communication interval T1 by at least one order of magnitude (approximately 533 times greater in the illustrated example). By maintaining the wireless connection at the reduced-duty second communication interval rather than fully disconnecting, the RTU 604 preserves the ability to resume full-rate communication without a fresh pairing or reconnection event.

The RTU 604 may transition from the idle state 902 back to the active state 900 responsive to an unlock intent. As shown in FIG. 9, the transition from the idle state 902 to the active state 900 is labeled “Unlock intent→restore full-rate external controller link” (e.g., an unlock transition 908), indicating that upon detection of an unlock intent from the electronic neural signals, the RTU 604 restores the first communication interval T1 and resumes full-rate streaming to the external controller 606. In some examples, the RTU 604 may also transition from the idle state 902 to the active state 900 responsive to a caregiver-override signal received while in the idle state 902, regardless of whether an unlock intent has been detected from the user. This caregiver-override capability enables caregivers to restore full system functionality when the user is unable to generate an unlock intent, such as during a medical event.

While in the idle state 902, the RTU 604 may detect at least one event from a predefined event set without first transitioning to the active state 900. For example, if the RTU 604 detects a caregiver-contact intent from the electronic neural signals while in the idle state 902, the RTU 604 may transmit a caregiver notification to the personal device 612 via the wireless link maintained independently of the external controller 606 without first resuming the active state 900. This notification-from-idle behavior allows the user to request caregiver assistance with minimal latency and without incurring the power cost of restoring full-rate communication.

FIG. 9 further shows an optional third state 904 (labeled “LOCKED-MONITORING”) depicted with dashed borders to indicate that it is optional. The optional third state 904 may be intermediate between the active state 900 and the idle state 902, or may represent a deeper idle condition. As shown in FIG. 9, the RTU 604 may transition from the idle state 902 to the optional third state 904 via a “deep idle” transition (reference 910), and may transition from the optional third state 904 back to the active state 900 via a “wake/unlock” transition (reference 912). In some examples, the optional third state 904 may correspond to a minimum-activity, deep-sleep, or charger-coupled service state in which the RTU 604 further reduces power consumption while still maintaining the ability to detect a wake or unlock event. The optional third state 904 may be used in situations where the user is expected to be inactive for an extended period, such as during overnight sleep, and where even the reduced-duty keepalive of the idle state 902 may be further reduced to conserve power.

The state diagram shown in FIG. 9 illustrates how the RTU 604 implements a neural-intent-aware state machine in which transitions between states are driven by user intents decoded from the electronic neural signals (such as lock, unlock, and wake intents), by system events (such as inactivity timeouts or caregiver-override signals), or by a combination thereof. The state machine preserves always-ready behavior by maintaining the wireless relationship with the external controller 606 in the idle state 902 while reducing power consumption, and by supporting event detection and notification routing from the idle state 902 without requiring a full transition to the active state 900.

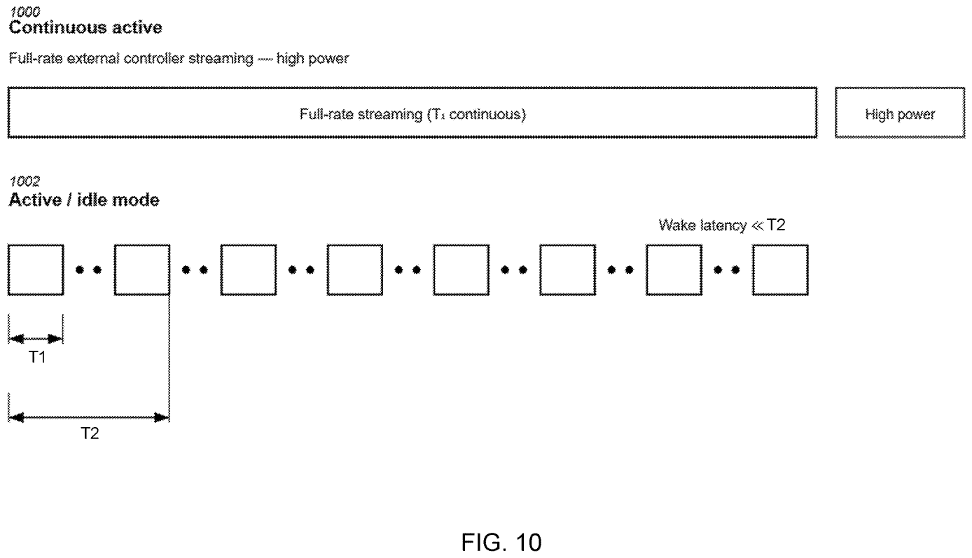

FIG. 10 shows a timing diagram comparing continuous active mode streaming with an active/idle mode alternating between two communication intervals. The timing diagram illustrates the power and latency tradeoffs associated with different communication strategies between the RTU 604 and the external controller 606.

As shown in FIG. 10, a first timing pattern 1000 (labeled “Continuous active”) represents a configuration in which the RTU 604 performs full-rate external controller streaming at the first communication interval T1 continuously. In this configuration, the RTU 604 transmits data packets to the external controller 606 at a continuous rate (T1 continuous), resulting in high power consumption by the RTU 604. The continuous active configuration is labeled “High power” in FIG. 10, indicating that this approach consumes the most power of the illustrated configurations. While the continuous active configuration provides the lowest possible latency for intent decoding (because the external controller 606 always has fresh neural data), the high power draw reduces the operational longevity of the implanted RTU 604 and increases the frequency of recharging, which may be undesirable during periods of user inactivity such as nighttime sleep.

A second timing pattern 1002 (labeled “Active/idle mode”) represents a configuration in which the RTU 604 alternates between transmitting data packets at the first communication interval T1 during active periods and maintaining a keepalive relationship at the second communication interval T2 during idle periods. As shown in FIG. 10, during the idle periods the RTU 604 transmits brief keepalive packets (represented as small squares separated by the longer T2 interval) rather than continuous full-rate data packets. The keepalive packets maintain the wireless connection between the RTU 604 and the external controller 606 without requiring full-rate streaming, thereby substantially reducing power consumption during the idle periods while preserving the ability to resume full-rate communication without a fresh pairing or reconnection event.

FIG. 10 further illustrates a wake latency associated with the active/idle mode configuration. The wake latency represents the time required for the RTU 604 to transition from the idle mode back to the active mode upon detection of an event from the predefined event set (such as an unlock intent or a caregiver-contact intent). As indicated in FIG. 10, the wake latency is much less than T2 (labeled “Wake latency<<T2”), meaning that the RTU 604 can resume full-rate streaming to the external controller 606 in a time period that is substantially shorter than the 4-second keepalive interval. This is because the wireless connection is maintained during the idle mode, and the RTU 604 need only increase the communication rate rather than perform a full reconnection sequence. In some examples, the wake latency may be under approximately 10 seconds, which represents a clinically meaningful response time for nighttime notification or system restoration scenarios.

The timing diagram shown in FIG. 10 illustrates the advantage of the active/idle mode configuration over both continuous active streaming and full disconnection. Compared to continuous active streaming, the active/idle mode configuration substantially reduces power consumption during periods of inactivity by reducing the communication duty cycle by at least one order of magnitude (such as from approximately 7.5 milliseconds to approximately 4 seconds). Compared to a full disconnection approach (in which the RTU 604 would completely sever the wireless connection during inactivity), the active/idle mode configuration preserves the wireless relationship between the RTU 604 and the external controller 606, avoiding the high reconnection latency that would otherwise be required to re-establish a fresh pairing or bond when the user needs to resume interaction. The active/idle mode configuration thus achieves a balance between power conservation and system responsiveness that is particularly well-suited for nighttime use and other extended periods of user inactivity. In some implementations, the idle mode may run on a regular duty cycle. In other words, the idle mode and the active mode may be associated with a same (“regular”) duty cycle, such that the communication interval at which the RTU 604 communicates with an external processing system (such as the external controller 606) is the same, or approximately the same, between the idle mode and the active mode. Additionally, or alternatively, the idle mode may be associated with a reduced vocabulary as compared to a larger vocabulary used (by the RTU 604 and/or the external processing system) in the active mode. By way of example, the idle mode may still reduce power consumption by supporting only the reduced vocabulary during periods of inactivity (as it may take less computing power to identify an intent from the reduced vocabulary as compared to identifying an intent from a larger or full vocabulary), even in implementations in which the idle mode and the active mode have the same duty cycle (such as the same communication intervals).

In some examples, the first communication interval is within a first interval range of about 1 millisecond to about 500 milliseconds, about 5 milliseconds to about 250 milliseconds, about 5 milliseconds to about 100 milliseconds, about 5 milliseconds to about 50 milliseconds, about 5 milliseconds to about 20 milliseconds, or about 7 milliseconds to about 10 milliseconds. In some examples, the second communication interval is within a second interval range of about 250 milliseconds to about 120 seconds, about 500 milliseconds to about 60 seconds, about 1 second to about 30 seconds, about 2 seconds to about 15 seconds, about 2 seconds to about 8 seconds, or about 3 seconds to about 5 seconds. In some examples, the second communication interval is at least about 5 times, 10 times, 25 times, 50 times, 100 times, 250 times, 500 times, or 1000 times the first communication interval. In some examples, the idle mode reduces radio duty cycle, telemetry energy consumption, or average communication-related power consumption by at least about 25%, 50%, 70%, 80%, 90%, or 95% relative to continuous active streaming. In some examples, notification-from-idle or wake-from-idle occurs within less than about 1 second, 2 seconds, 5 seconds, 10 seconds, 15 seconds, or 30 seconds from detection of the relevant fallback event.

The idle mode described herein is not only a radio sleep state. For example, the RTU may preserve a pre-authorized event-detection pathway for caregiver notification, wake, unlock, recovery, or other fallback events while avoiding a full disconnect/reconnect cycle. The RTU may therefore remain clinically available to the user even when full-rate streaming to the external processing system is suspended, reduced, delayed, or unavailable.

FIG. 11 shows a flowchart illustrating a caregiver-notification routing process. The flowchart depicts the sequence of operations that the routing logic may perform upon receiving a trigger event that requires a caregiver notification to be transmitted.

At block 1100, a notify intent or system alert is detected. The notify intent may be decoded from a neural signal at the RTU 604, either by the external controller 606 during normal operation or by the local decode logic block 704 of the RTU 604 during fallback operation. A system alert may be generated automatically without a user-generated intent as a trigger (for example, in response to detection of a component-outage condition, a signal-degradation condition, or another system-monitored event). The notify intent or system alert serves as the trigger that initiates the caregiver-notification routing process.

At block 1102, the routing logic determines an available path set. As shown in FIG. 11, this determination may include polling the external controller link, internet connectivity, and the gateway (such as the personal device 612) to identify which caregiver-output routes are currently reachable. The routing logic may assess the availability state of at least the external controller 606, the network connection to the cloud relay 608, and the direct communication path to the personal device 612. The result of this determination is a set of available caregiver-output routes from among the plurality of caregiver-output routes maintained by the system. An example of a caregiver notification routing matrix is illustrated in Table 2, shown below.

TABLE 2
Caregiver Notification Routing Marix

| | Rich | Canned | | | 433 |
|---|---|---|---|---|---|
| | Remote | Message | Gateway | Local | MHz |
| System | (SMS/ | (template/ | Push | Tone | RF |
| State | cloud) | local) | (wearable) | (chime) | (alert) |
| S1 - | Primary | Available | Available | Fallback | Fallback |
| external | | | | | |
| processing | | | | | |
| system + | | | | | |
| internet | | | | | |
| S2 - | N/A | Primary | Available | Fallback | Fallback |
| external | | | | | |
| processing | | | | | |
| system, no | | | | | |
| network | | | | | |
| S3 - | Primary | Available | RTU | Fallback | Fallback |
| RTU + | | | direct | | |
| gateway | | | | | |
| S4 - RTU | N/A | N/A | N/A | Primary | Available |
| local | | | | | |

Table 2 illustrates an example caregiver notification routing matrix that maps four system availability states (S1 through S4) to five notification delivery modalities: Rich Remote (SMS/cloud), Canned Message (template/local), Gateway Push (wearable), Local Tone (chime), and 433 MHz RF (alert). In state S1, where the external processing system and internet are both available, Rich Remote is the primary route with Canned Message and Gateway Push also available and Local Tone and 433 MHz RF as fallbacks. In state S2, where the external processing system is available but network connectivity is not, Rich Remote becomes unavailable, Canned Message becomes primary, Gateway Push remains available, and Local Tone and 433 MHz RF serve as fallbacks. In state S3, where only the RTU and a gateway device are available, Rich Remote is primary (via the gateway's own internet connectivity), Canned Message is available, Gateway Push is delivered via an RTU direct path, and Local Tone and 433 MHz RF are fallbacks. In state S4, representing RTU-local-only operation, Rich Remote, Canned Message, and Gateway Push are all unavailable, Local Tone becomes primary, and 433 MHz RF remains available. Accordingly, the routing logic progressively degrades notification richness while preserving at least one viable caregiver-contact pathway across all system availability states.

At block 1104, the routing logic selects a highest-priority route from among the available caregiver-output routes. As shown in FIG. 11, the routes are ordered by priority (labeled “S1→S2→S3→S4”), where S1 may correspond to a route that uses the external controller 606 with internet connectivity (such as a rich remote message via the cloud relay 608), S2 may correspond to a route that uses the external controller 606 without internet connectivity (such as a canned or template-derived message via a local communication channel), S3 may correspond to a route that uses the personal device 612 as a gateway independently of the external controller 606 (such as when the external controller 606 is unavailable but the personal device 612 has internet connectivity), and S4 may correspond to a local alert route (such as a tone via the local alert device 610 or a sub-GHz radio frequency alert signal). The priority ordering of the caregiver-output routes may be patient-configurable or caregiver-configurable, such that the default ordering (S1→S2→S3→S4) may be adjusted to suit the user's specific living environment and caregiver arrangement.

At block 1106, the routing logic transmits the caregiver notification via the selected route and modality. The caregiver notification may take any of a variety of forms depending on the selected route, including a generated or custom text message, a canned text message, a pre-recorded audio message, a synthesized audio message, a tone, a push notification, or a sub-GHz radio frequency alert signal (such as a 433 MHz signal). In some examples, when the selected route is S1 (external controller 606 with internet connectivity), the caregiver notification may include a generated text message produced by a large language model configured with context and communication preferences of the user. In some examples, when the selected route is S2 (external controller 606 without internet connectivity), the caregiver notification may include a pre-recorded, synthesized, or canned message delivered via a local communication channel. In some examples, when the selected route is S3 or S4 (external controller 606 unavailable), the caregiver notification may be transmitted by the RTU 604 directly to the personal device 612 or the local alert device 610 independently of the external controller 606.

At decision block 1108, the routing logic determines whether a delivery acknowledgement has been received. The delivery acknowledgement may be a confirmation signal returned by the endpoint device (such as the personal device 612, the caregiver's device, or the local alert device 610) indicating that the caregiver notification was successfully received or delivered. If a delivery acknowledgement is received (Yes), the process proceeds to block 1110, at which the routing process is complete.

If a delivery acknowledgement is not received within a configurable timeout (No/timeout), the process proceeds to block 1112, at which the routing logic performs a retry or escalation. As shown in FIG. 11, the retry/escalation block 1112 is labeled “Retry/escalate-next route,” indicating that the routing logic may initiate the transmission of the caregiver notification via a next-priority available caregiver-output route from among the plurality of caregiver-output routes. The dashed line from block 1112 back to block 1104 (labeled “Try next”) indicates that the routing logic returns to the route-selection step and selects the next-priority route in the ordering. For example, if the initial attempt was via S1 and no acknowledgement was received, the routing logic may retry via S2, and so on down the priority ordering.

At block 1114, if the maximum number of retries has been reached across all available routes (labeled “Escalate-max retries”), the routing logic may perform a final escalation action. The final escalation action may include, for example, activating all remaining available routes simultaneously, transmitting a repeated alert signal via the local alert device 610, or logging the failed delivery attempt for later review by a caregiver or system administrator.

The routing process illustrated in FIG. 11 may be executed by routing logic that resides at least in part on the external controller 606 when the external controller 606 is available, and at least in part on the RTU 604 when the external controller 606 is unavailable. In some examples, the routing logic is stored at least in part on the RTU 604 such that the RTU 604 is capable of selecting a caregiver-output route and initiating the transmission of the caregiver notification autonomously when the external controller 606 is unavailable. In some examples, the routing logic may also consider additional factors when selecting a caregiver-output route, such as a priority level of the user intent (where a higher-priority intent may trigger a higher-priority route), a privacy preference associated with the user (where a higher-privacy preference may favor a reduced-detail or non-audible notification), or a time-of-day context (where nighttime use may favor a less-intrusive modality for lower-priority notifications).

A route may be considered unavailable if any (required) element of the route is unavailable. For example, a route requiring the external controller may be considered unavailable when the external controller link monitor indicates absence of heartbeat, failed bond, failed handshake, unavailable application service, unacceptable battery state, or software-failure state. A route requiring internet connectivity may be considered unavailable when the associated endpoint, or a midpoint or relay, lacks network reachability. A route requiring a local alert device may be considered unavailable when the local alert device is unbonded, out of range, unacknowledged, unconfigured, or disabled. The routing logic may remove unavailable routes before selecting the highest-priority route, thereby avoiding failed attempts on routes known to be unreachable.

When the external processing system is unavailable, the caregiver notification may be transmitted as a low-bandwidth packet, notification token, alert code, canned-message identifier, route command, or predefined instruction that causes the personal electronic device or local alert device to generate a caregiver-facing output. The caregiver-facing output may include a message, tone, spoken phrase, haptic alert, visual alert, push notification, local automation, or other endpoint-specific output.

FIG. 12 shows a diagram illustrating a physical path topology for caregiver-output routes across different system availability states. FIG. 12 is divided into two portions: an upper portion depicting state variants that illustrate simplified path topologies for each of three system availability states, and a lower portion depicting a full topology 1200 that shows all available caregiver-output routes from the RTU 604 through the various endpoint devices.

The upper portion of FIG. 12 shows three state variants, labeled “S1—External controller+internet,” “S2—External controller, no internet,” and “S3/S4—External controller absent.” In the S1 state variant, the external controller 606 is available with full internet connectivity. As shown, the RTU 604 communicates with the external controller 606, which performs full decoding of the electronic neural signals, and the external controller 606 routes the caregiver notification to the cloud (e.g., the home hub 616) for delivery as a rich remote message (such as a generated or custom text message via an internet-connected channel). In the S2 state variant, the external controller 606 is available but internet connectivity is unavailable. As shown, the RTU 604 communicates with the external controller 606, which operates in a local-only mode, and the external controller 606 routes the caregiver notification to the personal device (612) via a local communication channel (such as delivering a canned or template-derived message). In the S3/S4 state variant, the external controller 606 is absent (shown with a crossed-out representation of the external controller 606). As shown, the RTU 604 communicates directly with the personal device (612) via an RTU direct path, bypassing the external controller 606 entirely. This RTU direct path represents the fallback caregiver-output route that does not use the external processing system.

The lower portion of FIG. 12 shows the full topology 1200, which depicts all available physical communication paths from the RTU 604 to the various endpoint devices. As shown, the RTU 604 (labeled “implant-side”) communicates with the external controller 606 (labeled “full decode+output”) via a primary communication path (shown as a solid line). The external controller 606 in turn communicates with the cloud (e.g., the home hub 616) (labeled “remote services”), the wearable (614) (labeled “watch companion”), the local alert device (610) (labeled “chime”), and the 433 MHz RF alert path via dashed lines representing peripheral or fallback paths. The RTU 604 also maintains a direct path to the smartphone (a personal device 612) (labeled “personal device”), shown as a dashed line labeled “RTU direct.” This RTU direct path represents the key fallback communication path that allows the RTU 604 to transmit a caregiver notification to the personal device 612 independently of the external controller 606.

The full topology 1200 shown in FIG. 12 illustrates how the plurality of caregiver-output routes spans at least three route families. The external-processing-system-mediated route family includes paths from the RTU 604 through the external controller 606 to the cloud (e.g., the home hub 616), the wearable (614), the local alert device (610), and the 433 MHz RF alert path. The personal-electronic-device-mediated route family includes the RTU direct path from the RTU 604 to the smartphone (a personal device 612), which may in turn relay the caregiver notification to a caregiver via an internet-connected channel when internet connectivity is available at the personal device 612. The local-alert-device-mediated route family includes paths to the local alert device (610) (such as a chime) and the 433 MHz RF alert path, which may be reached either through the external controller 606 or directly from the RTU 604 depending on the system availability state.

The state variants shown in the upper portion of FIG. 12 correspond to the priority ordering (S1→S2→S3→S4) described with reference to FIG. 11. When the system is in the S1 state (external controller 606 available with internet connectivity), the routing logic may select the rich remote message route via the cloud (e.g., the home hub 616) as the highest-priority available caregiver-output route. When the system is in the S2 state (external controller 606 available without internet connectivity), the routing logic may select the local communication route via the personal device (612) or the local alert device (610) as the highest-priority available caregiver-output route. When the system is in the S3 state (external controller 606 absent but the personal device 612 has internet connectivity), the routing logic may select the RTU direct path to the smartphone (a personal device 612) as the highest-priority available caregiver-output route, and the personal device 612 may relay the caregiver notification to a caregiver via an internet-connected channel. When the system is in the S4 state (external controller 606 absent and no internet connectivity available), the routing logic may select the local alert device (610) or the 433 MHz RF alert path as the highest-priority available caregiver-output route.

The physical path topology shown in FIG. 12 illustrates how the architecture of the implantable neural interface system supports state-aware caregiver-notification routing by providing multiple physically distinct communication paths that can be selected based on the availability state of at least the external controller 606. The RTU direct path to the smartphone (a personal device 612) represents a communication path that is maintained by the RTU 604 independently of the external controller 606, such that even when the external controller 606 is out of range, damaged, unpowered, misplaced, or in a software-failure state, the RTU 604 retains the ability to transmit a caregiver notification to the personal device 612 and, through the personal device 612, to a caregiver. The priority ordering of the caregiver-output routes may be patient-configurable or caregiver-configurable, such that the default ordering shown in FIG. 12 may be adjusted to suit the user's specific living environment and caregiver arrangement.

The RTU-direct path is a communication path that omits the external controller as a required decoding or routing participant. In some examples, the RTU-direct path allows the RTU to send a notification token, alert code, low-bandwidth command, or fallback packet directly to a personal electronic device or local alert device after the RTU detects or decodes a fallback event. The receiving endpoint may then generate, relay, or escalate the caregiver notification according to locally stored rules, route state, or application logic. In such implementations, an implantable neural interface system may include a neural interface, an RTU, an external processing system, and a personal electronic device or local alert device, where the external processing system performs full decoding during normal operation and the RTU detects an unavailability condition associated with the external processing system. While the unavailability condition is present, the RTU locally detects or decodes a caregiver-contact event from a bounded fallback vocabulary and transmits a caregiver notification to the personal electronic device or local alert device without using the external processing system as a required decoding or routing participant.

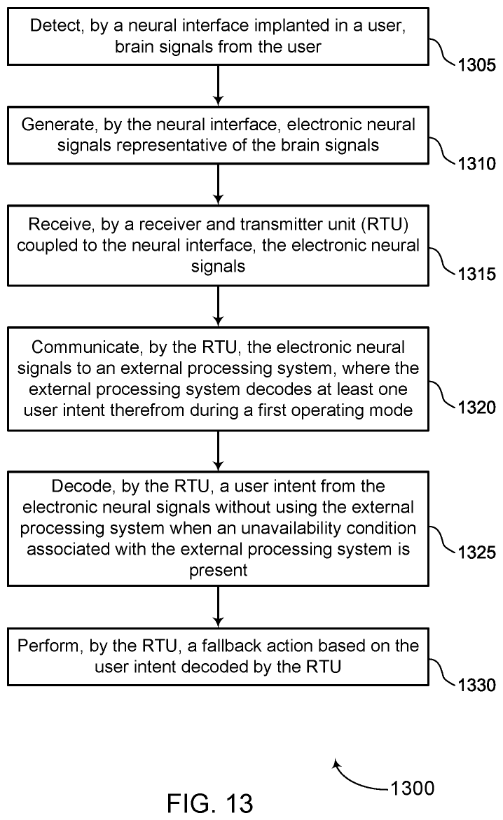

FIG. 13 shows an example of a method 1300 that supports availability enhancements for implantable neural interface systems. The method 1300 may be performed by one or more components of the implantable neural interface system described herein, including the neural interface 602, the RTU 604, and the external controller 606 as described with reference to FIGS. 6-8.

At 1305, the method may include detecting, by a neural interface implanted in a user, brain signals from the user. For example, the neural interface 602 may include one or more electrode components positioned within or adjacent to neural tissue, such as within the motor cortex, as described with reference to FIG. 6.

At 1310, the method may include generating, by the neural interface, electronic neural signals representative of the brain signals. For example, the neural interface 602 may convert the detected brain signals into electronic neural signals suitable for transmission to the RTU 604.

At 1315, the method may include receiving, by a receiver and transmitter unit (RTU) coupled to the neural interface, the electronic neural signals. For example, the RTU 604 may receive the electronic neural signals via one or more lead members or a wireless connection from the neural interface 602, and may condition the signals using the signal conditioning block 702 as described with reference to FIG. 7.

At 1320, the method may include communicating, by the RTU, the electronic neural signals to an external processing system, where the external processing system decodes at least one user intent therefrom during a first operating mode. For example, the RTU 604 may stream the electronic neural signals to the external controller 606 via the telemetry radio 710 at the first communication interval T1, and the external controller 606 may apply one or more decoding algorithms to decode user intents therefrom.

At 1325, the method may include decoding, by the RTU, a user intent from the electronic neural signals without using the external processing system when an unavailability condition associated with the external processing system is present. For example, the local decode logic block 704 of the RTU 604 may classify the electronic neural signals against the bounded fallback vocabulary to identify a user intent, as described with reference to FIGS. 7 and 8, responsive to the external controller link monitor 706 detecting that the external controller 606 is unavailable.

At 1330, the method may include performing, by the RTU, a fallback action based on the user intent decoded by the RTU. For example, the fallback action may include transmitting a caregiver notification to the personal device 612 via the telemetry radio 710, changing the system between an active state and an idle or locked state via the power management block 708, issuing a wake or recovery command directed to the external controller 606, or transmitting an alert signal to the local alert device 610, as described with reference to FIG. 8.

The method 1300 and its various implementations may achieve one or more of the following technical effects. The combination of decoding a user intent at the RTU without using the external processing system when an unavailability condition is present, and performing a fallback action based on that decoded intent, achieves the technical effect of preserving at least limited system functionality under single-point-of-failure loss of the external processing system, providing graceful degradation rather than total loss of user capability. The use of a bounded fallback vocabulary comprising no more than five intents at the RTU achieves the technical effect of reducing the computational load, memory footprint, and power consumption of the implanted RTU during fallback operation, because the local decode logic need only classify the electronic neural signals against a small, predefined set of intent classes rather than performing full vocabulary decoding. The detection of the unavailability condition by monitoring for an absence of an expected communication from the external processing system within a configurable monitoring interval achieves the technical effect of enabling autonomous mode switching at the RTU without requiring any user intervention, such that the transition to fallback operation occurs automatically and without latency attributable to user awareness of the failure.

The transmission of a caregiver notification to a personal electronic device via a wireless link maintained independently of the external processing system achieves the technical effect of preserving caregiver-contact capability under single-point-of-failure loss of the external processing system, because the direct path to the personal electronic device operates as a physically and logically independent communication channel that survives the unavailability of the external processing system regardless of the cause. The implementation of the local fallback logic in at least one of firmware executing on a microcontroller, a dedicated fixed-function circuit, configurable hardware, or a hybrid thereof achieves the technical effect of enabling the fallback decoding to be performed within the power and thermal constraints of an implanted device without requiring a general-purpose processor, thereby reducing heat dissipation within the implanted housing. The reduced fallback vocabulary also enables the RTU to use a simpler classifier than the external processing system, reducing memory requirements, processing cycles, radio use, and heat generation while maintaining a notification-capable or otherwise fallback-capable state. In some examples, the RTU performs only a notification-event detection function, while the external processing system performs full intent decoding (during normal operation).

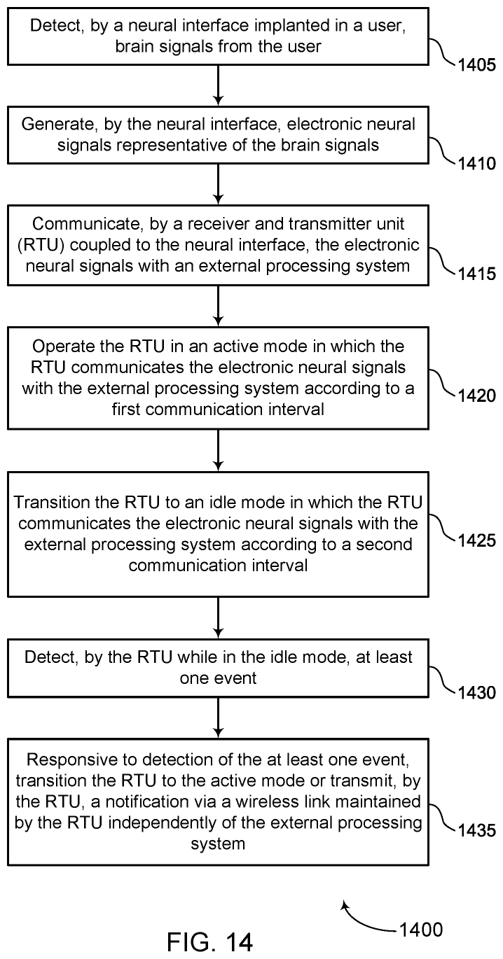

FIG. 14 shows an example of a method 1400 that supports availability enhancements for implantable neural interface systems. The method 1400 may be performed by one or more components of the implantable neural interface system described herein, including the neural interface 602, the RTU 604, and the external controller 606 as described with reference to FIGS. 7 and 9.

At 1405, the method may include detecting, by a neural interface implanted in a user, brain signals from the user. For example, the neural interface 602 may detect the brain signals using one or more electrode components implanted within or adjacent to neural tissue.

At 1410, the method may include generating, by the neural interface, electronic neural signals representative of the brain signals. For example, the neural interface 602 may convert the detected brain signals into electronic neural signals for downstream processing.

At 1415, the method may include communicating, by a receiver and transmitter unit (RTU) coupled to the neural interface, the electronic neural signals with an external processing system. For example, the RTU 604 may stream the electronic neural signals to the external controller 606 via the telemetry radio 710 during normal operation.

At 1420, the method may include operating the RTU in an active mode in which the RTU communicates the electronic neural signals with the external processing system according to a first communication interval. For example, the RTU 604 may operate in the active state 900 at the first communication interval T1, performing full-rate streaming to the external controller 606 as described with reference to FIG. 9.

At 1425, the method may include transitioning the RTU to an idle mode in which the RTU communicates the electronic neural signals with the external processing system according to a second communication interval. For example, the RTU 604 may transition to the idle state 902 responsive to a lock intent decoded from the electronic neural signals, an inactivity timeout, or a command from the external controller 606, reducing the communication interval to T2 while maintaining a keepalive relationship with the external controller 606, as described with reference to FIG. 9. The second communication interval T2 may be greater than the first communication interval T1 by at least one order of magnitude. Additionally, or alternatively, the RTU and/or the external processing system use a first vocabulary (e.g., a bounded vocabulary) during the idle mode and a second vocabulary (e.g., a full vocabulary) during the active mode.

At 1430, the method may include detecting, by the RTU while in the idle mode, at least one event. For example, the RTU 604 may detect at least one event from a predefined event set while in the idle state 902, including a wake intent or an unlock intent decoded from the electronic neural signals, or a caregiver-contact intent decoded from the electronic neural signals. The RTU 604 may detect the at least one event using the local decode logic block 704, which classifies the electronic neural signals against the bounded fallback vocabulary while the RTU 604 remains in the idle state 902.

At 1435, the method may include, responsive to detection of the at least one event, transitioning the RTU to the active mode or transmitting, by the RTU, a notification via a wireless link maintained by the RTU independently of the external processing system. For example, if the detected event is an unlock intent, the RTU 604 may transition from the idle state 902 back to the active state 900, restoring the first communication interval T1 and resuming full-rate streaming to the external controller 606, as described with reference to the unlock transition 908 of FIG. 9. If the detected event is a caregiver-contact intent, the RTU 604 may transmit a caregiver notification to the personal device 612 via the telemetry radio 710 without first transitioning to the active state 900, as described with reference to the notification-from-idle behavior of FIG. 9. In some examples, the RTU 604 may also transition to the active mode responsive to a caregiver-override signal received while in the idle mode, regardless of whether an unlock intent has been detected from the user.

The method 1400 and its various implementations may achieve one or more of the following technical effects. The combination of operating the RTU in an active mode at a first communication interval and transitioning to an idle mode at a second, longer communication interval while maintaining the ability to detect events and respond without a full disconnection and reconnection cycle, achieves the technical effect of reducing power consumption of the implanted RTU during periods of user inactivity while preserving always-ready responsiveness. The maintenance of a wireless relationship between the RTU and the external processing system at the reduced-duty second communication interval during the idle mode (rather than fully disconnecting) achieves the technical effect of enabling rapid state transitions back to the active mode without the high reconnection latency that would otherwise be required to re-establish a fresh pairing or bond. The detection of at least one event from a predefined event set while in the idle mode (including both wake or unlock intents and caregiver-contact intents) achieves the technical effect of ensuring that the system remains responsive to user needs during periods of inactivity, such as during nighttime use, without requiring continuous full-rate streaming. The transmission of a notification via a wireless link maintained independently of the external processing system without first transitioning to the active mode achieves the technical effect of preserving caregiver-contact capability from the idle mode with minimal latency and minimal power expenditure, because the RTU avoids the delay and energy cost of restoring full-rate communication before routing the notification. The separation of the first communication interval and the second communication interval by at least one order of magnitude achieves the technical effect of reducing the radio duty cycle of the implanted RTU by a sufficient factor to meaningfully extend operational duration between recharging cycles while still maintaining a connection that supports event detection and rapid state transitions. Further, in some examples, the technical effect is not limited to reducing communication power. The idle mode preserves a pre-authorized event-detection pathway for user-generated or system-generated fallback events while avoiding the availability penalty of a full disconnect. This enables a user to request caregiver attention or restore operation (from a reduced-duty state) without first requiring caregiver intervention to reconnect, reposition, or power the external processing system. Additionally, or alternatively, the idle mode may be a mode in which the RTU and/or the external processing system performs limited intent decoding, such as intent decoding from a bounded vocabulary described herein, and otherwise performs communication (between the RTU and the external processing system) at a same communication interval as is used in the active mode. In other words, the active mode and the idle mode may be associated with a same communication interval and may differ in the types or classes of intents that are able to be decoded. For example, the RTU and/or the external processing system may decode a first set of intent types or classes in the active mode and a second set of intent types or classes in the idle mode. The second set of intent types or classes may be a subset of the first set of intent types or classes. The second set of intent types or classes may be limited to a notification-event detection function, to a lock intent, to an unlock intent, to a wake intent, or to any subset or combination thereof. The first set of intent types or classes may be associated with full vocabulary decoding.

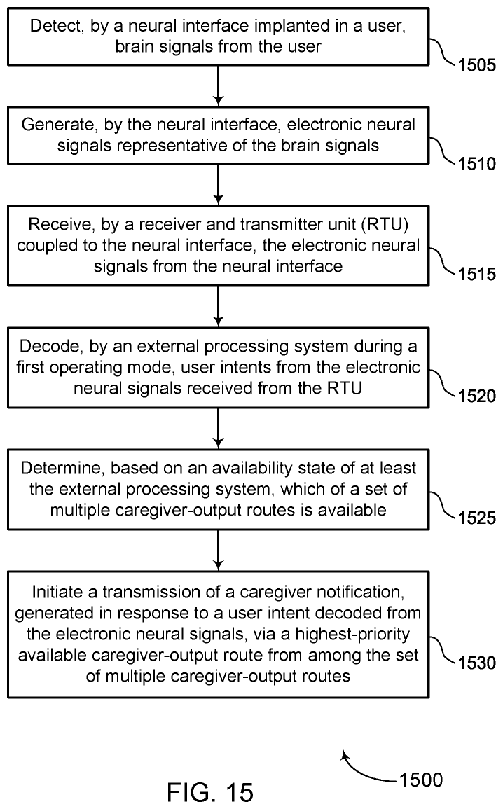

FIG. 15 shows an example of a method 1500 that supports availability enhancements for implantable neural interface systems. The method 1500 may be performed by one or more components of the implantable neural interface system described herein, including the neural interface 602, the RTU 604, the external controller 606, and the routing logic described with reference to FIGS. 11 and 12.

At 1505, the method may include detecting, by a neural interface implanted in a user, brain signals from the user. For example, the neural interface 602 may detect the brain signals using one or more electrode components implanted within or adjacent to neural tissue.

At 1510, the method may include generating, by the neural interface, electronic neural signals representative of the brain signals. For example, the neural interface 602 may convert the detected brain signals into electronic neural signals for downstream processing.

At 1515, the method may include receiving, by a receiver and transmitter unit (RTU) coupled to the neural interface, the electronic neural signals from the neural interface. For example, the RTU 604 may receive the electronic neural signals from the neural interface 602 and condition them using the signal conditioning block 702.

At 1520, the method may include decoding, by an external processing system during a first operating mode, user intents from the electronic neural signals received from the RTU. For example, the external controller 606 may receive the electronic neural signals from the RTU 604 and apply one or more decoding algorithms to decode user intents therefrom, including a caregiver-contact intent.

At 1525, the method may include determining, based on an availability state of at least the external processing system, which of a set of multiple caregiver-output routes is available. For example, the routing logic may assess the availability state of the external controller 606, the network connection to the cloud relay 608, and the direct communication path to the personal device 612, as described with reference to block 1102 of FIG. 11.

At 1530, the method may include initiating a transmission of a caregiver notification, generated in response to a user intent decoded from the electronic neural signals, via a highest-priority available caregiver-output route from among the set of multiple caregiver-output routes. In some examples, the set of multiple caregiver-output routes are ordered by priority and includes at least a primary route associated with internet connectivity and at least one fallback route that does not use the external processing system. For example, the routing logic may select among routes S1 through S4 based on the priority ordering and the determined availability, and may transmit the caregiver notification via the selected route and modality as described with reference to FIGS. 11 and 12.

The method 1500 and its various implementations may achieve one or more of the following technical effects. The combination of determining which caregiver-output routes are available based on an availability state of at least the external processing system, and initiating a caregiver notification via a highest-priority available route from among routes ordered by priority, achieves the technical effect of maximizing the probability of successful caregiver notification delivery across varying and unpredictable system availability states without requiring user awareness of the specific failure mode or user selection of an alternative route. The inclusion of at least a primary route associated with internet connectivity and at least one fallback route that does not use the external processing system achieves the technical effect of ensuring that caregiver notification remains available even when the external processing system is unavailable, because the system maintains at least one communication pathway that is independent of the external processing system.

The monitoring for a delivery acknowledgement on the highest-priority available route and escalation to a next-priority route upon expiration of a configurable timeout achieves the technical effect of automatic retry and route escalation without requiring any additional neural intent from the user beyond the initial notification intent, which reduces the cognitive burden on the user during a time-critical notification scenario. The patient-configurable or caregiver-configurable priority ordering of the caregiver-output routes achieves the technical effect of adapting the notification routing hierarchy to the specific physical environment and caregiver arrangement of the user without requiring firmware modification, such that the route most likely to result in rapid caregiver response for a given user's circumstances is attempted first. The selection of a caregiver-output route that delivers a generated or custom text message via an internet-connected channel when both the external processing system and internet connectivity are available, and a caregiver-output route that delivers a pre-recorded, synthesized, or canned message via a local communication channel when internet connectivity is unavailable, achieves the technical effect of matching notification richness to the capacity of the available communication channel, delivering the most informative notification possible given current availability constraints.

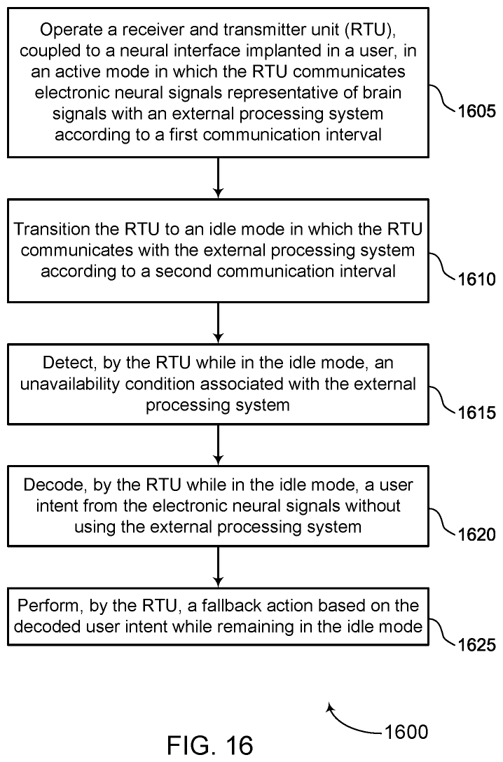

FIG. 16 shows an example of a method 1600 that supports availability enhancements for implantable neural interface systems. The method 1600 may be performed by one or more components of the implantable neural interface system described herein, including the RTU 604 and the external controller 606 as described with reference to FIGS. 7 and 9.

At 1605, the method may include operating a receiver and transmitter unit (RTU), coupled to a neural interface implanted in a user, in an active mode in which the RTU communicates electronic neural signals representative of brain signals with an external processing system according to a first communication interval. For example, the RTU 604 may stream the electronic neural signals to the external controller 606 at the first communication interval T1, as described with reference to the active state 900 of FIG. 9.

At 1610, the method may include transitioning the RTU to an idle mode in which the RTU communicates with the external processing system according to a second communication interval. For example, the RTU 604 may transition to the idle state 902 responsive to a lock intent, an inactivity timeout, or a command from the external controller 606, reducing the communication interval to T2 while maintaining a keepalive relationship, as described with reference to FIG. 9.

At 1615, the method may include detecting, by the RTU while in the idle mode, an unavailability condition associated with the external processing system. For example, the external controller link monitor 706 of the RTU 604 may detect that the external controller 606 has become unavailable while the RTU 604 is in the idle state 902, such as by monitoring for an absence of a heartbeat message within a configurable monitoring interval.

At 1620, the method may include decoding, by the RTU while in the idle mode, a user intent from the electronic neural signals without using the external processing system. For example, the local decode logic block 704 may classify the electronic neural signals against the bounded fallback vocabulary to identify a user intent, such as a caregiver-contact intent, while the RTU 604 remains in the idle state 902.

At 1625, the method may include performing, by the RTU, a fallback action based on the decoded user intent while remaining in the idle mode. For example, the RTU 604 may transmit a caregiver notification to the personal device 612 via the telemetry radio 710 without first transitioning to the active state 900, as described with reference to the notification-from-idle behavior of FIG. 9.

The method 1600 and its various implementations may achieve one or more of the following technical effects. The combination of operating the RTU in an idle mode at a second communication interval, detecting an unavailability condition while in the idle mode, decoding a user intent without the external processing system, and performing a fallback action while remaining in the idle mode, achieves the technical effect of preserving caregiver-contact capability under the simultaneous conditions of user inactivity and external processing system loss, without incurring the power cost of first restoring full-rate communication. The separation of the first communication interval and the second communication interval by at least one order of magnitude (for example, from approximately 7.5 milliseconds to approximately 4 seconds) achieves the technical effect of reducing the radio duty cycle of the implanted RTU by a sufficient factor (of approximately 533) during idle periods, which directly reduces the energy consumed per unit time by the telemetry radio and extends the operational duration between recharging cycles. The performance of the fallback action while remaining in the idle mode (rather than first transitioning to the active mode) achieves the technical effect of reducing both notification latency and unnecessary power expenditure, because the system avoids the delay and energy cost associated with restoring full-rate streaming before routing the notification. The detection of the unavailability condition while in the idle mode by monitoring for an absence of a heartbeat message within a configurable monitoring interval achieves the technical effect of enabling the RTU to identify external processing system loss even during reduced-duty operation, such that the user is not left without notification capability during periods of inactivity when the external processing system may be more likely to become unavailable (for example, during nighttime when the external processing system may run out of battery or be moved out of range by a caregiver). In some examples, notification-from-idle is completed within less than about 1 second, 2 seconds, 5 seconds, 10 seconds, 15 seconds, or 30 seconds from detection of a caregiver-contact event, depending on route availability and endpoint responsiveness. In some examples, the reduced-duty idle mode extends usable operation between charging events by at least about 10%, 25%, 50%, 75%, 100%, or more relative to continuous active streaming during comparable inactive periods.

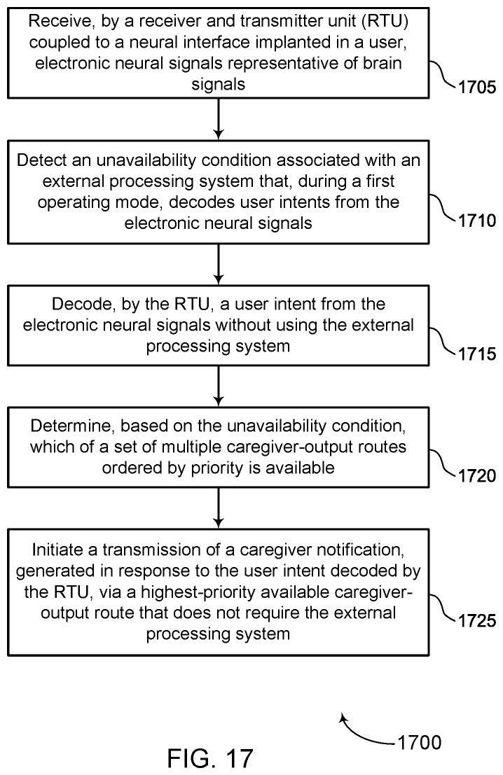

FIG. 17 shows an example of a method 1700 that supports availability enhancements for implantable neural interface systems. The method 1700 may be performed by one or more components of the implantable neural interface system described herein, including the RTU 604 and the routing logic described with reference to FIGS. 8, 11, and 12.

At 1705, the method may include receiving, by a receiver and transmitter unit (RTU) coupled to a neural interface implanted in a user, electronic neural signals representative of brain signals. For example, the RTU 604 may receive the electronic neural signals from the neural interface 602 and condition them using the signal conditioning block 702 as described with reference to FIG. 7.

At 1710, the method may include detecting an unavailability condition associated with an external processing system that, during a first operating mode, decodes user intents from the electronic neural signals. For example, the external controller link monitor 706 may detect that the external controller 606 is out of range, damaged, unpowered, or in a software-failure state, as described with reference to block 804 of FIG. 8.

At 1715, the method may include decoding, by the RTU, a user intent from the electronic neural signals without using the external processing system. For example, the local decode logic block 704 of the RTU 604 may classify the electronic neural signals against the bounded fallback vocabulary to identify a user intent, such as a caregiver-contact intent, as described with reference to block 806 of FIG. 8.

At 1720, the method may include determining, based on the unavailability condition, which of a set of multiple caregiver-output routes ordered by priority is available. For example, because the external controller 606 is unavailable, routes that require the external controller 606 (such as S1 and S2) may be excluded from the available path set, and the routing logic may identify the personal device 612 or the local alert device 610 as available endpoints, as described with reference to the S3/S4 state variant of FIG. 12.

At 1725, the method may include initiating a transmission of a caregiver notification, generated in response to the user intent decoded by the RTU, via a highest-priority available caregiver-output route that does not require the external processing system. For example, the RTU 604 may transmit the caregiver notification to the personal device 612 via the RTU direct path or to the local alert device 610 via a sub-GHz radio frequency alert signal, as described with reference to FIGS. 11 and 12.

The method 1700 and its various implementations may achieve one or more of the following technical effects. The combination of detecting an unavailability condition, decoding a user intent at the RTU without the external processing system, determining which caregiver-output routes are available based on the unavailability condition, and initiating a caregiver notification via a highest-priority available route that does not require the external processing system, achieves the technical effect of providing end-to-end caregiver notification originating from the implanted component without any participation by the external processing system. The routing logic stored at least in part on the RTU such that the RTU is capable of autonomously selecting a caregiver-output route when the external processing system is unavailable achieves the technical effect of ensuring that the routing intelligence survives the same single-point-of-failure condition that the fallback decoding is designed to address, because the RTU can independently evaluate which fallback routes are available, select the highest-priority available fallback route, and initiate the notification transmission. The determination of route availability based on the unavailability condition (such that routes requiring the external processing system are excluded from the available path set) achieves the technical effect of preventing failed transmission attempts on routes that are known to be unreachable, thereby reducing notification latency by directing the first transmission attempt to a route that is actually available. The support for multiple output modalities across the available routes (including transmission to a personal electronic device via BLE and transmission to a local alert device via a sub-GHz radio frequency signal) achieves the technical effect of providing at least two physically distinct fallback communication paths that use different radio technologies, such that a failure of one radio technology does not eliminate all fallback notification capability.

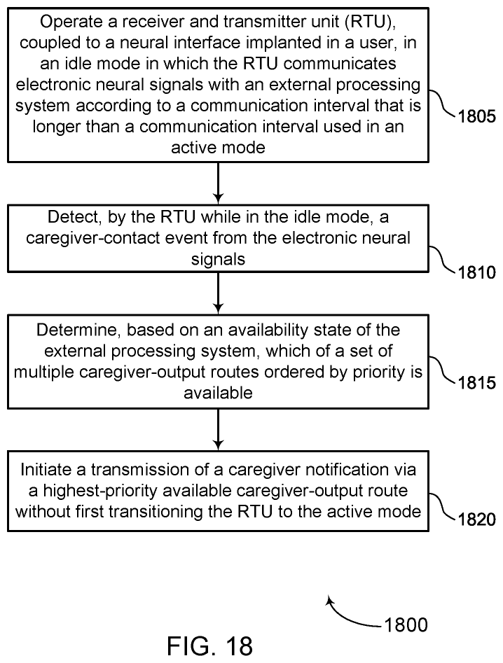

FIG. 18 shows an example of a method 1800 that supports availability enhancements for implantable neural interface systems. The method 1800 may be performed by one or more components of the implantable neural interface system described herein, including the RTU 604 and the routing logic described with reference to FIGS. 9 and 11.

At 1805, the method may include operating a receiver and transmitter unit (RTU), coupled to a neural interface implanted in a user, in an idle mode in which the RTU communicates electronic neural signals with an external processing system according to a communication interval that is longer than a communication interval used in an active mode. For example, the RTU 604 may operate in the idle state 902 at the second communication interval T2 while maintaining a keepalive relationship with the external controller 606, as described with reference to FIG. 9.

At 1810, the method may include detecting, by the RTU while in the idle mode, a caregiver-contact event from the electronic neural signals. For example, the local decode logic block 704 of the RTU 604 may detect a caregiver-contact intent from the electronic neural signals while the RTU 604 remains in the idle state 902, without first transitioning to the active state 900.

At 1815, the method may include determining, based on an availability state of the external processing system, which of a set of multiple caregiver-output routes ordered by priority is available. For example, the routing logic may assess whether the external controller 606 is available and whether internet connectivity is present, and may identify the available caregiver-output routes accordingly, as described with reference to block 1102 of FIG. 11.

At 1820, the method may include initiating a transmission of a caregiver notification via a highest-priority available caregiver-output route without first transitioning the RTU to the active mode. For example, the RTU 604 may transmit the caregiver notification via the highest-priority available route (which may be a route through the external controller 606 if available, or the RTU direct path to the personal device 612 if the external controller 606 is unavailable) while remaining in the idle state 902, as described with reference to the notification-from-idle behavior of FIG. 9.

The method 1800 and its various implementations may achieve one or more of the following technical effects. The combination of operating the RTU in an idle mode, detecting a caregiver-contact event from the electronic neural signals while in the idle mode, determining which caregiver-output routes are available based on an availability state of the external processing system, and initiating a caregiver notification via a highest-priority available route without first transitioning the RTU to the active mode, achieves the technical effect of enabling clinically meaningful nighttime caregiver notification with minimal latency and minimal power expenditure. The detection of the caregiver-contact event while in the idle mode without first transitioning to the active mode achieves the technical effect of preserving always-ready notification behavior during periods of user inactivity, such that the user's ability to request caregiver assistance is not conditioned on first restoring full-rate communication with the external processing system. The determination of route availability based on the availability state of the external processing system while in the idle mode achieves the technical effect of enabling state-aware routing even during reduced-duty operation, such that the system selects the appropriate route (for example, a route through the external processing system if available, or the RTU direct path if not) without requiring the user to be aware of the current system state. The initiation of the caregiver notification without first transitioning to the active mode achieves the technical effect of reducing end-to-end notification latency to a time period that may be under approximately 10 seconds, which represents a clinically meaningful response time for nighttime notification scenarios where alternative caregiver-attention methods may take 10-15 seconds and may fail entirely.

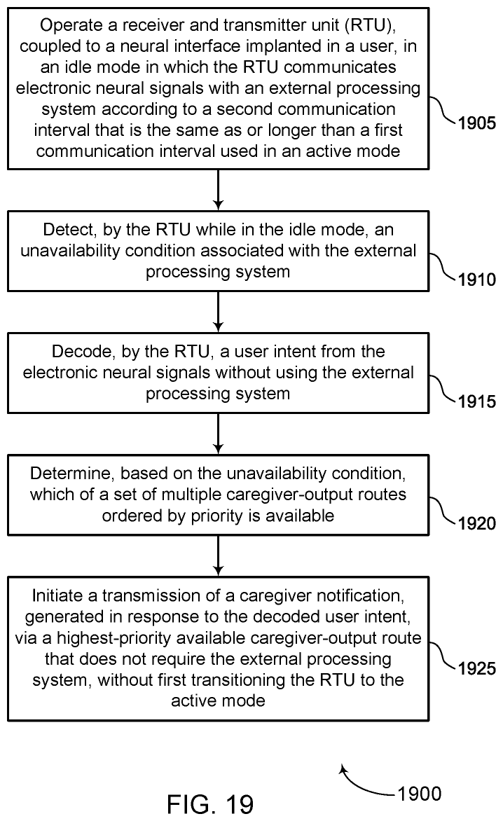

FIG. 19 shows an example of a method 1900 that supports availability enhancements for implantable neural interface systems. The method 1900 may be performed by one or more components of the implantable neural interface system described herein, including the RTU 604 and the routing logic described with reference to FIGS. 8, 9, 11, and 12.

At 1905, the method may include operating a receiver and transmitter unit (RTU), coupled to a neural interface implanted in a user, in an idle mode in which the RTU communicates electronic neural signals with an external processing system according to a second communication interval that is the same as or longer than a first communication interval used in an active mode. For example, the RTU 604 may operate in the idle state 902 at the second communication interval T2, maintaining the wireless connection with the external controller 606 at the reduced-duty keepalive interval, as described with reference to FIG. 9.

At 1910, the method may include detecting, by the RTU while in the idle mode, an unavailability condition associated with the external processing system. For example, the external controller link monitor 706 may detect that the external controller 606 has become unavailable while the RTU 604 is in the idle state 902, such as because the external controller 606 is out of range, damaged, unpowered, or in a software-failure state.

At 1915, the method may include decoding, by the RTU, a user intent from the electronic neural signals without using the external processing system. For example, the local decode logic block 704 of the RTU 604 may classify the electronic neural signals against the bounded fallback vocabulary to identify a user intent, such as a caregiver-contact intent, while the RTU 604 remains in the idle state 902.

At 1920, the method may include determining, based on the unavailability condition, which of a set of multiple caregiver-output routes ordered by priority is available. For example, because the external controller 606 is unavailable, the routing logic (executing at least in part on the RTU 604) may exclude routes that require the external controller 606 and identify the personal device 612 or the local alert device 610 as available endpoints, as described with reference to the S3/S4 state variant of FIG. 12.

At 1925, the method may include initiating a transmission of a caregiver notification, generated in response to the decoded user intent, via a highest-priority available caregiver-output route that does not require the external processing system, without first transitioning the RTU to the active mode. For example, the RTU 604 may transmit the caregiver notification to the personal device 612 via the RTU direct path or to the local alert device 610 via a sub-GHz radio frequency alert signal, while remaining in the idle state 902, thereby preserving power and minimizing latency as described with reference to FIGS. 9, 11, and 12.

The method 1900 and its various implementations may achieve one or more of the following technical effects. The combination of operating the RTU in an idle mode, detecting an unavailability condition while in the idle mode, decoding a user intent without the external processing system, determining which caregiver-output routes are available based on the unavailability condition, and initiating a caregiver notification via a highest-priority available route that does not require the external processing system without first transitioning to the active mode, achieves the technical effect of preserving caregiver-contact capability under the simultaneous conditions of user inactivity, external processing system loss, and reduced-duty communication (the most constrained operating scenario) without requiring any system component other than the implanted RTU and a reachable endpoint device to be operational. The performance of all steps (unavailability detection, local decoding, route determination, and notification transmission) while remaining in the idle mode achieves the technical effect of minimizing the total energy expenditure for a complete notification cycle under the most constrained conditions, because the RTU avoids the power cost of restoring full-rate streaming to an external processing system that is not available to receive it.

The routing logic executing at least in part on the RTU and excluding routes that require the external processing system based on the detected unavailability condition achieves the technical effect of directing the notification to a route that is actually reachable on the first attempt, avoiding wasted transmission energy and latency on routes that would fail. The bounded fallback vocabulary used for local decoding while in the idle mode achieves the technical effect of enabling intent classification with minimal processing overhead during a period when the RTU is operating in its lowest-power communication state, because the classification operates against a small (and, in some implementations, predefined) set of intents (such as no more than five) rather than requiring the computational resources needed for full vocabulary decoding. The combination of idle-mode operation with fallback decoding and state-aware routing on the RTU achieves the technical effect of providing a complete, self-contained notification pathway from neural intent to caregiver delivery that operates entirely within the implanted component and a single reachable endpoint device, independent of the external processing system, internet connectivity, and full-rate communication (representing the maximum degree of autonomous notification capability achievable by the implanted system).

In some examples, the RTU performs unavailability detection, local fallback-event detection, route exclusion, route selection, notification transmission, and acknowledgement monitoring while remaining in the idle mode. This enables a complete caregiver-notification cycle under a constrained operating condition in which the user is inactive or sleeping, the external processing system is unavailable, and full-rate communication would consume unnecessary power or be impossible. The same architecture may also support a notification-only implementation in which the RTU does not locally decode lock, unlock, wake, or other commands, while alternative implementations additionally support one or more of those commands as optional fallback events.

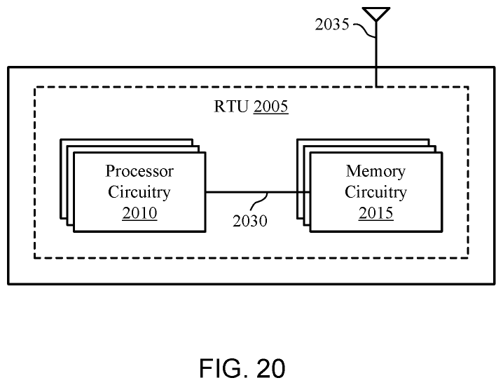

FIG. 20 shows an example of a diagram of an RTU 2005 (an implanted or implantable RTU) that supports availability enhancements for implantable neural interface systems. The RTU 2005 shown in FIG. 20 is an example of the RTU 604 described herein with reference to FIGS. 6-7, and may be implemented as a fully implanted device within the body of a user as described herein. In some examples, the RTU 2005 includes one or more chips, systems on chip (SoCs), chipsets, packages, components, or devices that individually or collectively constitute or include the RTU 2005. As shown in FIG. 20, the RTU 2005 includes processing circuitry 2010 and memory circuitry 2015, which are coupled with one another via an interface 2030. In some examples, the RTU 2005 is also coupled with a wireless communication interface 2035 that supports wireless communication between the RTU 2005 and one or more of the external processing system (e.g., the external controller 606), the personal device 612, the local alert device 610, or other components of the implantable neural interface system described herein.

The processing circuitry 2010 may be collectively configured to perform the processing steps described herein, including performing signal conditioning on electronic neural signals received from the neural interface 602, locally decoding user intents from a bounded fallback vocabulary when an unavailability condition associated with the external processing system is present, managing transitions between the active mode and the idle mode, detecting events from a predefined event set while in the idle mode, executing fallback actions based on decoded user intents, invoking routing logic to select and initiate transmission of caregiver notifications via a highest-priority available caregiver-output route, or any combination thereof. In some examples, the processing circuitry 2010 is implemented in the form of one or more processors, microcontrollers, application-specific integrated circuits (ASICs), field-programmable gate arrays (FPGAs), dedicated fixed-function circuits, or a hybrid thereof, among other examples.

In some examples, the processing circuitry 2010 includes one or more processors individually or collectively configured to perform the signal conditioning operations described herein, including amplification, bandpass filtering, and analog-to-digital conversion of the electronic neural signals received from the neural interface 602. In some examples, the processing circuitry 2010 includes one or more processors individually or collectively configured to perform the local fallback decoding operations described herein, including classifying electronic neural signals against the bounded fallback vocabulary to identify a user intent such as a notify, lock, unlock, or wake intent. In some examples, the processing circuitry 2010 includes one or more processors individually or collectively configured to perform the external controller link monitoring operations described herein, including monitoring for an absence of an expected communication from the external processing system within a configurable monitoring interval and generating an unavailability trigger that activates local fallback decoding. In some examples, the processing circuitry 2010 includes one or more processors individually or collectively configured to perform the power management and state transition operations described herein, including managing transitions between the active state 900, the idle state 902, and the optional third state 904 based on decoded user intents such as lock, unlock, and wake intents, inactivity timeouts, environment-monitoring signals, and caregiver-override signals. In some examples, the processing circuitry 2010 includes one or more processors individually or collectively configured to execute routing logic that selects a caregiver-output route from among a plurality of caregiver-output routes ordered by priority based on an availability state of at least the external processing system, as described herein. In some examples, a first portion of the processing circuitry 2010 is configured to perform signal conditioning and local intent decoding, and a second portion of the processing circuitry 2010 is configured to perform power management and state transitions, such that the two processing functions are performed without one blocking the other. In some examples, the processing circuitry 2010 is implemented within the power and thermal constraints of an implanted device, such that the local fallback logic is implemented in at least one of firmware executing on a microcontroller, a dedicated fixed-function circuit, configurable hardware, or a hybrid thereof, as described herein.

The memory circuitry 2015 may be collectively configured for storing, accessing, or retrieving information used by the processing circuitry 2010 to perform the processing steps described herein. In some examples, the memory circuitry 2015 stores processor-executable code that, when executed by the processing circuitry 2010, causes the processing circuitry 2010 to perform one or more of the operations described herein, including the local fallback decoding, active/idle mode state management, external controller link monitoring, and caregiver-notification routing operations described herein. In some examples, the memory circuitry 2015 stores the bounded fallback vocabulary described herein, including the predefined and limited set of user intents (such as notify, lock, unlock, wake, and physiological-state detection intents) that the RTU 2005 is configured to locally decode from the electronic neural signals without using the external processing system. In some examples, the memory circuitry 2015 stores the routing logic described herein, including the priority ordering of the plurality of caregiver-output routes and the route-selection and delivery-acknowledgement monitoring logic, such that the RTU 2005 is capable of autonomously selecting a caregiver-output route and initiating the transmission of a caregiver notification when the external processing system is unavailable.

In some examples, the memory circuitry 2015 stores the current operating state of the RTU 2005, including whether the RTU 2005 is in the active state, the idle state, or an external-controller-unavailable state. In some examples, the memory circuitry 2015 stores configuration parameters for the RTU 2005, including the first communication interval T1, the second communication interval T2, the configurable monitoring interval used by the external controller link monitor, the configurable timeout used by the delivery-acknowledgement monitoring logic, and the patient-configurable or caregiver-configurable priority ordering of the caregiver-output routes. In some examples, the memory circuitry 2015 includes non-volatile memory, such as read-only memory (ROM), or volatile memory, such as random-access memory (RAM), including static RAM (SRAM) or dynamic RAM (DRAM), among other examples. In some examples, the memory circuitry 2015 includes a non-volatile memory storage device used to store the bounded fallback vocabulary, the routing logic, and configuration parameters that are retained across power cycles of the RTU 2005.

As shown in FIG. 20, the processing circuitry 2010 and the memory circuitry 2015 are coupled with one another via an interface 2030. The interface 2030 may include any suitable quantities or types of interconnecting buses, bridges, or circuitry depending on the specific implementation and overall design constraints of the RTU 2005. In some examples, some or all of the processing circuitry 2010 is interconnected with the memory circuitry 2015 within a single chip, SoC, or package, which supports the compact form factor required for implantation within the body of the user. In some examples, the interface 2030 supports low-latency communication between the processing circuitry 2010 and the memory circuitry 2015, such as for the real-time signal conditioning, local intent decoding, and state transition operations performed by the RTU 2005 in response to electronic neural signals received from the neural interface 602.

The RTU 2005 is coupled with a wireless communication interface 2035. The wireless communication interface 2035 includes one or more antennas and associated radio circuitry, which may support one or more wireless communication protocols including BLE or any another wireless protocol, as described herein. In some examples, the wireless communication interface 2035 supports wireless communication between the RTU 2005 and the external processing system (e.g., the external controller 606), such as by streaming electronic neural signals to the external processing system at the first communication interval T1 during the active mode and maintaining a keepalive relationship at the second communication interval T2 during the idle mode, as described herein. In some examples, the wireless communication interface 2035 supports a direct wireless communication path between the RTU 2005 and the personal device 612, maintained independently of the external processing system, such as by transmitting a caregiver notification to the personal device 612 via a BLE connection when the external processing system is unavailable or when the RTU 2005 is in the idle mode and a caregiver-contact intent has been detected, as described herein. In some examples, the wireless communication interface 2035 supports wireless communication between the RTU 2005 and the local alert device 610, such as by transmitting a sub-GHz radio frequency alert signal (for example, a 433 MHz signal) as a fallback caregiver-output route when both the external processing system and the personal device 612 are unavailable, as described herein. In some examples, the wireless communication interface 2035 is configured to concurrently maintain a first wireless link to the external processing system and a second wireless link to the personal device 612 independently of the first wireless link, such that the RTU 2005 can route a caregiver notification via the second wireless link both during normal operation when the external processing system is available and during fallback operation when the external processing system is unavailable, as described herein. In some examples, the wireless communication interface 2035 includes antenna circuitry, modem circuitry, RF and analog circuitry including one or more filters, mixers, oscillators, amplifiers, analog-to-digital converters (ADCs), or digital-to-analog converters (DACs), or other circuitry associated with wireless communication, among other examples, all implemented within the power and thermal constraints of an implanted device.

In some examples, the RTU 2005 is configured to perform all local fallback decoding, state management, and caregiver-notification routing operations described herein without transmitting raw electronic neural signals or decoded user intents to any (unauthorized, non-private, or non-secure) external system when the external processing system is unavailable, such that the user's neural data is processed and retained locally on the RTU 2005 during fallback operation. In some examples, the RTU 2005 communicates with the external processing system during normal operation to perform full vocabulary intent decoding, and retains only the bounded fallback vocabulary and associated routing logic locally, such that the local processing architecture of the RTU 2005 is configured for the power, thermal, and form-factor constraints of an implanted device while still preserving clinically meaningful availability for the user when the external processing system is unavailable.

The RTU, the external processing system, a personal electronic device, or combinations thereof may further include one or more memories or registers storing a fallback-vocabulary definition, one or more thresholds or templates associated with fallback events, confidence or hysteresis parameters, a route-priority table, an endpoint-availability table, retry counters, acknowledgement timers, and state-transition criteria for active, idle, locked-monitoring, and external-processing-system-unavailable states. For example, the external processing system and/or a personal electronic device may include memory circuitry and/or processing circuitry, such as circuitry similar to the memory circuitry and processing circuitry described herein as being within the RTU. These stored parameters may be fixed, clinician-configurable, caregiver-configurable, patient-configurable, or adaptively updated based on system use.

The following provides an overview of aspects of the present disclosure:

Aspect 1: An implantable neural interface system, including: a neural interface implanted in a user and configured to: detect brain signals from the user; and generate electronic neural signals representative of the brain signals; a receiver and transmitter unit (RTU) coupled to the neural interface and configured to receive the electronic neural signals; and an external processing system configured to receive the electronic neural signals from the RTU and decode at least one user intent therefrom during a first operating mode; where the RTU is further configured to: decode a user intent from the electronic neural signals without using the external processing system when an unavailability condition associated with the external processing system is present; and perform a fallback action based on the user intent decoded by the RTU.

Aspect 2: The implantable neural interface system of aspect 1, where, to perform the fallback action, the RTU is further configured to transmit a caregiver notification to a personal electronic device via a wireless link between the RTU and the personal electronic device, where the RTU and the personal electronic device maintain the wireless link independently of the external processing system.

Aspect 3: The implantable neural interface system of aspect 2, where the personal electronic device is configured to operate as a gateway device that relays the caregiver notification to a caregiver without presenting a visual user interface to the user, the personal electronic device receiving the caregiver notification from the RTU and forwarding the caregiver notification to the caregiver via an internet-connected channel or a local wireless channel.

Aspect 4: The implantable neural interface system of any of aspects 2-3, where the personal electronic device includes a smartphone executing a medical application, and the wireless link between the RTU and the personal electronic device includes a Bluetooth Low Energy (BLE) connection maintained independently of the external processing system.

Aspect 5: The implantable neural interface system of any of aspects 2-4, where the RTU is further configured to monitor for a delivery acknowledgement from the personal electronic device; and upon expiration of a configurable timeout without acknowledgement, transmit the caregiver notification using a next-priority caregiver-output route.

Aspect 6: The implantable neural interface system of any of aspects 1-5, where the RTU is further configured to detect the unavailability condition associated with the external processing system, where the RTU decodes the user intent from the electronic neural signals without using the external processing system in accordance with detection of the unavailability condition associated with the external processing system.

Aspect 7: The implantable neural interface system of aspect 6, where the RTU is configured to detect the unavailability condition by monitoring for an absence of an expected communication from the external processing system within a configurable monitoring interval.

Aspect 8: The implantable neural interface system of any of aspects 1-7, where, to perform the fallback action, the RTU is further configured to change the implantable neural interface system between an active state and an idle or locked state.

Aspect 9: The implantable neural interface system of any of aspects 1-8, where, to perform the fallback action, the RTU is further configured to issue a wake or recovery command directed to the external processing system.

Aspect 10: The implantable neural interface system of any of aspects 1-9, where, to perform the fallback action, the RTU is further configured to transmit an alert signal to a local notification device.

Aspect 11: The implantable neural interface system of any of aspects 1-10, where the user intent is from a bounded fallback vocabulary of the RTU.

Aspect 12: The implantable neural interface system of aspect 11, where the bounded fallback vocabulary includes a caregiver-contact or notification intent.

Aspect 13: The implantable neural interface system of any of aspects 11-12, where the bounded fallback vocabulary further includes at least one of: a lock intent, an unlock intent, a wake intent, or a physiological-state detection intent.

Aspect 14: The implantable neural interface system of any of aspects 11-13, where the bounded fallback vocabulary includes a physiological-state intent, and where, to perform the fallback action, the RTU is further configured to: initiate a caregiver notification responsive to detection of the physiological-state intent.

Aspect 15: The implantable neural interface system of any of aspects 11-14, where the bounded fallback vocabulary includes no more than five intents.

Aspect 16: The implantable neural interface system of any of aspects 1-15, where the RTU includes local fallback logic, the local fallback logic includes logic configured to locally decode the user intent, and the local fallback logic is implemented in at least one of firmware executing on a microcontroller, a dedicated fixed-function circuit, configurable hardware, or a hybrid thereof.

Aspect 17: The implantable neural interface system of any of aspects 1-16, where the external processing system is implemented by a signal control unit that is physically separate from the RTU.

Aspect 18: The implantable neural interface system of any of aspects 1-17, where the external processing system is implemented by a host device that executes a neural interface application, without a separate signal control unit.

Aspect 19: The implantable neural interface system of any of aspects 1-18, where the external processing system is implemented by a signal control unit operating in conjunction with a host device.

Aspect 20: The implantable neural interface system of any of aspects 1-19, where the unavailability condition associated with the external processing system includes at least one of: the external processing system being out of wireless range, powered off, physically damaged, misplaced, or in a software-failure state.

Aspect 21: The implantable neural interface system of any of aspects 1-20, where the RTU is implanted in the user.

Aspect 22: The implantable neural interface system of any of aspects 1-21, where the RTU is configured to concurrently maintain a first wireless link to the external processing system during the first operating mode; and a second wireless link to a personal electronic device independent of the first wireless link; where the RTU is configured to route a caregiver notification via the second wireless link both during the first operating mode when the external processing system is available and during a second operating mode when the external processing system is unavailable.

Aspect 23: The implantable neural interface system of any of aspects 1-22, where the RTU is further configured to, upon restoration of communication with the external processing system, transition from a second operating mode to the first operating mode in which the external processing system resumes decoding user intents from the electronic neural signals.

Aspect 24: The implantable neural interface system of any of aspects 1-23, where the RTU is further operable in an active mode and an idle mode, where in the active mode the RTU communicates the electronic neural signals with the external processing system according to a first communication interval; in the idle mode the RTU communicates with the external processing system according to a second communication interval; and the RTU is configured to decode the user intent and perform the fallback action in both the active mode and the idle mode.

Aspect 25: A method performed by an implantable neural interface system, the method including: detecting, by a neural interface implanted in a user, brain signals from the user; generating, by the neural interface, electronic neural signals representative of the brain signals; receiving, by a receiver and transmitter unit (RTU) coupled to the neural interface, the electronic neural signals; communicating, by the RTU, the electronic neural signals to an external processing system, where the external processing system decodes at least one user intent therefrom during a first operating mode; decoding, by the RTU, a user intent from the electronic neural signals without using the external processing system when an unavailability condition associated with the external processing system is present; and performing, by the RTU, a fallback action based on the user intent decoded by the RTU.

Aspect 26: The method of aspect 25, where performing the fallback action includes: transmitting, by the RTU, a caregiver notification to a personal electronic device via a wireless link between the RTU and the personal electronic device, where the RTU and the personal electronic device maintain the wireless link independently of the external processing system.

Aspect 27: The method of aspect 26, where the personal electronic device operates as a gateway device that relays the caregiver notification to a caregiver without presenting a visual user interface to the user, the personal electronic device receiving the caregiver notification from the RTU and forwarding the caregiver notification to the caregiver via an internet-connected channel or a local wireless channel.

Aspect 28: The method of any of aspects 26-27, where the personal electronic device includes a smartphone executing a medical application, and the wireless link between the RTU and the personal electronic device includes a Bluetooth Low Energy (BLE) connection maintained independently of the external processing system.

Aspect 29: The method of any of aspects 26-28, further including: monitoring, by the RTU, for a delivery acknowledgement from the personal electronic device; and upon expiration of a configurable timeout without acknowledgement, transmitting, by the RTU, the caregiver notification using a next-priority caregiver-output route.

Aspect 30: The method of any of aspects 25-29, further including: detecting, by the RTU, the unavailability condition associated with the external processing system, where the RTU decodes the user intent from the electronic neural signals without using the external processing system in accordance with detection of the unavailability condition associated with the external processing system.

Aspect 31: The method of aspect 30, where detecting the unavailability condition includes monitoring, by the RTU, for an absence of an expected communication from the external processing system within a configurable monitoring interval.

Aspect 32: The method of any of aspects 25-31, where performing the fallback action includes: changing, by the RTU, the implantable neural interface system between an active state and an idle or locked state.

Aspect 33: The method of any of aspects 25-32, where performing the fallback action includes: issuing, by the RTU, a wake or recovery command directed to the external processing system.

Aspect 34: The method of any of aspects 25-33, where performing the fallback action includes: transmitting, by the RTU, an alert signal to a local notification device.

Aspect 35: The method of any of aspects 25-34, where the user intent is from a bounded fallback vocabulary of the RTU.

Aspect 36: The method of aspect 35, where the bounded fallback vocabulary includes a caregiver-contact or notification intent.

Aspect 37: The method of any of aspects 35-36, where the bounded fallback vocabulary further includes at least one of: a lock intent, an unlock intent, a wake intent, or a physiological-state detection intent.

Aspect 38: The method of any of aspects 35-37, where the bounded fallback vocabulary includes a physiological-state intent, and where performing the fallback action includes: initiating, by the RTU, a caregiver notification responsive to detection of the physiological-state intent.

Aspect 39: The method of any of aspects 35-38, where the bounded fallback vocabulary includes no more than five intents.

Aspect 40: The method of any of aspects 25-39, where the RTU includes local fallback logic, the local fallback logic includes logic configured to locally decode the user intent, and the local fallback logic is implemented in at least one of firmware executing on a microcontroller, a dedicated fixed-function circuit, configurable hardware, or a hybrid thereof.

Aspect 41: The method of any of aspects 25-40, where the external processing system is implemented by a signal control unit that is physically separate from the RTU.

Aspect 42: The method of any of aspects 25-41, where the external processing system is implemented by a host device that executes a neural interface application, without a separate signal control unit.

Aspect 43: The method of any of aspects 25-42, where the external processing system is implemented by a signal control unit operating in conjunction with a host device.

Aspect 44: The method of any of aspects 25-43, where the unavailability condition associated with the external processing system includes at least one of: the external processing system being out of wireless range, powered off, physically damaged, misplaced, or in a software-failure state.

Aspect 45: The method of any of aspects 25-44, where the RTU is implanted in the user.

Aspect 46: The method of any of aspects 25-45, further including concurrently maintaining, by the RTU: a first wireless link to the external processing system during the first operating mode; and a second wireless link to a personal electronic device independent of the first wireless link; where the RTU routes a caregiver notification via the second wireless link both during the first operating mode when the external processing system is available and during a second operating mode when the external processing system is unavailable.

Aspect 47: The method of any of aspects 25-46, further including, upon restoration of communication with the external processing system, transitioning, by the RTU, from a second operating mode to the first operating mode in which the external processing system resumes decoding user intents from the electronic neural signals.

Aspect 48: The method of any of aspects 25-47, where the RTU is further operable in an active mode and an idle mode, where in the active mode the RTU communicates the electronic neural signals with the external processing system according to a first communication interval; in the idle mode the RTU communicates with the external processing system according to a second communication interval; and the RTU decodes the user intent and performs the fallback action in both the active mode and the idle mode.

Aspect 49: A receiver and transmitter unit (RTU) for use in an implantable neural interface system, the RTU including: a (wireless and/or wired) communication interface configured to: receive electronic neural signals from a neural interface implanted in a user, the electronic neural signals being representative of brain signals detected from the user; and communicate the electronic neural signals to an external processing system during a first operating mode, where the external processing system decodes at least one user intent from the electronic neural signals; and processing circuitry configured to: decode a user intent from the electronic neural signals without using the external processing system when an unavailability condition associated with the external processing system is present; and cause the RTU to perform a fallback action based on the user intent decoded by the processing circuitry.

Aspect 50: The RTU of aspect 49, where, to perform the fallback action, the processing circuitry is further configured to cause the communication interface to transmit a caregiver notification to a personal electronic device via a wireless link between the RTU and the personal electronic device, where the RTU and the personal electronic device maintain the wireless link independently of the external processing system.

Aspect 51: The RTU of aspect 50, where the personal electronic device is configured to operate as a gateway device that relays the caregiver notification to a caregiver without presenting a visual user interface to the user, the personal electronic device receiving the caregiver notification from the RTU and forwarding the caregiver notification to the caregiver via an internet-connected channel or a local wireless channel.

Aspect 52: The RTU of any of aspects 50-51, where the personal electronic device includes a smartphone executing a medical application, and the wireless link between the RTU and the personal electronic device includes a Bluetooth Low Energy (BLE) connection maintained independently of the external processing system.

Aspect 53: The RTU of any of aspects 50-52, where the processing circuitry is further configured to monitor for a delivery acknowledgement from the personal electronic device; and upon expiration of a configurable timeout without acknowledgement, cause the communication interface to transmit the caregiver notification using a next-priority caregiver-output route.

Aspect 54: The RTU of any of aspects 49-53, where the processing circuitry is further configured to detect the unavailability condition associated with the external processing system, where the processing circuitry decodes the user intent from the electronic neural signals without using the external processing system in accordance with detection of the unavailability condition.

Aspect 55: The RTU of aspect 54, where the processing circuitry is configured to detect the unavailability condition by monitoring for an absence of an expected communication from the external processing system within a configurable monitoring interval.

Aspect 56: The RTU of any of aspects 49-55, where, to perform the fallback action, the processing circuitry is further configured to change the implantable neural interface system between an active state and an idle or locked state.

Aspect 57: The RTU of any of aspects 49-56, where, to perform the fallback action, the processing circuitry is further configured to issue a wake or recovery command directed to the external processing system via the communication interface.

Aspect 58: The RTU of any of aspects 49-57, where, to perform the fallback action, the processing circuitry is further configured to cause the communication interface to transmit an alert signal to a local notification device.

Aspect 59: The RTU of any of aspects 49-58, where the user intent is from a bounded fallback vocabulary stored on the RTU.

Aspect 60: The RTU of aspect 59, where the bounded fallback vocabulary includes a caregiver-contact or notification intent.

Aspect 61: The RTU of any of aspects 59-60, where the bounded fallback vocabulary further includes at least one of: a lock intent, an unlock intent, a wake intent, or a physiological-state detection intent.

Aspect 62: The RTU of any of aspects 59-61, where the bounded fallback vocabulary includes a physiological-state intent, and where, to perform the fallback action, the processing circuitry is further configured to: initiate a caregiver notification responsive to detection of the physiological-state intent.

Aspect 63: The RTU of any of aspects 59-62, where the bounded fallback vocabulary includes no more than five intents.

Aspect 64: The RTU of any of aspects 49-63, where the processing circuitry includes local fallback logic implemented in at least one of firmware executing on a microcontroller, a dedicated fixed-function circuit, configurable hardware, or a hybrid thereof.

Aspect 65: The RTU of any of aspects 49-64, where the RTU is configured for implantation in the user.

Aspect 66: The RTU of any of aspects 49-65, where the communication interface is configured to concurrently maintain a first wireless link to the external processing system during the first operating mode; and a second wireless link to a personal electronic device independent of the first wireless link; where the processing circuitry is configured to route a caregiver notification via the second wireless link both during the first operating mode when the external processing system is available and during a second operating mode when the external processing system is unavailable.

Aspect 67: The RTU of any of aspects 49-66, where the processing circuitry is further configured to, upon restoration of communication with the external processing system, transition from a second operating mode to the first operating mode in which the external processing system resumes decoding user intents from the electronic neural signals.

Aspect 68: The RTU of any of aspects 49-67, where the RTU is further operable in an active mode and an idle mode, where in the active mode the communication interface communicates the electronic neural signals with the external processing system according to a first communication interval; in the idle mode the communication interface communicates with the external processing system according to a second communication interval; and the processing circuitry is configured to decode the user intent and cause the RTU to perform the fallback action in both the active mode and the idle mode.

Aspect 69: An implantable neural interface system, including: a neural interface implanted in a user and configured to: detect brain signals from the user; and generate electronic neural signals representative of the brain signals; a receiver and transmitter unit (RTU) coupled to the neural interface and configured to communicate the electronic neural signals with an external processing system; and where the RTU is operable in: an active mode in which the RTU communicates the electronic neural signals with the external processing system according to a first communication interval; and an idle mode in which the RTU communicates the electronic neural signals with the external processing system according to a second communication interval; where, in the idle mode, the RTU is configured to: detect at least one event; and responsive to detection of the at least one event, transition to the active mode or transmit a notification via a wireless link maintained by the RTU independently of the external processing system.

Aspect 70: The implantable neural interface system of aspect 69, where the at least one event includes a wake intent or an unlock intent detected from a brain signal received by the RTU while in the idle mode.

Aspect 71: The implantable neural interface system of aspect 70, where the at least one event includes a caregiver-contact intent, and the RTU transmits the notification without first resuming the active mode.

Aspect 72: The implantable neural interface system of any of aspects 69-71, where the RTU is further operable in a third mode intermediate between the active mode and the idle mode.

Aspect 73: The implantable neural interface system of any of aspects 69-72, where the RTU is implanted in the user.

Aspect 74: The implantable neural interface system of any of aspects 69-73, where the RTU is further configured to receive a caregiver-override signal while in the idle mode and, responsive to receipt of the caregiver-override signal, transition to the active mode regardless of whether an unlock intent has been detected from the user.

Aspect 75: The implantable neural interface system of any of aspects 69-74, where a user-generated lock intent decoded from the electronic neural signals, an inactivity timeout triggered by absence of detected neural activity for a configurable period, an environment-monitoring signal indicating a sleep or rest condition, or a command received from the external processing system or a caregiver device triggers entry to the idle mode.

Aspect 76: The implantable neural interface system of any of aspects 69-75, where the first communication interval is on an order of milliseconds and the second communication interval is on the order of seconds.

Aspect 77: The implantable neural interface system of any of aspects 69-76, where the first communication interval is within about 1-500 milliseconds, 5-250 milliseconds, 5-100 milliseconds, 5-50 milliseconds, 5-20 milliseconds, or 7-10 milliseconds and the second communication interval is within about 250 milliseconds-120 seconds, 500 milliseconds-60 seconds, 1-30 seconds, 2-15 seconds, 2-8 seconds, or 3-5 seconds.

Aspect 78: The implantable neural interface system of any of aspects 69-77, where the second communication interval is greater than the first communication interval by at least one order of magnitude.

Aspect 79: The implantable neural interface system of any of aspects 69-78, where responsive to the detection of the at least one event, the RTU is configured to transmit the notification to a gateway device via the wireless link.

Aspect 80: The implantable neural interface system of aspect 79, where the gateway device includes a personal electronic device executing a medical application configured to route the notification to a caregiver.

Aspect 81: A method performed by an implantable neural interface system, the method including: detecting, by a neural interface implanted in a user, brain signals from the user; generating, by the neural interface, electronic neural signals representative of the brain signals; communicating, by a receiver and transmitter unit (RTU) coupled to the neural interface, the electronic neural signals with an external processing system; operating the RTU in an active mode in which the RTU communicates the electronic neural signals with the external processing system according to a first communication interval; transitioning the RTU to an idle mode in which the RTU communicates the electronic neural signals with the external processing system according to a second communication interval; detecting, by the RTU while in the idle mode, at least one event; and responsive to detection of the at least one event, transitioning the RTU to the active mode or transmitting, by the RTU, a notification via a wireless link maintained by the RTU independently of the external processing system.

Aspect 82: The method of aspect 81, where the at least one event includes a wake intent or an unlock intent detected from a brain signal received by the RTU while in the idle mode.

Aspect 83: The method of aspect 82, where the at least one event includes a caregiver-contact intent, and the RTU transmits the notification to a gateway device without first resuming the active mode.

Aspect 84: The method of any of aspects 81-83, where the notification is transmitted to a gateway device including a personal electronic device executing a medical application configured to route the notification to a caregiver.

Aspect 85: The method of any of aspects 81-84, further including operating the RTU in a third mode intermediate between the active mode and the idle mode.

Aspect 86: The method of any of aspects 81-85, where the RTU is implanted in the user.

Aspect 87: The method of any of aspects 81-86, further including: receiving, by the RTU, a caregiver-override signal while in the idle mode; and responsive to receipt of the caregiver-override signal, transitioning the RTU to the active mode regardless of whether an unlock intent has been detected from the user.

Aspect 88: The method of any of aspects 81-87, where at least one of a user-generated lock intent decoded from the electronic neural signals, an inactivity timeout triggered by absence of detected neural activity for a configurable period, an environment-monitoring signal indicating a sleep or rest condition, or a command received from the external processing system or a caregiver device triggers entry to the idle mode.

Aspect 89: The method of any of aspects 81-88, where the first communication interval is on an order of milliseconds and the second communication interval is on the order of seconds.

Aspect 90: The method of any of aspects 81-89, where the first communication interval is within about 1-500 milliseconds, 5-250 milliseconds, 5-100 milliseconds, 5-50 milliseconds, 5-20 milliseconds, or 7-10 milliseconds and the second communication interval is within about 250 milliseconds-120 seconds, 500 milliseconds-60 seconds, 1-30 seconds, 2-15 seconds, 2-8 seconds, or 3-5 seconds.

Aspect 91: The method of any of aspects 81-90, where the second communication interval is greater than the first communication interval by at least one order of magnitude.

Aspect 92: The method of any of aspects 81-91, where responsive to the detection of the at least one event, the RTU transmits the notification to a gateway device via the wireless link.

Aspect 93: A receiver and transmitter unit (RTU) for use in an implantable neural interface system, the RTU including: a (wireless and/or wired) communication interface configured to communicate electronic neural signals, received from a neural interface implanted in a user, with an external processing system; and processing circuitry configured to operate the RTU in: an active mode in which the communication interface communicates the electronic neural signals with the external processing system according to a first communication interval; and an idle mode in which the communication interface communicates the electronic neural signals with the external processing system according to a second communication interval; where, in the idle mode, the processing circuitry is configured to: detect at least one event; and responsive to detection of the at least one event, transition the RTU to the active mode or cause the communication interface to transmit a notification via a wireless link maintained by the RTU independently of the external processing system.

Aspect 94: The RTU of aspect 93, where the at least one event includes a wake intent or an unlock intent detected from a brain signal received by the RTU while in the idle mode.

Aspect 95: The RTU of aspect 94, where the at least one event includes a caregiver-contact intent, and the processing circuitry causes the communication interface to transmit the notification without first resuming the active mode.

Aspect 96: The RTU of any of aspects 93-95, where the processing circuitry is further configured to operate the RTU in a third mode intermediate between the active mode and the idle mode.

Aspect 97: The RTU of any of aspects 93-96, where the RTU is configured for implantation in the user.

Aspect 98: The RTU of any of aspects 93-97, where the processing circuitry is further configured to receive a caregiver-override signal via the communication interface while in the idle mode; and responsive to receipt of the caregiver-override signal, transition the RTU to the active mode regardless of whether an unlock intent has been detected from the user.

Aspect 99: The RTU of any of aspects 93-98, where at least one of a user-generated lock intent decoded from the electronic neural signals, an inactivity timeout triggered by absence of detected neural activity for a configurable period, an environment-monitoring signal indicating a sleep or rest condition, or a command received from the external processing system or a caregiver device triggers entry to the idle mode.

Aspect 100: The RTU of any of aspects 93-99, where the first communication interval is on an order of milliseconds and the second communication interval is on the order of seconds.

Aspect 101: The RTU of any of aspects 93-100, where the first communication interval is within about 1-500 milliseconds, 5-250 milliseconds, 5-100 milliseconds, 5-50 milliseconds, 5-20 milliseconds, or 7-10 milliseconds and the second communication interval is within about 250 milliseconds-120 seconds, 500 milliseconds-60 seconds, 1-30 seconds, 2-15 seconds, 2-8 seconds, or 3-5 seconds.

Aspect 102: The RTU of any of aspects 93-101, where the second communication interval is greater than the first communication interval by at least one order of magnitude.

Aspect 103: The RTU of any of aspects 93-102, where responsive to the detection of the at least one event, the processing circuitry is configured to cause the communication interface to transmit the notification to a gateway device via the wireless link.

Aspect 104: The RTU of aspect 103, where the gateway device includes a personal electronic device executing a medical application configured to route the notification to a caregiver.

Aspect 105: An implantable neural interface system, including: a neural interface implanted in a user and configured to: detect brain signals from the user; and generate electronic neural signals representative of the brain signals; a receiver and transmitter unit (RTU) coupled to the neural interface and configured to receive the electronic neural signals from the neural interface; an external processing system configured to receive the electronic neural signals from the RTU and decode user intents therefrom during a first operating mode; and routing logic configured to: determine, based on an availability state of at least the external processing system, which of a set of multiple caregiver-output routes is available; and initiate a transmission of a caregiver notification, generated in response to a user intent decoded from the electronic neural signals, via a highest-priority available caregiver-output route from among the set of multiple caregiver-output routes; where the set of multiple caregiver-output routes are ordered by priority and includes at least a primary route associated with internet connectivity and at least one fallback route that does not use the external processing system.

Aspect 106: The implantable neural interface system of aspect 105, where the user intent is to contact a caregiver, and the routing logic is configured to initiate the transmission of the caregiver notification via the highest-priority available caregiver-output route based on the user intent being to contact the caregiver.

Aspect 107: The implantable neural interface system of any of aspects 105-106, where the user intent is to contact a caregiver, and the highest-priority available caregiver-output route includes a wireless signal to an alert device when there is a lack of network connectivity.

Aspect 108: The implantable neural interface system of aspect 107, where the wireless signal is a 433 megahertz (MHz) wireless signal.

Aspect 109: The implantable neural interface system of any of aspects 105-108, where the routing logic is further configured to select a caregiver-output route based in part on a priority level of the user intent, a first user intent having a higher priority level triggers the transmission of the caregiver notification via a higher-priority caregiver-output route and a second user intent having a lower priority level triggers the transmission of the caregiver notification via a lower-priority caregiver-output route.

Aspect 110: The implantable neural interface system of any of aspects 105-109, where the routing logic is further configured to select a caregiver-output route based in part on a privacy preference associated with the user, when a higher-privacy preference is indicated, the caregiver-output route delivers a reduced-detail or non-audible notification in preference to a route that delivers a higher-detail or audible notification.

Aspect 111: The implantable neural interface system of any of aspects 105-110, where the routing logic is further configured to select the highest-priority available caregiver-output route from among the set of multiple caregiver-output routes, initiation of the transmission of the caregiver notification via the highest-priority available caregiver-output route is based on selection of the highest-priority available caregiver-output route.

Aspect 112: The implantable neural interface system of any of aspects 105-111, where when both the external processing system and the internet connectivity are available, the routing logic selects a caregiver-output route that delivers a generated or custom text message via an internet-connected channel.

Aspect 113: The implantable neural interface system of any of aspects 105-112, where when the external processing system is available and the internet connectivity is unavailable, the routing logic selects a caregiver-output route that delivers a pre-recorded, synthesized, or canned message via a local communication channel.

Aspect 114: The implantable neural interface system of any of aspects 105-113, where when the external processing system is unavailable, the routing logic, executing at least in part on the RTU, selects a fallback caregiver-output route associated with a personal electronic device or a local notification device independently of the external processing system.

Aspect 115: The implantable neural interface system of any of aspects 105-114, where the routing logic is stored at least in part on the RTU such that the RTU is capable of selecting a caregiver-output route and initiating the transmission of the caregiver notification autonomously when the external processing system is unavailable.

Aspect 116: The implantable neural interface system of any of aspects 105-115, where the routing logic is further configured to monitor for a delivery acknowledgement on the highest-priority available caregiver-output route and, upon expiration of a configurable timeout without acknowledgement, initiate the transmission of the caregiver notification via a next-priority available caregiver-output route from among the set of multiple caregiver-output routes.

Aspect 117: The implantable neural interface system of any of aspects 105-116, where each caregiver-output route is configured to deliver at least one of a generated text message, a canned text message, a pre-recorded audio message, a synthesized audio message, a tone, or a sub-GHz radio frequency alert signal.

Aspect 118: The implantable neural interface system of aspect 117, where the generated text message is produced by a large language model configured with context and communication preferences of the user.

Aspect 119: The implantable neural interface system of any of aspects 105-118, further including a component configured to detect an outage condition based on failure to receive an expected packet or heartbeat message within a configurable interval, where detection of the outage condition triggers the routing logic to re-evaluate route availability.

Aspect 120: The implantable neural interface system of any of aspects 105-119, where the routing logic is further configured to monitor a health status of each of a set of multiple system components including at least the external processing system and a network connection; detect a component-outage condition based on absence of an expected status indicator from at least one of the set of multiple system components within a configurable monitoring interval; and initiate a transmission of an outage notification to a caregiver via a caregiver-output route without a user-generated intent as a trigger.

Aspect 121: The implantable neural interface system of any of aspects 105-120, where the routing logic is further configured to monitor a quality metric of the electronic neural signals received from the neural interface; detect a signal-degradation condition when the quality metric falls below a threshold; and initiate a transmission of a signal-degradation notification to a caregiver via a caregiver-output route without a user-generated intent as a trigger.

Aspect 122: The implantable neural interface system of any of aspects 105-121, where a priority ordering of the set of multiple caregiver-output routes is patient-configurable or caregiver-configurable.

Aspect 123: The implantable neural interface system of any of aspects 105-122, where the set of multiple caregiver-output routes includes at least three route families: an external-processing-system-mediated route family, a personal-electronic-device-mediated route family, and a local-alert-device-mediated route family.

Aspect 124: A method performed by an implantable neural interface system, the method including: detecting, by a neural interface implanted in a user, brain signals from the user; generating, by the neural interface, electronic neural signals representative of the brain signals; receiving, by a receiver and transmitter unit (RTU) coupled to the neural interface, the electronic neural signals from the neural interface; decoding, by an external processing system during a first operating mode, user intents from the electronic neural signals received from the RTU; determining, based on an availability state of at least the external processing system, which of a set of multiple caregiver-output routes is available; and initiating a transmission of a caregiver notification, generated in response to a user intent decoded from the electronic neural signals, via a highest-priority available caregiver-output route from among the set of multiple caregiver-output routes; where the set of multiple caregiver-output routes are ordered by priority and includes at least a primary route associated with internet connectivity and at least one fallback route that does not use the external processing system.

Aspect 125: The method of aspect 124, where the user intent is to contact a caregiver, and initiating the transmission of the caregiver notification via the highest-priority available caregiver-output route is based on the user intent being to contact the caregiver.

Aspect 126: The method of any of aspects 124-125, where the user intent is to contact a caregiver, and the highest-priority available caregiver-output route includes a wireless signal to an alert device when there is a lack of network connectivity.

Aspect 127: The method of aspect 126, where the wireless signal is a 433 megahertz (MHz) wireless signal.

Aspect 128: The method of any of aspects 124-127, further including selecting a caregiver-output route based in part on a priority level of the user intent, where a first user intent having a higher priority level triggers the transmission of the caregiver notification via a higher-priority caregiver-output route and a second user intent having a lower priority level triggers the transmission of the caregiver notification via a lower-priority caregiver-output route.

Aspect 129: The method of any of aspects 124-128, further including selecting a caregiver-output route based in part on a privacy preference associated with the user, where when a higher-privacy preference is indicated, the caregiver-output route delivers a reduced-detail or non-audible notification in preference to a route that delivers a higher-detail or audible notification.

Aspect 130: The method of any of aspects 124-129, further including selecting the highest-priority available caregiver-output route from among the set of multiple caregiver-output routes, where initiation of the transmission of the caregiver notification via the highest-priority available caregiver-output route is based on selection of the highest-priority available caregiver-output route.

Aspect 131: The method of any of aspects 124-130, where when both the external processing system and the internet connectivity are available, a caregiver-output route that delivers a generated or custom text message via an internet-connected channel is selected.

Aspect 132: The method of any of aspects 124-131, where when the external processing system is available and the internet connectivity is unavailable, a caregiver-output route that delivers a pre-recorded, synthesized, or canned message via a local communication channel is selected.

Aspect 133: The method of any of aspects 124-132, where when the external processing system is unavailable, a fallback caregiver-output route associated with a personal electronic device or a local notification device independently of the external processing system is selected.

Aspect 134: The method of any of aspects 124-133, where the RTU is capable of selecting a caregiver-output route and initiating the transmission of the caregiver notification autonomously when the external processing system is unavailable.

Aspect 135: The method of any of aspects 124-134, further including: monitoring for a delivery acknowledgement on the highest-priority available caregiver-output route; and upon expiration of a configurable timeout without acknowledgement, initiating the transmission of the caregiver notification via a next-priority available caregiver-output route from among the set of multiple caregiver-output routes.

Aspect 136: The method of any of aspects 124-135, where each caregiver-output route is configured to deliver at least one of a generated text message, a canned text message, a pre-recorded audio message, a synthesized audio message, a tone, or a sub-GHz radio frequency alert signal.

Aspect 137: The method of aspect 136, where the generated text message is produced by a large language model configured with context and communication preferences of the user.

Aspect 138: The method of any of aspects 124-137, further including: detecting, by a component of the implantable neural interface system, an outage condition based on failure to receive an expected packet or heartbeat message within a configurable interval, where detection of the outage condition triggers a re-evaluation of route availability.

Aspect 139: The method of any of aspects 124-138, further including: monitoring a health status of each of a set of multiple system components including at least the external processing system and a network connection; detecting a component-outage condition based on absence of an expected status indicator from at least one of the set of multiple system components within a configurable monitoring interval; and initiating a transmission of an outage notification to a caregiver via a caregiver-output route without a user-generated intent as a trigger.

Aspect 140: The method of any of aspects 124-139, further including: monitoring a quality metric of the electronic neural signals received from the neural interface; detecting a signal-degradation condition when the quality metric falls below a threshold; and initiating a transmission of a signal-degradation notification to a caregiver via a caregiver-output route without a user-generated intent as a trigger.

Aspect 141: The method of any of aspects 124-140, where a priority ordering of the set of multiple caregiver-output routes is patient-configurable or caregiver-configurable.

Aspect 142: The method of any of aspects 124-141, where the set of multiple caregiver-output routes includes at least three route families: an external-processing-system-mediated route family, a personal-electronic-device-mediated route family, and a local-alert-device-mediated route family.

Aspect 143: A processing device for use in an implantable neural interface system, the processing device including: a (wireless and/or wired) communication interface configured to receive electronic neural signals from a receiver and transmitter unit (RTU) coupled to a neural interface implanted in a user, the electronic neural signals being representative of brain signals detected from the user; a processor configured to decode user intents from the electronic neural signals during a first operating mode; and routing logic configured to: determine, based on an availability state of at least the processing device and a network connection, which of a set of multiple caregiver-output routes is available; and initiate a transmission of a caregiver notification, generated in response to a user intent decoded from the electronic neural signals, via a highest-priority available caregiver-output route from among the set of multiple caregiver-output routes; where the set of multiple caregiver-output routes are ordered by priority and includes at least a primary route associated with internet connectivity and at least one fallback route that does not use the processing device.

Aspect 144: The processing device of aspect 143, where the user intent is to contact a caregiver, and the routing logic is configured to initiate the transmission of the caregiver notification via the highest-priority available caregiver-output route based on the user intent being to contact the caregiver.

Aspect 145: The processing device of any of aspects 143-144, where the user intent is to contact a caregiver, and the highest-priority available caregiver-output route includes a wireless signal to an alert device when there is a lack of network connectivity.

Aspect 146: The processing device of aspect 145, where the wireless signal is a 433 megahertz (MHz) wireless signal.

Aspect 147: The processing device of any of aspects 143-146, where the routing logic is further configured to select a caregiver-output route based in part on a priority level of the user intent, a first user intent having a higher priority level triggers the transmission of the caregiver notification via a higher-priority caregiver-output route and a second user intent having a lower priority level triggers the transmission of the caregiver notification via a lower-priority caregiver-output route.

Aspect 148: The processing device of any of aspects 143-147, where the routing logic is further configured to select a caregiver-output route based in part on a privacy preference associated with the user, when a higher-privacy preference is indicated, the caregiver-output route delivers a reduced-detail or non-audible notification in preference to a route that delivers a higher-detail or audible notification.

Aspect 149: The processing device of any of aspects 143-148, where the routing logic is further configured to select the highest-priority available caregiver-output route from among the set of multiple caregiver-output routes, initiation of the transmission of the caregiver notification via the highest-priority available caregiver-output route is based on selection of the highest-priority available caregiver-output route.

Aspect 150: The processing device of any of aspects 143-149, where when both the processing device and the internet connectivity are available, the routing logic selects a caregiver-output route that delivers a generated or custom text message via an internet-connected channel.

Aspect 151: The processing device of any of aspects 143-150, where when the processing device is available and the internet connectivity is unavailable, the routing logic selects a caregiver-output route that delivers a pre-recorded, synthesized, or canned message via a local communication channel.

Aspect 152: The processing device of any of aspects 143-151, where the routing logic is further configured to monitor for a delivery acknowledgement on the highest-priority available caregiver-output route and, upon expiration of a configurable timeout without acknowledgement, initiate the transmission of the caregiver notification via a next-priority available caregiver-output route from among the set of multiple caregiver-output routes.

Aspect 153: The processing device of any of aspects 143-152, where each caregiver-output route is configured to deliver at least one of a generated text message, a canned text message, a pre-recorded audio message, a synthesized audio message, a tone, or a sub-GHz radio frequency alert signal.

Aspect 154: The processing device of aspect 153, where the generated text message is produced by a large language model configured with context and communication preferences of the user.

Aspect 155: The processing device of any of aspects 143-154, further including a monitoring component configured to detect an outage condition based on failure to receive an expected packet or heartbeat message within a configurable interval, where detection of the outage condition triggers the routing logic to re-evaluate route availability.

Aspect 156: The processing device of any of aspects 143-155, where the routing logic is further configured to monitor a health status of each of a set of multiple system components including at least the processing device and the network connection; detect a component-outage condition based on absence of an expected status indicator from at least one of the set of multiple system components within a configurable monitoring interval; and initiate a transmission of an outage notification to a caregiver via a caregiver-output route without a user-generated intent as a trigger.

Aspect 157: The processing device of any of aspects 143-156, where the routing logic is further configured to monitor a quality metric of the electronic neural signals received from the RTU; detect a signal-degradation condition when the quality metric falls below a threshold; and initiate a transmission of a signal-degradation notification to a caregiver via a caregiver-output route without a user-generated intent as a trigger.

Aspect 158: The processing device of any of aspects 143-157, where a priority ordering of the set of multiple caregiver-output routes is patient-configurable or caregiver-configurable.

Aspect 159: The processing device of any of aspects 143-158, where the set of multiple caregiver-output routes includes at least three route families: an external-processing-system-mediated route family, a personal-electronic-device-mediated route family, and a local-alert-device-mediated route family.

Aspect 160: An implantable neural interface system, including: a neural interface implanted in a user and configured to detect brain signals from the user and generate electronic neural signals representative of the brain signals; a receiver and transmitter unit (RTU) coupled to the neural interface and configured to communicate the electronic neural signals with an external processing system; and where the RTU is operable in: an active mode in which the RTU communicates the electronic neural signals with the external processing system according to a first communication interval; and an idle mode in which the RTU communicates with the external processing system according to a second communication interval; where, in the idle mode, the RTU is configured to: detect at least one event from a predefined event set; and decode a user intent from the electronic neural signals without using the external processing system when an unavailability condition associated with the external processing system is present; and perform a fallback action based on the user intent decoded by the RTU while remaining in the idle mode.

Aspect 161: The implantable neural interface system of aspect 160, where the fallback action includes transmitting a caregiver notification to a personal electronic device via a wireless link maintained by the RTU independently of the external processing system, without first transitioning to the active mode.

Aspect 162: The implantable neural interface system of any of aspects 160-161, where the predefined event set includes at least an unlock intent that triggers a transition from the idle mode to the active mode and a caregiver-contact intent that triggers the fallback action without transitioning to the active mode.

Aspect 163: The implantable neural interface system of any of aspects 160-162, where the first communication interval is on an order of milliseconds and the second communication interval is on an order of seconds, and the user intent is from a bounded fallback vocabulary including no more than five intents.

Aspect 164: A method performed by an implantable neural interface system, the method including: operating a receiver and transmitter unit (RTU), coupled to a neural interface implanted in a user, in an active mode in which the RTU communicates electronic neural signals representative of brain signals with an external processing system according to a first communication interval; transitioning the RTU to an idle mode in which the RTU communicates with the external processing system according to a second communication interval; detecting, by the RTU while in the idle mode, an unavailability condition associated with the external processing system; decoding, by the RTU while in the idle mode, a user intent from the electronic neural signals without using the external processing system; and performing, by the RTU, a fallback action based on the decoded user intent while remaining in the idle mode.

Aspect 165: The method of aspect 164, where performing the fallback action includes transmitting a caregiver notification to a personal electronic device via a wireless link maintained by the RTU independently of the external processing system, without first resuming the active mode.

Aspect 166: The method of any of aspects 164-165, further including, upon restoration of communication with the external processing system, transitioning the RTU from the idle mode to the active mode in which the external processing system resumes decoding user intents from the electronic neural signals.

Aspect 167: An implantable neural interface system, including: a neural interface implanted in a user and configured to detect brain signals from the user and generate electronic neural signals representative of the brain signals; a receiver and transmitter unit (RTU) coupled to the neural interface and configured to receive the electronic neural signals; an external processing system configured to receive the electronic neural signals from the RTU and decode user intents therefrom during a first operating mode; and routing logic configured to select a caregiver-output route from among a set of multiple caregiver-output routes ordered by priority; where, when an unavailability condition associated with the external processing system is present, the RTU is configured to: decode a user intent from the electronic neural signals without using the external processing system; and invoke the routing logic to initiate a transmission of a caregiver notification, generated in response to the user intent decoded by the RTU, via a highest-priority available caregiver-output route that does not require the external processing system.

Aspect 168: The implantable neural interface system of aspect 167, where the routing logic is stored at least in part on the RTU, and the set of multiple caregiver-output routes includes at least a primary route that uses the external processing system and at least one fallback route associated with a personal electronic device or a local notification device.

Aspect 169: The implantable neural interface system of any of aspects 167-168, where the routing logic is further configured to monitor for a delivery acknowledgement on the highest-priority available caregiver-output route and, upon expiration of a configurable timeout without acknowledgement, initiate the transmission of the caregiver notification via a next-priority available caregiver-output route.

Aspect 170: The implantable neural interface system of any of aspects 167-169, where a priority ordering of the set of multiple caregiver-output routes is patient-configurable, and the user intent is from a bounded fallback vocabulary of the RTU including a caregiver-contact intent.

Aspect 171: A method performed by an implantable neural interface system, the method including: receiving, by a receiver and transmitter unit (RTU) coupled to a neural interface implanted in a user, electronic neural signals representative of brain signals; detecting an unavailability condition associated with an external processing system that, during a first operating mode, decodes user intents from the electronic neural signals; decoding, by the RTU, a user intent from the electronic neural signals without using the external processing system; determining, based on the unavailability condition, which of a set of multiple caregiver-output routes ordered by priority is available; and initiating a transmission of a caregiver notification, generated in response to the user intent decoded by the RTU, via a highest-priority available caregiver-output route that does not require the external processing system.

Aspect 172: The method of aspect 171, further including monitoring for a delivery acknowledgement on the highest-priority available caregiver-output route and, upon expiration of a configurable timeout without acknowledgement, initiating the transmission of the caregiver notification via a next-priority available caregiver-output route.

Aspect 173: The method of any of aspects 171-172, where the set of multiple caregiver-output routes includes at least a personal-electronic-device-mediated route and a local-alert-device-mediated route, and a priority ordering of the set of multiple caregiver-output routes is patient-configurable.

Aspect 174: An implantable neural interface system, including: a neural interface implanted in a user and configured to detect brain signals from the user and generate electronic neural signals representative of the brain signals; a receiver and transmitter unit (RTU) coupled to the neural interface and configured to communicate the electronic neural signals with an external processing system; where the RTU is operable in: an active mode in which the RTU communicates the electronic neural signals with the external processing system according to a first communication interval; and an idle mode in which the RTU communicates with the external processing system according to a second communication interval; and routing logic configured to, responsive to detection of a caregiver-contact event while the RTU is in the idle mode: determine which of a set of multiple caregiver-output routes ordered by priority is available based on an availability state of the external processing system; and initiate a transmission of a caregiver notification via a highest-priority available caregiver-output route without first transitioning the RTU to the active mode.

Aspect 175: The implantable neural interface system of aspect 174, where the set of multiple caregiver-output routes includes at least a primary route that uses the external processing system and at least one fallback route associated with a personal electronic device, and the caregiver-contact event includes a user intent decoded from the electronic neural signals by the RTU while in the idle mode.

Aspect 176: The implantable neural interface system of any of aspects 174-175, where the routing logic is further configured to monitor for a delivery acknowledgement and, upon expiration of a configurable timeout without acknowledgement, initiate the transmission of the caregiver notification via a next-priority available caregiver-output route.

Aspect 177: A method performed by an implantable neural interface system, the method including: operating a receiver and transmitter unit (RTU), coupled to a neural interface implanted in a user, in an idle mode in which the RTU communicates electronic neural signals with an external processing system according to a communication interval that is longer than a communication interval used in an active mode; detecting, by the RTU while in the idle mode, a caregiver-contact event from the electronic neural signals; determining, based on an availability state of the external processing system, which of a set of multiple caregiver-output routes ordered by priority is available; and initiating a transmission of a caregiver notification via a highest-priority available caregiver-output route without first transitioning the RTU to the active mode.

Aspect 178: The method of aspect 177, where the set of multiple caregiver-output routes includes at least a primary route associated with internet connectivity via the external processing system and at least one fallback route associated with a personal electronic device that does not require the external processing system.

Aspect 179: The method of any of aspects 177-178, further including monitoring for a delivery acknowledgement on the highest-priority available caregiver-output route and, upon expiration of a configurable timeout, initiating the transmission of the caregiver notification via a next-priority available caregiver-output route.

Aspect 180: An implantable neural interface system, including: a neural interface implanted in a user and configured to detect brain signals from the user and generate electronic neural signals representative of the brain signals; a receiver and transmitter unit (RTU) coupled to the neural interface and configured to communicate the electronic neural signals with an external processing system; where the RTU is operable in: an active mode in which the RTU communicates the electronic neural signals with the external processing system according to a first communication interval; and an idle mode in which the RTU communicates with the external processing system according to a second communication interval; where, in the idle mode, the RTU is configured to: detect an unavailability condition associated with the external processing system; decode a user intent from the electronic neural signals without using the external processing system; and invoke routing logic to select a caregiver-output route from among a set of multiple caregiver-output routes ordered by priority based on the unavailability condition; and initiate a transmission of a caregiver notification, generated in response to the decoded user intent, via a highest-priority available caregiver-output route that does not require the external processing system, without first transitioning to the active mode.

Aspect 181: The implantable neural interface system of aspect 180, where the set of multiple caregiver-output routes includes at least a primary route that uses the external processing system and at least one fallback route associated with a personal electronic device, and the user intent is from a bounded fallback vocabulary of the RTU including a caregiver-contact intent.

Aspect 182: The implantable neural interface system of any of aspects 180-181, where the routing logic is further configured to monitor for a delivery acknowledgement on the highest-priority available caregiver-output route and, upon expiration of a configurable timeout without acknowledgement, initiate the transmission of the caregiver notification via a next-priority available caregiver-output route.

Aspect 183: The implantable neural interface system of any of aspects 180-182, where the first communication interval is on an order of milliseconds and the second communication interval is on an order of seconds, and a priority ordering of the set of multiple caregiver-output routes is patient-configurable.

Aspect 184: A method performed by an implantable neural interface system, the method including: operating a receiver and transmitter unit (RTU), coupled to a neural interface implanted in a user, in an idle mode in which the RTU communicates electronic neural signals with an external processing system according to a second communication interval that is the same as or longer than a first communication interval used in an active mode; detecting, by the RTU while in the idle mode, an unavailability condition associated with the external processing system; decoding, by the RTU, a user intent from the electronic neural signals without using the external processing system; determining, based on the unavailability condition, which of a set of multiple caregiver-output routes ordered by priority is available; and initiating a transmission of a caregiver notification, generated in response to the decoded user intent, via a highest-priority available caregiver-output route that does not require the external processing system, without first transitioning the RTU to the active mode.

Aspect 185: The method of aspect 184, where the set of multiple caregiver-output routes includes at least a personal-electronic-device-mediated route and a local-alert-device-mediated route, and the user intent is from a bounded fallback vocabulary including a caregiver-contact intent.

Aspect 186: The method of any of aspects 184-185, further including monitoring for a delivery acknowledgement on the highest-priority available caregiver-output route and, upon expiration of a configurable timeout without acknowledgement, initiating the transmission of the caregiver notification via a next-priority available caregiver-output route.

Aspect 187: The method or implantable neural interface system of any preceding aspect, wherein a bounded fallback vocabulary consists of a notification event or caregiver-contact event.

Aspect 188: The method or implantable neural interface system of any preceding aspect, wherein the RTU locally detects a user intent using threshold detection, temporal pattern detection, template matching, matched filtering, bandpower detection, threshold-crossing counts, linear classification, logistic classification, decision-tree logic, compressed neural-network inference, state-machine logic, multi-window voting, or combinations thereof.

Aspect 189: The method or implantable neural interface system of any preceding aspect, wherein the RTU suppresses a fallback action unless a confidence threshold, repeated-detection requirement, hysteresis requirement, refractory-period requirement, confirmation-window requirement, or notification-authorized state is satisfied.

Aspect 190: The method or implantable neural interface system of any preceding aspect, wherein RTU local fallback logic is configured to detect a notification event but not to perform full vocabulary cursor control, text entry, multi-degree-of-freedom control, or continuous DMO control.

Aspect 191: The method or implantable neural interface system of any preceding aspect, wherein routing logic uses a route table comprising entries that identify required route components, required communication links, endpoint type, route priority, permitted message format, privacy rule, urgency rule, acknowledgement rule, timeout value, retry count, and fallback successor route.

Aspect 192: The method or implantable neural interface system of any preceding aspect, wherein routing logic excludes a caregiver-output route from an available route set when a required external processing system, network connection, personal electronic device, local alert device, bond, handshake, heartbeat, acknowledgement, or application service is unavailable.

Aspect 193: The method or implantable neural interface system of any preceding aspect, wherein, when the external processing system is unavailable, the routing logic excludes routes requiring the external processing system and selects a direct RTU-to-personal-electronic-device route or a direct RTU-to-local-alert-device route.

Aspect 194: The method or implantable neural interface system of any preceding aspect, wherein a caregiver notification transmitted by the RTU comprises a notification token, alert code, canned-message identifier, route command, or predefined instruction that causes a receiving endpoint to generate a caregiver-facing output.

Aspect 195: The method or implantable neural interface system of any preceding aspect, wherein the idle mode preserves detection of at least a notification event without a full disconnect and reconnect cycle.

Aspect 196: The method or implantable neural interface system of any preceding aspect, wherein the second communication interval is at least 10 times, 50 times, 100 times, 250 times, 500 times, or 1000 times the first communication interval.

Aspect 197: The method or implantable neural interface system of any preceding aspect, wherein notification-from-idle is initiated within less than about 1 second, 2 seconds, 5 seconds, 10 seconds, 15 seconds, or 30 seconds after detection of a notification event.

Aspect 198: The method or implantable neural interface system of any preceding aspect, wherein idle-mode operation reduces telemetry energy consumption or radio duty cycle by at least about 25%, 50%, 70%, 80%, 90%, or 95% relative to continuous active streaming.

Aspect 199: The method or implantable neural interface system of any preceding aspect, wherein a physiological-state detection intent comprises a non-diagnostic physiological-state indicator used to trigger a caregiver notification.

Aspect 200: The method or implantable neural interface system of any preceding aspect, wherein a physiological-state detection intent is not used by the RTU to diagnose or treat a medical condition, but is used as a fallback event that causes transmission of a caregiver notification or initiation of a recovery workflow.

Aspect 201: The method or implantable neural interface system of any preceding aspect, wherein an active mode is associated with a first communication interval and an idle mode is associated with a second communication interval longer than the first communication interval.

Aspect 202: The method or implantable neural interface system of any preceding aspect, wherein the RTU and/or the external processing system use a first vocabulary (e.g., a bounded vocabulary) during an idle mode and a second vocabulary (e.g., a larger or full vocabulary) during an active mode.

Aspect 203: A non-transitory computer-readable medium storing code for controlling an implantable neural interface system, the code comprising instructions executable by one or more processors to perform any one or more aspects described herein, alone or in any combination.

Aspect 204: An apparatus (e.g., a processing device, an RTU, an external processing system, one or more components of a device, or a brain interface), comprising at least one means for performing any one or more aspects described herein, alone or in any combination.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements or use of a “negative” limitation. Unless defined otherwise, all technical and scientific terms used herein have the same meaning as commonly understood by one of ordinary skill in the art to which this invention belongs.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings, such as the terms “including”, “having,” and their derivatives. Also, the terms “part,” “section,” “portion,” “member,” “element,” or “component” when used in the singular, can have the dual meaning of a single part or a plurality of parts. As used herein, the following directional terms “forward, rearward, above, downward, vertical, horizontal, below, transverse, laterally, and vertically” as well as any other similar directional terms, refer to those positions of a device or piece of equipment or those directions of the device or piece of equipment being translated or moved. Finally, terms of degree such as “substantially”, “about,” and “approximately” as used herein mean a reasonable amount of deviation (e.g., a deviation of up to ±0.1%, ±1%, ±5%, or ±10%, as such variations are appropriate) from the specified value such that the end result is not significantly or materially changed.

This disclosure is not intended to be limited to the scope of the particular forms set forth but is intended to cover alternatives, modifications, and equivalents of the variations or embodiments described herein. Further, the scope of the disclosure fully encompasses other variations or embodiments that may become obvious to those skilled in the art in view of this disclosure.

What is claimed is:

1. An implantable neural interface system, comprising:
a neural interface implanted in a user and configured to:
detect brain signals from the user; and
generate electronic neural signals representative of the brain signals;
a receiver and transmitter unit (RTU) coupled to the neural interface and configured to receive the electronic neural signals; and
an external processing system configured to receive the electronic neural signals from the RTU and decode at least one user intent therefrom during a first operating mode;
wherein the RTU is further configured to:
decode a user intent from the electronic neural signals without using the external processing system when an unavailability condition associated with the external processing system is present; and
perform a fallback action based on the user intent decoded by the RTU.

2. The implantable neural interface system of claim 1, wherein, to perform the fallback action, the RTU is further configured to:
transmit a caregiver notification to a personal electronic device via a wireless link between the RTU and the personal electronic device, wherein the RTU and the personal electronic device maintain the wireless link independently of the external processing system.

3. The implantable neural interface system of claim 2, wherein the personal electronic device is configured to operate as a gateway device that relays the caregiver notification to a caregiver without presenting a visual user interface to the user, the personal electronic device receiving the caregiver notification from the RTU and forwarding the caregiver notification to the caregiver via an internet-connected channel or a local wireless channel.

4. The implantable neural interface system of claim 2, wherein the personal electronic device comprises a smartphone executing a medical application, and wherein the wireless link between the RTU and the personal electronic device comprises a Bluetooth Low Energy (BLE) connection maintained independently of the external processing system.

5. The implantable neural interface system of claim 2, wherein the RTU is further configured to:
monitor for a delivery acknowledgement from the personal electronic device; and
upon expiration of a configurable timeout without acknowledgement, transmit the caregiver notification using a next-priority caregiver-output route.

6. The implantable neural interface system of claim 1, wherein the RTU is further configured to:
detect the unavailability condition associated with the external processing system, wherein the RTU decodes the user intent from the electronic neural signals without using the external processing system in accordance with detection of the unavailability condition associated with the external processing system.

7. The implantable neural interface system of claim 1, wherein, to perform the fallback action, the RTU is further configured to:
change the implantable neural interface system between an active state and an idle or locked state; or
issue a wake or recovery command directed to the external processing system.

8. The implantable neural interface system of claim 1, wherein, to perform the fallback action, the RTU is further configured to:
transmit an alert signal to a local notification device.

9. The implantable neural interface system of claim 1, wherein the user intent is from a bounded fallback vocabulary of the RTU.

10. The implantable neural interface system of claim 9, wherein the bounded fallback vocabulary comprises a caregiver-contact or notification intent.

11. The implantable neural interface system of claim 9, wherein the bounded fallback vocabulary comprises no more than five intents.

12. The implantable neural interface system of claim 1, wherein the RTU is implanted in the user, and wherein the unavailability condition associated with the external processing system comprises at least one of: the external processing system being out of wireless range, powered off, physically damaged, misplaced, or in a software-failure state.

13. A method performed by an implantable neural interface system, the method comprising:
detecting, by a neural interface implanted in a user, brain signals from the user;
generating, by the neural interface, electronic neural signals representative of the brain signals;
receiving, by a receiver and transmitter unit (RTU) coupled to the neural interface, the electronic neural signals;
communicating, by the RTU, the electronic neural signals to an external processing system, wherein the external processing system decodes at least one user intent therefrom during a first operating mode;
decoding, by the RTU, a user intent from the electronic neural signals without using the external processing system when an unavailability condition associated with the external processing system is present; and
performing, by the RTU, a fallback action based on the user intent decoded by the RTU.

14. The method of claim 13, wherein performing the fallback action comprises:
transmitting, by the RTU, a caregiver notification to a personal electronic device via a wireless link between the RTU and the personal electronic device, wherein the RTU and the personal electronic device maintain the wireless link independently of the external processing system.

15. The method of claim 13, wherein the user intent is from a bounded fallback vocabulary of the RTU, wherein the bounded fallback vocabulary comprises a caregiver-contact or notification intent, and wherein the bounded fallback vocabulary comprises no more than five intents.

16. The method of claim 13, wherein the RTU is implanted in the user, and wherein the unavailability condition associated with the external processing system comprises at least one of: the external processing system being out of wireless range, powered off, physically damaged, misplaced, or in a software-failure state.

17. The method of claim 13, further comprising, upon restoration of communication with the external processing system, transitioning, by the RTU, from a second operating mode to the first operating mode in which the external processing system resumes decoding user intents from the electronic neural signals.

18. A receiver and transmitter unit (RTU) for use in an implantable neural interface system, the RTU comprising:
a communication interface configured to:
receive electronic neural signals from a neural interface implanted in a user, the electronic neural signals being representative of brain signals detected from the user; and
communicate the electronic neural signals to an external processing system during a first operating mode, wherein the external processing system decodes at least one user intent from the electronic neural signals; and
processing circuitry configured to:
decode a user intent from the electronic neural signals without using the external processing system when an unavailability condition associated with the external processing system is present; and
cause the RTU to perform a fallback action based on the user intent decoded by the processing circuitry.

19. The RTU of claim 18, wherein the communication interface is configured to concurrently maintain:
a first wireless link to the external processing system during the first operating mode; and
a second wireless link to a personal electronic device independent of the first wireless link;
wherein the processing circuitry is configured to route a caregiver notification via the second wireless link both during the first operating mode when the external processing system is available and during a second operating mode when the external processing system is unavailable.

20. The RTU of claim 18, wherein the RTU is further operable in an active mode and an idle mode, wherein:
in the active mode the communication interface communicates the electronic neural signals with the external processing system according to a first communication interval;
in the idle mode the communication interface communicates with the external processing system according to a second communication interval; and
the processing circuitry is configured to decode the user intent and cause the RTU to perform the fallback action in both the active mode and the idle mode.
